(19) United States
(12) Patent Application Publication
(10) Pub. No.: US 2008/0189177 A1
(43) Pub. Date: Aug. 7, 2008

(54) SYSTEMS AND METHODS FOR PROVIDING ADVERTISEMENTS

(76) Inventors: Jared M. Anderton, West Jordan, UT (US); Philip M. Bailey, West Jordan, UT (US); Clark J. Madsen, Riverton, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/670,851

(22) Filed: Feb. 2, 2007

(51) Int. Cl. G06Q 30/00

(52) U.S. Cl. 705/14

(57) ABSTRACT

One or more advertisements may be provided to telephones. The advertisements may be selected based upon any suitable criteria, including, but not limited to, telephone identifiers, geographical regions, advertisement categories, bids, time periods, and/or other factors. The advertisements may be used to help provide discounted telephone service, for example, to provide telephone calls at a lower cost or no cost.

### BACKGROUND

1. Field of the Invention

Some embodiments of the present invention may generally relate to systems and methods for providing telephone service, systems and methods for providing advertising, or systems and methods for providing advertising and telephone service.

2. Background Technology

People all around the world use telephones. Unfortunately, telephone service may be expensive.

### SUMMARY

A need therefore exists for systems and methods that eliminate or reduce the disadvantages and problems listed above or other disadvantages and problems.

In one aspect, to obtain a discounted telephone call, a user may call a telephone number (preferably a toll-free or local telephone number) hosted by a system. In response to receiving the user's call, the system may provide an advertisement to the user, for example, by playing an audio recording. The system may prompt the user to dial a desired telephone number (preferably, a long distance telephone number). The system preferably connects the user to the desired telephone number for a fixed period, such as 20 minutes. The system preferably plays a warning before the period ends, such as 1 minute before the period ends.

Another aspect is the system may select the advertisement at least partially based upon an identifier associated with the user's telephone. One exemplary identifier is the user's telephone's ANI (Automatic Number Identification), e.g., the telephone number.

Yet another aspect is the system may include one or more databases including data associating advertisements with geographic regions and data associating telephone identifiers with the geographic regions. Accordingly, when the system receives a telephone call from a user, the system may identify a geographic region associated with the user's telephone's identifier, identify an advertisement associated with the geographic region, and provide the advertisement to the user.

Still another aspect is the system may include one or more databases including data associating advertisements with particular categories (such as, apparel, men's apparel, entertainment, video games, shopping, technology, software, etc.) and data associating telephone identifiers with the categories. The system may provide an interface configured to allow a user to select categories of advertisements to associate the user's telephone's identifier with the categories. Accordingly, when the system receives a telephone call from a user, the system may identify a category associated with the user's telephone's identifier, identify an advertisement associated with the category, and provide the advertisement to the user.

Another aspect is the system may provide an interface configured to allow advertisers to upload advertisements to the system.

Yet another aspect is the system may provide an interface configured to allow an advertiser to select one or more geographic regions to associate those geographic regions with an advertisement. Accordingly, the system may provide the advertisement to a user when the user's telephone's ANI is associated with the advertiser-selected geographic region.

Still another aspect is the system may provide an interface configured to allow the advertiser to select particular time slots during which the system may provide the advertiser's advertisements. For example, the advertiser may select one or more hourly intervals for a particular advertisement. Accordingly, the system may provide the advertisement to a user when the user calls during one of those hourly intervals.

Another aspect is the system may provide an interface configured to allow the advertiser to bid for particular time slots during which the system may provide the advertiser's advertisements. When selecting an advertisement to be provided to a user, the system may advantageously select the advertisement with the highest bid for a particular time slot and/or a particular geographic region. Of course, the system may use these and/or other criteria in selecting the advertisement.

A further aspect is the system may provide an interface configured to display a minimum required bid for the time slot, the average bid for the time slot, the highest bid for the time slot, the median bid for the time slot, etc. This may help an advertiser decide how to bid for a particular time slot.

Yet another aspect is, when selecting an advertisement to be provided to a user, the system may limit the number of times a particular advertisement is provided. For example, the system may limit the total number of times advertisements from a particular advertising campaign may be provided. Also, for example, the system may limit the total number of times the system provides a particular advertisement. Further, for example, the system may limit the number of times the system provides a particular advertisement to a particular subset of one or more zip codes or a particular subset of one or more telephones (e.g., a particular ANI). The system may provide an interface configured to allow an advertiser to enter these limits.

Still another aspect is the system may provide an interface configured to display various reports that may list the number of times an advertisement has been provided, the number of different telephone identifiers that an advertisement has been provided to, the percentage of the total number of advertisements provided to a particular geographical region, and/or other suitable information.

Another aspect is a system that may comprise a database. The database may include first data and second data. The first data may associate a first geographical region with a first plurality of identifiers, and each identifier of the first plurality of identifiers may comprise at least a portion of a telephone identifier. The second data may associate the first geographical region with one or more advertisements. The system may also comprise a first server. The first server may be configured to receive a first telephone identifier; to determine whether at least a portion of the first telephone identifier matches at least a portion of at least one of the first plurality of identifiers; and to, at least partially in response to determining that at least a portion of the first telephone identifier matches at least a portion of at least one of the first plurality of identifiers, send at least one of the one or more advertisements to a first telephone associated with the first telephone identifier.

Yet another aspect is a method that may comprise receiving at least one advertisement from a server. The server may be configured to send the at least one advertisement at least partially in response to the server receiving a first telephone identifier, identifying at least one geographical region associated with the first telephone identifier, and determining that the at least one advertisement is associated with the at least one geographical region.

Still another aspect is a method that may comprise identifying one or more geographical regions associated with a first telephone identifier; identifying one or more advertisements associated with at least one of the one or more geographical regions; and sending at least one of the one or more advertisements to a first telephone associated with the first telephone identifier.

For purposes of summarizing, certain aspects, advantages and features of certain embodiments of the invention have been described in this summary. Not necessarily all (or any of) these summarized aspects, advantages or features will be embodied in any particular embodiment of the invention. Some of these summarized aspects, advantages and features and other aspects, advantages and features may become more fully apparent from the following detailed description and the appended claims.

### BRIEF DESCRIPTION OF THE DRAWINGS

The appended drawings contain figures of preferred embodiments to further clarify the above and other aspects, advantages and features of embodiments of the present invention. It will be appreciated that these drawings depict only preferred embodiments of the invention and are not intended to limits its scope. Particular embodiments of the invention will be described and explained with additional specificity and detail through the use of the accompanying drawings in which:

FIG. 1 is a block diagram of an exemplary system;

FIG. 2 is a flowchart illustrating a portion of an exemplary method;

FIG. 3 is a flowchart illustrating a portion of an exemplary method;

FIG. 4 is a block diagram of a portion of an exemplary database;

FIG. 5 is a block diagram of a portion of an exemplary database;

FIG. 6 is a diagram illustrating an exemplary user interface;

FIG. 7 is a diagram illustrating an exemplary user interface;

FIG. 8 is a flowchart illustrating an exemplary method;

FIG. 9 is a diagram illustrating an exemplary user interface;

FIG. 10 is a flowchart illustrating an exemplary method;

FIG. 11 is a diagram illustrating an exemplary user interface;

FIG. 12 is a flowchart illustrating an exemplary method;

FIG. 13 is a diagram illustrating an exemplary user interface;

FIG. 14 is a flowchart illustrating an exemplary method;

FIG. 15 is a diagram illustrating an exemplary user interface;

FIG. 16 is a flowchart illustrating an exemplary method;

FIG. 17 is a diagram illustrating an exemplary user interface;

FIG. 18 is a diagram illustrating an exemplary user interface;

FIG. 19 is a diagram illustrating an exemplary user interface;

FIG. 20 is a diagram illustrating an exemplary user interface;

FIG. 21 is a diagram illustrating an exemplary user interface;

FIG. 22 is a diagram illustrating an exemplary method;

FIG. 23 is a diagram illustrating an exemplary user interface;

FIG. 24 is a diagram illustrating an exemplary user interface;

FIG. 25 is a diagram illustrating an exemplary user interface;

FIG. 26 is a flowchart illustrating an exemplary method;

FIG. 27 is a flowchart illustrating a portion of an exemplary method;

FIG. 28 is a diagram illustrating an exemplary user interface;

FIG. 29 is a flowchart illustrating a portion of an exemplary method;

FIG. 30 is a diagram illustrating an exemplary user interface;

FIG. 31 is a flowchart illustrating a portion of an exemplary method;

FIG. 32 is a diagram illustrating an exemplary user interface;

FIG. 33 is a diagram illustrating an exemplary user interface;

FIG. 34 is a flowchart illustrating a portion of an exemplary method;

FIG. 35 is a diagram illustrating an exemplary user interface;

FIG. 36 is a diagram illustrating an exemplary user interface;

FIG. 37 is a flowchart illustrating a portion of an exemplary method;

FIG. 38 is a diagram illustrating an exemplary user interface;

FIG. 39 is a diagram illustrating an exemplary user interface;

FIG. 40 is a diagram illustrating an exemplary report and an exemplary database;

FIG. 41 is a diagram illustrating an exemplary report;

FIG. 42 is a diagram illustrating an exemplary report;

FIG. 43 is a diagram illustrating an exemplary report; and

FIG. 44 is a flowchart illustrating an exemplary method.

### DETAILED DESCRIPTION OF THE PREFERRED EMBODIMENTS

Embodiments of the present invention may be generally directed towards systems and methods for providing telephone service, systems and methods for providing advertising, or systems and methods for providing advertising and telephone service. The principles of the present invention, however, are not limited to such systems and methods. It will be understood that, in light of the present disclosure, the systems and methods disclosed herein can be successfully used in connection with other types of systems, methods and services.

### Discounted Telephone Service

Many embodiments may be used to provide discounted telephone service, for example, to provide telephone calls at a lower cost or at no cost. Such costs may include monetary costs, minutes (for example, allotments of minutes on a mobile telephone plan), and/or other costs. Such telephone service may include a telephone call to another telephone, a telephone call to one or more other telephones (such as, for a conference call), and/or other suitable telephone service.

### Exemplary System

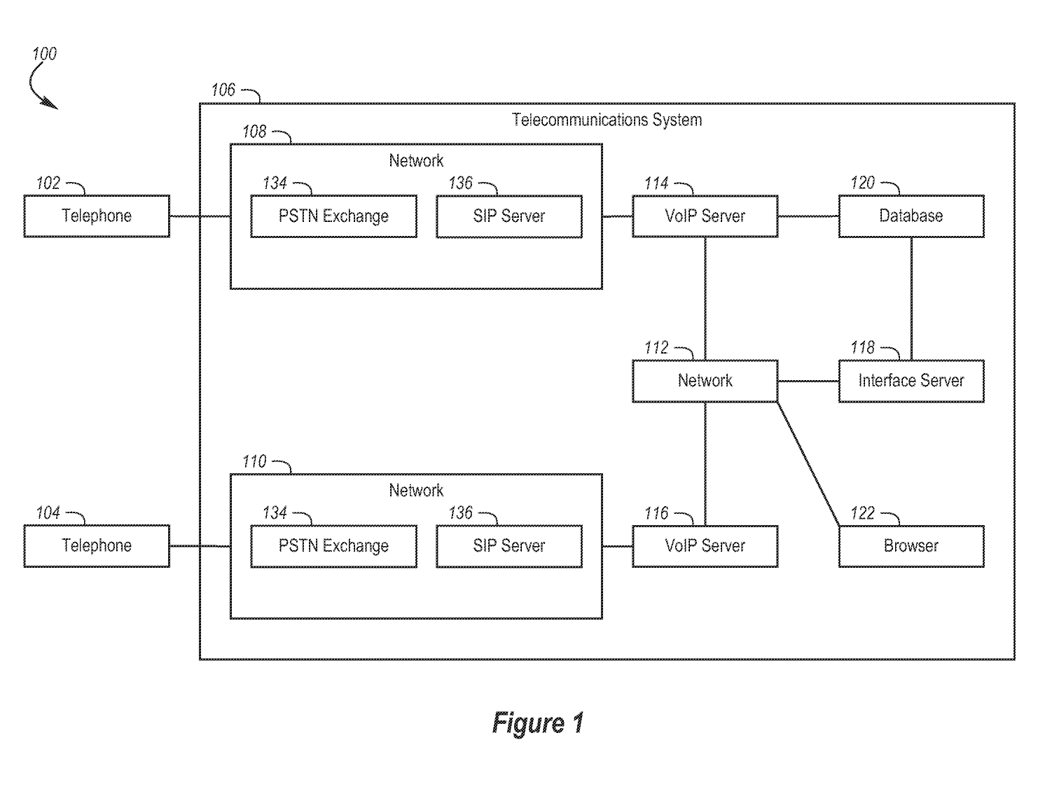

As shown in FIG. 1, a system 100 may include one or more telephones 102, 104. As used herein, the term “telephone” is a broad term and is used in its ordinary meaning and includes, but is not limited to, telephones, mobile telephones, Voice over Internet Protocol (VoIP) telephones, personal digital assistant (PDA) telephones; and any other device configured to receive telephone service.

The system 100 may also include a telecommunications system 106. The telecommunications system 106 may include one or more networks 108, 110, 112; one or more servers 114, 116, 118; one or more databases 120; one or more browsers 122; other suitable components; or any one or more thereof.

### Exemplary Method

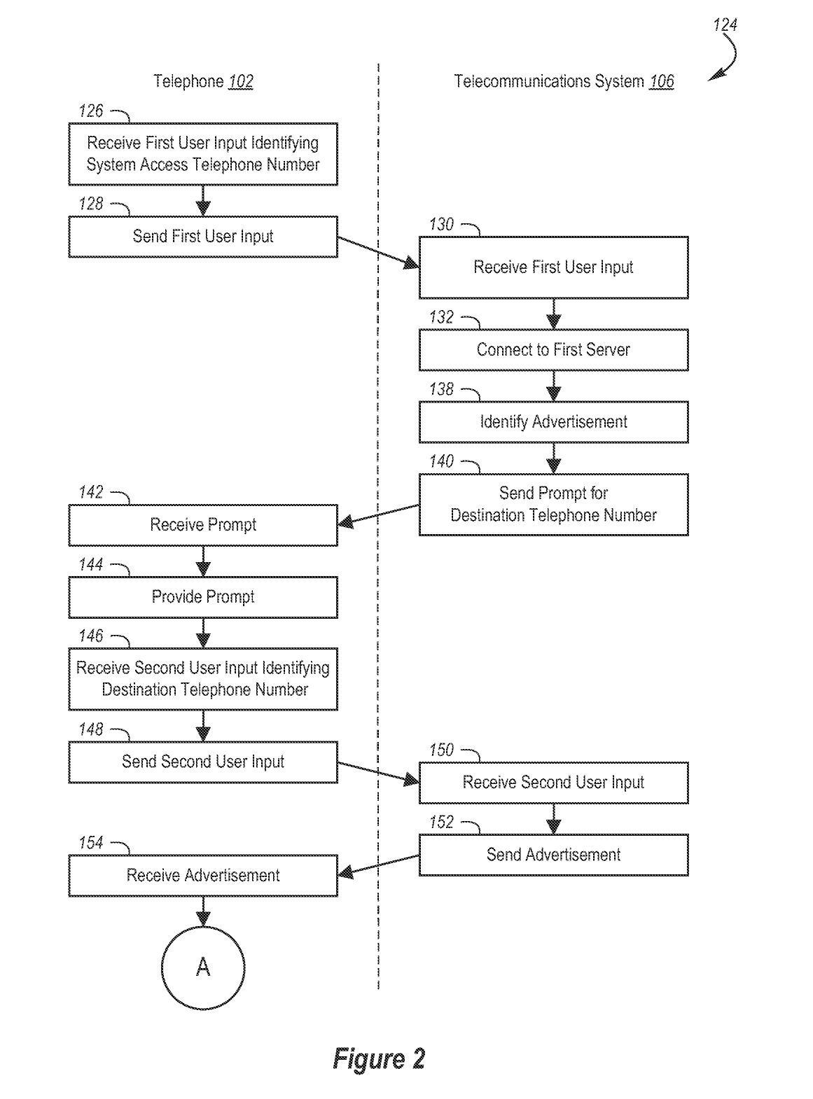

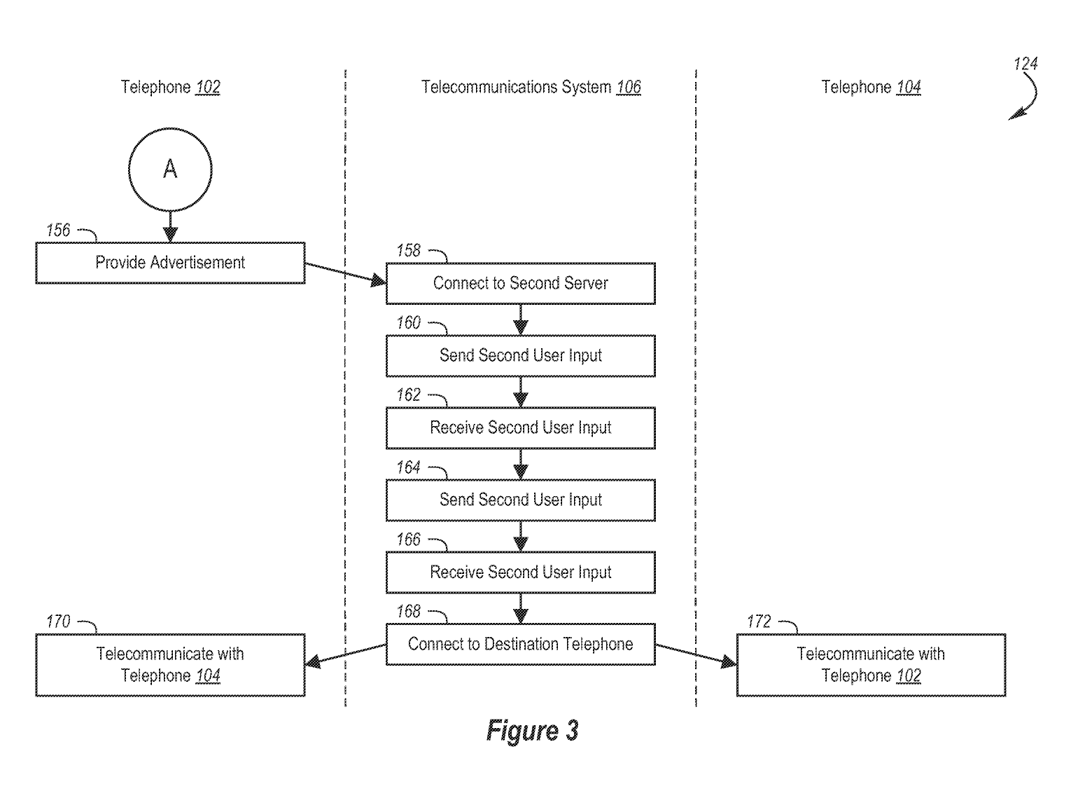

With reference to FIGS. 2-3, the method 124 may be performed by the telecommunications system 106; the networks 108, 110, 112; the servers 114, 116; the database 120; one or more other suitable components, systems, modules, and the like; or any one or more thereof. Of course, the entire method 124 need not be performed; and any part or parts of the method 124 may be performed to provide a useful method 124.

As shown in FIG. 2, at a block 126, the telephone 102 may receive first user input identifying an access telephone number, which may be used to access the server 114 as discussed in further detail below. The access telephone number is preferably a toll-free telephone number or local telephone number; however, other types of telephone numbers may be used if desired.

At a block 128, the telephone 102 may send the first user input, and the network 108 may receive the first user input at a block 130.

At a block 132, the network 108 may use the first user input to connect to the server 114. For example, the network 108 may include at least one Public Switched Telephone Network (PSTN) exchange 134, which may use the first user input to connect the telephone 102 to the server 114 at the block 132. Also, for example, the network 108 may include at least one Session Initiation Protocol (SIP) server 136, which may use the first user input to connect the telephone 102 to the server 114 at the block 132. As shown in FIG. 1, the server 114 is preferably a VoIP server. However, the server 114 need not be a VoIP server, and the server 114 may be any other suitable type of server.

At a block 138, the server 114 may identify an advertisement. At a block 140, the server 114 may send a prompt for a destination telephone number to the telephone 102 via, for example, the network 108. At a block 142, the telephone 102 may receive the prompt via, for example, the network 108; and the telephone 102 may provide the prompt at a block 144. The prompt may comprise audio, video, text, one or more images; any other suitable means for prompting; or any one or more thereof. Desirably, the telephone 102 may include one or more output devices configured to provide audio, video, text, one or more images; any other suitable means for prompting; or any one or more thereof. Such output devices may include, but are limited to, speakers, display screens, and the like.

At a block 146, the telephone 102 may receive second user input identifying a destination number. The destination telephone number may comprise, for example, a telephone number associated with the telephone 104. At a block 148, the telephone 102 may send the second user input to the server 114 via, for example, the network 108. At a block 150, the server 114 may receive the second user input via, for example, the network 108.

As shown in FIG. 2, at a block 152, the server 114 may send the advertisement (identified at the block 138) to the telephone 102 via, for example, the network 108. At a block 154, the telephone 102 may receive the advertisement via, for example, the network 108; and the telephone 102 may provide the advertisement at a block 156 (FIG. 3). The advertisement may comprise audio, video, text, one or more images; any other suitable means for advertising; or any one or more thereof. Desirably, the telephone 102 may comprise one or more output devices configured to provide audio, video, text, one or more images; any other suitable means for advertising; or any one or more thereof. In a preferred embodiment, the advertisement comprises audio.

As shown in FIG. 3, at a block 158, the server 114 may connect to the server 116 via, for example, the network 112. The server 116 is preferably a VoIP server, and the network 112 may comprise the Internet. The server 116, however, need not be a VoIP server, and the server 116 may be any other suitable type of server. In addition, the network 112 need not comprise the Internet, and the network 112 may comprise any other suitable type of network.

At a block 160, the server 114 may send the second user input identifying a destination telephone number (received at the block 146 in FIG. 2) to the server 116 via, for example, the network 112. At a block 162, the server 116 may receive the second user input via, for example, the network 112. At a block 164, the server 116 may send the second user input, and the network 110 may receive the second user input at a block 166.

At a block 168, the network 110 may use the second user input to connect to a destination telephone, such as telephone 104. For example, the network 110 may include at least one Public Switched Telephone Network (PSTN) exchange 134, which may use the second user input to connect the telephone 102 to the telephone 104 at the block 168. Also, for example, the network 110 may include at least one Session Initiation Protocol (SIP) server 136, which may use the second user input to connect the telephone 102 to the telephone 104 at the block 168. After being connected at the block 168, the telephones 102, 104 may telecommunicate with each other at blocks 170, 172. Advantageously, the telephones 102, 104 may telecommunicate with each at a lower cost or at no cost for the person using the telephone 102, the person using the telephone 104 or both. For example, an advertiser may pay one or more fees in exchange for its advertisements being provided at the block 156 in FIG. 2. Consequently, these fees may be used to offset all or at least a portion of the costs normally associated with making a telephone call using the telephone 102, receiving a telephone call using the telephone 104, or both. As explained below, advertisers may place bids to indicate the fee they are willing to pay in exchange for its advertisements being provided at the block 156 in FIG. 2.

### Exemplary Database

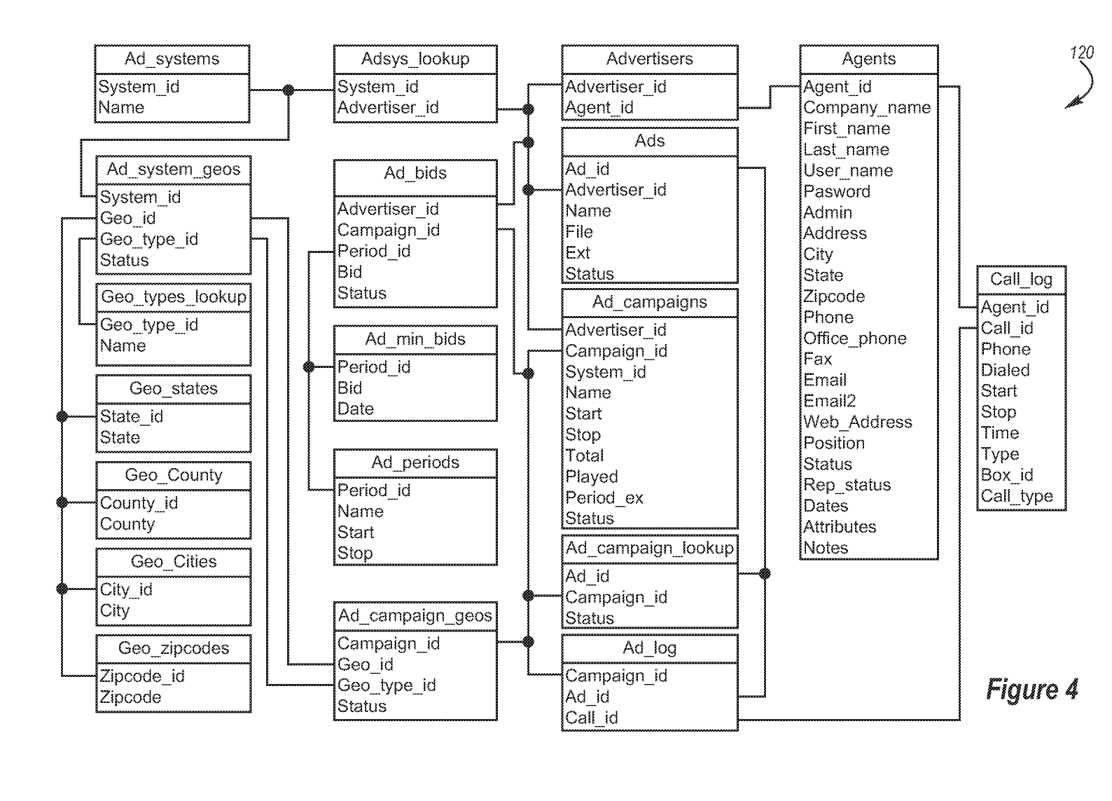

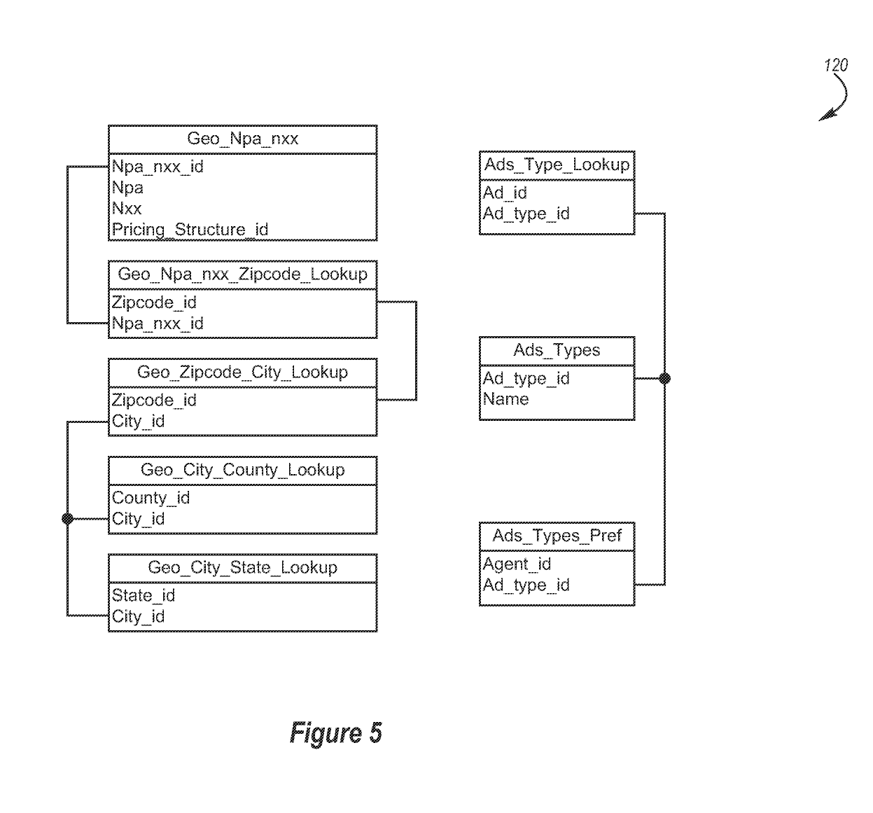

As shown in FIGS. 4-5, an exemplary embodiment of the database 120 may be configured to facilitate the identification of an advertisement at the block 138 (FIG. 2) and other features disclosed herein.

The database 120 may include one or more tables, such as Ad_systems, Ad_system_geos, Geo_types_lookup, Geo_states, Geo_County, Geo_Cities, Geo_zipcodes, Adsys_lookup, Ad_bids, Ad_min_bids, Ad_periods, Ad_campaign_geos, Advertisers, Ads, Ad_campaigns, Ad_campaign_lookup, Ad_log, Agents, Call_log, Geo_Npa_nxx, Geo_Npa_nxx_Zipcode_Lookup, Geo_Zipcode_City_Lookup, Geo_City_County_Lookup, Geo_City_State_Lookup, Ads_Type_Lookup, Ads_Types, Ads_Types_Pref, one or more other tables, or any one or more thereof.

The tables of the database 120 may include one or more rows, which may include one or more fields. For example, the rows of the Ad_systems table may include System_id, Name, other suitable fields, or any one or more thereof. The rows of the Ad_system geos table may include System_id, Geo_id, Geo_type_id, Status, other suitable fields, or any one or more thereof. The rows of the Geo_types_lookup table may include Geo_type_id, Name, other suitable fields, or any one or more thereof. The rows of the Geo_states table may include State_id, State, other suitable fields, or any one or more thereof. The rows of the Geo_County table may include County_id, County, other suitable fields, or any one or more thereof. The rows of the Geo_Cities table may include City_id, City, other suitable fields, or any one or more thereof. The rows of the Geo_zipcodes table may include Zipcode_id, Zipcode, other suitable fields, or any one or more thereof. The rows of the Adsys_lookup table may include System_id, Advertiser_id, other suitable fields, or any one or more thereof. The rows of the Ad_bids table may include Advertiser_id, Campaign_id, Period_id, Bid, Status, other suitable fields, or any one or more thereof. The rows of the Ad_min bids table may include Period_id, Bid, Date, other suitable fields, or any one or more thereof. The rows of the Ad_periods table may include Period_id, Name, Start, Stop, other suitable fields, or any one or more thereof. The rows of the Ad_campaign_geos table may include Campaign_id, Geo_id, Geo_type_id, Status, other suitable fields, or any one or more thereof. The rows of the Advertisers table may include Advertiser_id, Agent_id, other suitable fields, or any one or more thereof. The rows of the Ads table may include Ad_id, Advertiser_id, Name, File, Ext, Status, other suitable fields, or any one or more thereof. The rows of the Ad_campaigns table may include Advertiser_id, Campaign_id, System_id, Name, Start, Stop, Total, Played, Period_ex, Status, other suitable fields, or any one or more thereof. The rows of the Ad_campaign_lookup table may include Ad_id, Campaign_id, Status, other suitable fields, or any one or more thereof. The rows of the Ad_log table may include Campaign_id, Ad_id, Call_id, other suitable fields, or any one or more thereof. The rows of the Agents table may include Agent_id, Company_name, First_name, Last_name, User_name, Pasword, Admin, Address, City, State, Zipcode, Phone, Office_phone, Fax, Email, Email2, Web_Address, Position, Status, Rep_status, Dates, Attributes, Notes, other suitable fields, or any one or more thereof. The rows of the Call_log table may include Agent_id, Call_id, Phone, Dialed, Start, Stop, Time, Type, Box_id, Call_type, other suitable fields, or any one or more thereof. The rows of the Geo_Npa_nxx table may include Npa_nxx_id, Npa, Nxx, Pricing_Structure_id, other suitable fields, or any one or more thereof. The rows of the Geo_Npa_nxx_Zipcode_Lookup table may include Zipcode_id, Npa_nxx_id, other suitable fields, or any one or more thereof. The rows of the Geo_Zipcode_City_Lookup table may include Zipcode_id, City_id, other suitable fields, or any one or more thereof. The rows of the Geo_City_County_Lookup table may include County_id, City_id, other suitable fields, or any one or more thereof. The rows of the Geo_City_State_Lookup table may include State_id, City_id, other suitable fields, or any one or more thereof. The rows of the Ads_Type_Lookup table may include Ad_id, Ad_type_id, other suitable fields, or any one or more thereof. The rows of the Ads_Types table may include Ad_type_id, Name, other suitable fields, or any one or more thereof. The rows of the Ads_Types_Pref table may include Agent_id, Ad_type_id, other suitable fields, or any one or more thereof.

The database 120 does not require all (or any) of the tables and fields of the exemplary embodiment of the database 120 shown in FIGS. 4-5. In fact, the database 120 may include different structures having other suitable configurations, which may facilitate the identification of an advertisement at the block 138 (FIG. 2) and/or other features disclosed herein. Nevertheless, the exemplary embodiment of the database 120 shown in FIGS. 4-5 advantageously provides an example that will enable a person to create such different structures having other suitable configurations.

### Exemplary Identifying of Advertisements

As discussed above, the server 114 may identify an advertisement at the block 138 (FIG. 2).

Identifiers Associated with a Telephone

In one embodiment, at the block 138, the server 114 may identify the advertisement at least partially based upon an identifier that is associated with a telephone, for instance, the telephone 102 or the telephone 104. For example, the server 114 may identify an advertisement that is associated with at least a portion of a telephone number of the telephone 102; and the server 114 may send the advertisement to the telephone 102. One exemplary identifier may comprise at least a portion of a telephone's ANI (Automatic Number Identification)—such as, an area code, a prefix, or both an area code and a prefix of the telephone's telephone number. For illustrative purposes, in an example United States phone number “801-555-1212,” the area code is “801” and the prefix is “555.”

Zip Codes

In a further embodiment, at the block 138, the server 114 may identify the advertisement at least partially based upon a geographical region (such as a zip code, a county, a state, a country or the like) associated with a telephone. For instance, the server 114 may identify a zip code that is associated with at least a portion of a telephone number of the telephone 102; and the server 114 may identify an advertisement associated with the zip code, which the server 114 may then send to the telephone 102.

For example, using the exemplary database 120 shown in FIG. 4-5, the following exemplary Structured Query Language (SQL) Statement #1 could identify the file name and file extension (“Ads.File” and “Ads.Ext”) of at least one advertisement file that is associated with a zip code that is associated with an area code (<Telephone Area Code>) and a prefix (<Telephone Prefix>):

SQL Statement #1

SELECT Ads.File, Ads.Ext
FROM Geo_Npa_nxx, Geo_Npa_nxx_Zipcode_Lookup, Geo_zipcodes, Ads,
Ad_system_geos, Geo_types_lookup, Ad_campaign_geos, Ad_campaign_lookup
WHERE (Geo_Npa_nxx.Npa = <Telephone Area Code>) AND
(Geo_Npa_nxx.Nxx = <Telephone Prefix>) AND
(Geo_Npa_nxx.Npa_nxx_id = Geo_Npa_nxx_Zipcode_Lookup.Npa_nxx_id) AND
(Geo_Npa_nxx_Zipcode_Lookup.Zipcode_id = Geo_zipcodes.Zipcode_id) AND
(Geo_zipcodes.Zipcode_id = Ad_system_geos.Geo_id) AND
(Ad_system_geos.Geo_type_id = Geo_types_lookup.Geo_type_id) AND
(Geo_types_lookup.Name = “ZIP Code”) AND
(Ad_system_geos.Geo_id = Ad_campaign_geos.Geo_id) AND
(Ad_system_geos.Geo_type_id = Ad_campaign_geos.Geo_type_id) AND
(Ad_campaign_geos.Campaign_id = Ad_campaign_lookup.Campaign_id) AND
(Ad_campaign_lookup.Ad_id = Ads.Ad_id)

As illustrated by the SQL Statement #1 and FIG. 5, the Geo_Npa_nxx table may include various combinations of area codes and prefixes. Each row in the Geo_Npa_nxx table preferably includes an area code (Geo_Npa_nxx.Npa), a prefix (Geo_Npa_nxx.Nxx), and an identifier (Geo_Npa_nxx.Npa_nxx_id) used to identify the area-code/prefix pair.

As illustrated by the SQL Statement #1 and FIG. 4, the Geo_zipcodes table may include various zip codes. In particular, each row in the Geo_zipcodes table preferably includes a zip code (Geo_zipcodes.Zipcode) and an identifier (Geo_zipcodes.Zipcode_id) used to identify the zip code.

As illustrated by the SQL Statement #1 and FIG. 5, the Geo_Npa_nxx_Zipcode_Lookup table may advantageously associate a zip code with (1) an area-code/prefix pair and/or (2) an area-code. For example, each row in the Geo_Npa_nxx_Zipcode_Lookup table preferably includes an identifier (Geo_Npa_nxx_Zipcode_Lookup.Zipcode_id) used to identify a zip code and an identifier (Geo_Npa_nxx_Zipcode_Lookup.Npa_nxx_id) used to identify an area-code/prefix pair—thus associating the zip code with the area-code/prefix pair.

Consequently, the Geo_Npa_nxx_Zipcode_Lookup table may be used to join the Geo_Npa_nxx table and the Geo_zipcodes table to identify the zips codes that are associated with at least a portion of an identifier associated with a telephone. For example, as illustrated by the SQL Statement #1, the Geo_Npa_nxx_Zipcode_Lookup table may be used to identify one or more zip codes associated with an area code (<Telephone Area Code>) and a prefix (<Telephone Prefix>). Moreover, as illustrated by the SQL Statement #1 and FIGS. 4-5, additional tables (such as, the Geo_zipcodes table, the Ad_system_geos table, the Geo_types_lookup table, the Ad_campaign geos table, the Ad_campaign lookup table, and the Ads table) may be joined to identify advertisements that are associated with these zip codes.

In further detail, as illustrated by the SQL Statement #1 and FIG. 4, the Ads table preferably includes data indicating one or more advertisements. For example, each row in the Ads table preferably includes a name of an advertisement (Ads.Name), an advertisement file name (Ads.File), an advertisement file extension (Ads.Ext), and an identifier (Ads.Ad_id) used to identify the advertisement.

Also, as illustrated by the SQL Statement #1 and FIG. 4, the Ad_campaign_lookup table may advantageously associate at least one ad with at least one advertising campaign. For example, each row in the Ad_campaign_lookup table preferably includes an identifier (Ad_campaign_lookup.Ad_id) used to identify an advertisement and an identifier (Ad_campaign_lookup.Campaign_id) used to identify an advertising campaign—thus associating the advertisement with the advertising campaign.

In addition, as illustrated by the SQL Statement #1 and FIG. 4, the Ad_campaign_geos table may advantageously associate a geographical region geographical region (such as a zip code, a county, a state, a country or the like) with an advertising campaign. In particular, each row in the Ad_campaign_geos table preferably includes an identifier (Ad_campaign_geos.Campaign_id) used to identify an advertising campaign and an identifier (Ad_campaign_geos.Geo_id) used to identify a geographical region—thus associating the campaign with the geographical region. Each row in the Ad_campaign_geos table also preferably includes an identifier (Ad_campaign_geos.Geo_type_id) used to identify a type of geographical region (such as zip code, county, state, country or the like).

Consequently, the Ad_campaign_lookup table may be used to join the Ad_campaign_geos table and the Ads table to identify the advertisements associated with a particular zip code or other geographical region, as illustrated by the SQL Statement #1.

The area code (<Telephone Area Code>) and the prefix (<Telephone Prefix>) illustrated in the SQL Statement #1 are preferably the area code and prefix of a telephone number associated with the telephone 102 or the telephone 104. For example, when the network 108 connects to the server 114 at the block 132, the server 114 may advantageously receive the ANI (Automatic Number Identification) of the telephone 102, which ANI may include an area code, a prefix, or both an area code and a prefix of the telephone number of the telephone 102. Consequently, at the block 138, the server 114 may identify one or more zip codes associated with at least a portion of the ANI of the telephone 102 and may identify an advertisement associated with at least one of the zip codes; and the server 114 may send that advertisement at the block 152.

Advertisement Categories

In one embodiment, at the block 138, the server 114 may identify the advertisement at least partially based upon an advertisement category associated with a telephone, such as the telephone 102 or the telephone 104. For instance, the server 114 may identify one or more advertisement categories associated with at least a portion of an identifier associated with the telephone 102; and the server 114 may identify an advertisement associated with at least one of those categories, which the server 114 may then send to the telephone 102.

For example, using the exemplary database 120 shown in FIG. 4-5, the following exemplary SQL Statement #2 could identify the file name and file extension (“Ads.File” and “Ads.Ext”) of at least one advertisement file that is associated with an advertisement category that is associated with a telephone number (<Telephone Number>):

SQL Statement #2

SELECT Ads.File, Ads.Ext
FROM Agents, Ads_Types_Pref, Ads_Type_Lookup, Ads
WHERE (Agents.Phone = <Telephone Number>) AND
(Agents.Agent_id = Ads_Types_Pref.Agent_id) AND
(Ads_Types_Pref.Ad_type_id = Ads_Type_Lookup.Ad_type_id)
AND
(Ads_Type_Lookup.Ad_id = Ads.Ad_id)

As illustrated by the SQL Statement #2 and FIG. 4, the Agents table preferably includes data indicating one or more persons. Each row in the Agents table preferably includes a telephone number (Agents.Phone) for a person and an identifier (Agents.Agent_id) used to identify the person. As illustrated by FIG. 5, the Ads_Types table preferably includes data indicating one or more advertisement categories. Each row in the Ads_Types table preferably includes the name of an advertisement category (Ads_Types.Name) and an identifier (Ads_Types.Ad_type_id) used to identify the advertisement category.

As illustrated by the SQL Statement #2 and FIG. 5, the Ads_Types_Pref table may advantageously associate at least one person with at least one advertisement category; and the Ads_Type_Lookup table may advantageously associate at least one advertisement with at least one advertisement category. For example, each row in the Ads_Types_Pref table preferably includes an identifier (Ads_Types_Pref.Agent_id) used to identify a person and an identifier (Ads_Types_Pref.Ad_type_id) used to identify the advertisement category, thus associating the person with the advertisement category; and each row in the Ads_Type_Lookup table preferably includes an identifier (Ads_Type_Lookup.Ad_id) used to identify an advertisement and an identifier (Ads_Type_Lookup.Ad_type_id) used to identify the advertisement category, thus associating the advertisement with the advertisement category.

Consequently, the Ads_Types_Pref table and the Ads_Type_Lookup table may be used to join the Agents table and the Ads table to identify one or more advertisement categories associated with at least a portion of an identifier associated with a telephone and to identify an advertisement associated with at least one of those categories. For example, as illustrated by the SQL Statement #2, the Ads_Types_Pref table and the Ads_Type_Lookup table may be used to identify one or more advertisement categories associated with a telephone number (<Telephone Number>) and to identify an advertisement associated with at least one of those categories.

The telephone number (<Telephone Number>) illustrated the SQL Statement #2 is preferably a telephone number associated with the telephone 102 or the telephone 104. For example, when the network 108 connects to the server 114 at the block 132, the server 114 may advantageously receive the ANI (Automatic Number Identification) of the telephone 102, which ANI may comprise the telephone number of the telephone 102. Thus, at the block 138, the server 114 may identify one or more advertisement categories associated with at least a portion of the ANI of the telephone 102 and may identify an advertisement associated with at least one of the advertisement categories; and the server 114 may send that advertisement at the block 152.

Bids

In one embodiment, at the block 138, the server 114 may identify the advertisement at least partially based upon a bid. In further embodiments, the bid may be associated with a time period, a zip code, or both a time period and a zip code; and the server 114 may identify an advertisement at least partially based upon the bid, the time period, the zip code, or any one or more thereof. For instance, the server 114 may ascertain the current time (e.g., the current time at the location of the server, the current time at the location of the telephone 102, the current time at another suitable location); identify a period that includes the current time; identify one or more bids for the period; and identify an advertisement associated with at least one of those bids, which advertisement the server 114 may then send to the telephone 102. Also for instance, the server 114 may ascertain the current time; identify a period that includes the current time; identify one or more bids for the period; identify a zip code that is associated with at least a portion of a telephone number of the telephone 102; and identify an advertisement associated with the zip code and at least one of those bids, which the server 114 may then send to the telephone 102. In some embodiments, the advertisement identified at the block 138 may, for example, be associated with the highest bid for a particular zip code and/or a particular period. But the advertisement identified at the block 138 need not be associated with the highest bid for a particular zip code or a particular period.

In further detail, using the exemplary database 120 shown in FIG. 4-5, the following exemplary SQL Statement #3 could identify the file name and file extension (“Ads.File” and “Ads.Ext”) of at least one advertisement file that is associated with one or more bids for a period that includes a particular time (<Time>):

SQL Statement #3

SELECT Ads.File, Ads.Ext
FROM Ad_periods, Ad_bids, Ad_campaign_lookup, Ads
WHERE (<Time> BETWEEN Ad_periods.Start and Ad_periods.Stop)
AND
(Ad_periods.Period_id = Ad_bids.Period_id) AND
(Ad_bids.Campaign_id = Ad_campaign_lookup.Campaign_id) AND
(Ad_campaign_lookup.Ad_id = Ads.Ad_id)

As illustrated by the SQL Statement #3 and FIG. 4, the Ad_periods table may include various periods, for instance, different periods sharing a common length (for example, hourly intervals within a day) or different periods having various lengths (for example, peak intervals and off-peak intervals). Each row in the Ad_periods table preferably includes a name for a period (Ad_periods.Name), a value indicating the beginning of the period (Ad_periods.Start), a value indicating the end of the period (Ad_periods.Stop), and an identifier (Ad_periods.Period_id) used to identify the period.

As illustrated by the SQL Statement #3 and FIG. 4, the Ad_bids table may advantageously associate a bid with a campaign and/or a period. Each row in the Ad_bids table preferably includes an identifier (Ad_bids.Period_id) used to identify a period, an identifier (Ad_bids.Campaign_id) used to identify an advertising campaign, and a value indicating a bid (Ad_bids.Bid)—thus associating the bid with the campaign and the period.

In addition, as discussed above, the Ad_campaign_lookup table may advantageously associate at least one ad with at least one advertising campaign.

Consequently, the Ad_bids table and the Ad_campaign_lookup table may be used to join the Ad_periods table and the Ads table to identify a period that includes the current time; identify one or more bids for the period; and identify an advertisement associated with at least one of those bids. For example, as illustrated by the SQL Statement #3, the Ad_bids table and the Ad_campaign_lookup table may be used to identify one or more advertisements associated with one or more bids for a period that includes a particular time (<Time>).

Zip Codes/Advertisement Categories/Bids

If desired, the SQL Statement #1, the SQL Statement #2, the SQL Statement #3, other query statements, or any one or more thereof may be combined to identify bids at the block 138.

For example, the SQL Statement #1 and the SQL Statement #2 may be combined into SQL Statement #4 to identify the file name and file extension (“Ads.File” and “Ads.Ext”) of at least one advertisement file that is (1) associated with a zip code that is associated with an area code (<Telephone Area Code>) and a prefix (<Telephone Prefix>) and (2) associated with an advertisement category that is associated with a telephone number (<Telephone Number>)—as shown below:

SQL Statement #4

SELECT Ads.File, Ads.Ext
FROM Geo_Npa_nxx, Geo_Npa_nxx_Zipcode_Lookup, Geo_zipcodes, Ads,
Ad_system_geos, Geo_types_lookup, Ad_campaign_geos, Ad_campaign_lookup,
Agents, Ads_Types_Pref, Ads_Type_Lookup
WHERE (Geo_Npa_nxx.Npa = <Telephone Area Code>) AND
(Geo_Npa_nxx.Nxx = <Telephone Prefix>) AND
(Geo_Npa_nxx.Npa_nxx_id = Geo_Npa_nxx_Zipcode_Lookup.Npa_nxx_id) AND
(Geo_Npa_nxx_Zipcode_Lookup.Zipcode_id = Geo_zipcodes.Zipcode_id) AND
(Geo_zipcodes.Zipcode_id = Ad_system_geos.Geo_id) AND
(Ad_system_geos.Geo_type_id = Geo_types_lookup.Geo_type_id) AND
(Geo_types_lookup.Name = “ZIP Code”) AND
(Ad_system_geos.Geo_id = Ad_campaign_geos.Geo_id) AND
(Ad_system_geos.Geo_type_id =Ad_campaign_geos.Geo_type_id) AND
(Ad_campaign_geos.Campaign_id = Ad_campaign_lookup. Campaign_id) AND
(Ad_campaign_lookup.Ad_id = Ads.Ad_id) AND
(Agents.Phone = <Telephone Number>) AND
(Agents.Agent_id = Ads_Types_Pref.Agent_id) AND
(Ads_Types_Pref.Ad_type_id = Ads_Type_Lookup.Ad_type_id) AND
(Ads_Type_Lookup.Ad_id = Ads.Ad_id)

Also, for example, the SQL Statement #1 and the SQL Statement #3 may be combined into SQL Statement #5 to identify the file name and file extension (“Ads.File” and “Ads.Ext”) of at least one advertisement file that is (1) associated with a zip code that is associated with an area code (<Telephone Area Code>) and a prefix (<Telephone Prefix>) and (2) associated with one or more bids for a period that includes a particular time (<Time>)—as shown below:

SQL Statement #5

SELECT Ads.File, Ads.Ext
FROM Geo_Npa_nxx, Geo_Npa_nxx_Zipcode_Lookup, Geo_zipcodes, Ads,
Ad_system_geos, Geo_types_lookup, Ad_campaign_geos, Ad_campaign_lookup,
Ad_periods, Ad_bids
WHERE (Geo_Npa_nxx.Npa = <Telephone Area Code>) AND
(Geo_Npa_nxx.Nxx = <Telephone Prefix>) AND
(Geo_Npa_nxx.Npa_nxx_id = Geo_Npa_nxx_Zipcode_Lookup.Npa_nxx_id) AND
(Geo_Npa_nxx_Zipcode_Lookup.Zipcode_id = Geo_zipcodes.Zipcode_id) AND
(Geo_zipcodes.Zipcode_id = Ad_system_geos.Geo_id) AND
(Ad_system_geos.Geo_type_id = Geo_types_lookup.Geo_type_id) AND
(Geo_types_lookup.Name = “ZIP Code”) AND
(Ad_system_geos.Geo_id = Ad_campaign_geos.Geo_id) AND
(Ad_system_geos.Geo_type_id = Ad_campaign_geos.Geo_type_id) AND
(Ad_campaign_geos.Campaign_id = Ad_campaign_lookup.Campaign_id) AND
(Ad_campaign_lookup.Ad_id = Ads.Ad_id) AND
(<Time> BETWEEN Ad_periods.Start and Ad_periods.Stop) AND
(Ad_periods.Period_id = Ad_bids.Period_id) AND
(Ad_bids.Campaign_id = Ad_campaign_lookup.Campaign_id) AND
(Ad_campaign_lookup.Ad_id = Ads.Ad_id)

In addition, for example, the SQL Statement #1, the SQL Statement #2, and the SQL Statement #3 may be combined into SQL Statement #6 to identify the file name and file extension (“Ads.File” and “Ads.Ext”) of at least one advertisement file that is (1) associated with a zip code that is associated with an area code (<Telephone Area Code>) and a prefix (<Telephone Prefix>); (2) associated with an advertisement category that is associated with a telephone number (<Telephone Number>); and (3) associated with one or more bids for a period that includes a particular time (<Time>)—as shown below:

SQL Statement #6

SELECT Ads.File, Ads.Ext
FROM Geo_Npa_nxx, Geo_Npa_nxx_Zipcode_Lookup, Geo_zipcodes, Ads,
Ad_system_geos, Geo_types_lookup, Ad_campaign_geos, Ad_campaign_lookup,
Agents, Ads_Types_Pref, Ads_Type_Lookup, Ad_periods, Ad_bids
WHERE (Geo_Npa_nxx.Npa = <Telephone Area Code>) AND
(Geo_Npa_nxx.Nxx = <Telephone Prefix>) AND
(Geo_Npa_nxx.Npa_nxx_id = Geo_Npa_nxx_Zipcode_Lookup.Npa_nxx_id) AND
(Geo_Npa_nxx_Zipcode_Lookup.Zipcode_id = Geo_zipcodes.Zipcode_id) AND
(Geo_zipcodes.Zipcode_id = Ad_system_geos.Geo_id) AND
(Ad_system_geos.Geo_type_id = Geo_types_lookup.Geo_type_id) AND
(Geo_types_lookup.Name = “ZIP Code”) AND
(Ad_system_geos.Geo_id = Ad_campaign_geos.Geo_id) AND
(Ad_system_geos.Geo_type_id = Ad_campaign_geos.Geo_type_id) AND
(Ad_campaign_geos.Campaign_id = Ad_campaign_lookup. Campaign_id) AND
(Ad_campaign_lookup.Ad_id = Ads.Ad_id) AND
(Agents.Phone = <Telephone Number>) AND
(Agents.Agent_id = Ads_Types_Pref.Agent_id) AND
(Ads_Types_Pref.Ad_type_id = Ads_Type_Lookup.Ad_type_id) AND
(Ads_Type_Lookup.Ad_id = Ads.Ad_id) AND
(<Time> BETWEEN Ad_periods.Start and Ad_periods.Stop) AND
(Ad_periods.Period_id = Ad_bids.Period_id) AND
(Ad_bids.Campaign_id = Ad_campaign_lookup.Campaign_id) AND
(Ad_campaign_lookup.Ad_id = Ads.Ad_id)

Further, for example, the SQL Statement #2 and the SQL Statement #3 may be combined into SQL Statement #7 to identify the file name and file extension (“Ads.File”and “Ads.Ext”) of at least one advertisement file that is (1) associated with an advertisement category that is associated with a telephone number (<Telephone Number>) and (2) associated with one or more bids for a period that includes a particular time (<Time>)—as shown below:

SQL Statement #7

SELECT Ads.File, Ads.Ext
FROM Agents, Ads_Types_Pref, Ads_Type_Lookup, Ads,
Ad_periods, Ad_bids, Ad_campaign_lookup
WHERE (Agents.Phone = <Telephone Number>) AND
(Agents.Agent_id = Ads_Types_Pref.Agent_id)
AND
(Ads_Types_Pref.Ad_type_id = Ads_Type_Lookup.Ad_type_id)
AND
(Ads_Type_Lookup.Ad_id = Ads.Ad_id) AND
(<Time> BETWEEN Ad_periods.Start and Ad_periods.Stop) AND
(Ad_periods.Period_id = Ad_bids.Period_id) AND
(Ad_bids.Campaign_id = Ad_campaign_lookup.Campaign_id) AND
(Ad_campaign_lookup.Ad_id = Ads.Ad_id)

Geographical Regions

As shown above, the SQL Statements #1, #4, #5, and #6 may provide various means for identifying an advertisement at least partially based upon a geographical region (in particular, a zip code) associated with a telephone. If desired, the SQL Statements #1, #4, #5, and #6 may advantageously be modified to provide a means for identifying an advertisement at least partially based upon any desired geographical region (such as a zip code, a county, a state, a country or the like) associated with a telephone.

Geographical Regions (City)

For example, the SQL Statement #1 may be modified to the SQL Statement #8, which could identify the file name and file extension (“Ads.File” and “Ads.Ext”) of at least one advertisement file that is associated with a city that is associated with an area code (<Telephone Area Code>) and a prefix (<Telephone Prefix>):

SQL Statement #8

SELECT Ads.File, Ads.Ext
FROM Geo_Zipcode_City_Lookup,
Geo_Npa_nxx, Geo_Npa_nxx_Zipcode_Lookup, Ads,
Ad_system_geos, Geo_types_lookup, Ad_campaign_geos, Ad_campaign_lookup
WHERE (Geo_Npa_nxx.Npa = <Telephone Area Code>) AND
(Geo_Npa_nxx.Nxx = <Telephone Prefix>) AND
(Geo_Npa_nxx.Npa_nxx_id = Geo_Npa_nxx_Zipcode_Lookup.Npa_nxx_id) AND
(Geo_Npa_nxx_Zipcode_Lookup.Zipcode_id =
Geo_Zipcode_City_Lookup.Zipcode_id) AND
(Geo_Zipcode_City_Lookup.City_id = Ad_system_geos.Geo_id) AND
(Ad_system_geos.Geo_type_id = Geo_types_lookup.Geo_type_id) AND
(Geo_types_lookup.Name = “City”) AND
(Ad_system_geos.Geo_id = Ad_campaign_geos.Geo_id) AND
(Ad_system_geos.Geo_type_id = Ad_campaign_geos.Geo_type_id) AND
(Ad_campaign_geos.Campaign_id = Ad_campaign_lookup.Campaign_id) AND
(Ad_campaign_lookup.Ad_id = Ads.Ad_id)

As illustrated by the SQL Statement #8 and FIG. 4, the Geo_Cities table may include various cities. In particular, each row in the Geo_Cities table preferably includes a city (Geo_Cities.City) and an identifier (Geo_Cities.City_id) used to identify the city.

As illustrated by the SQL Statement #8 and FIG. 5, the Geo_Zipcode_City_Lookup table may advantageously associate at least one zip code with at least one city. For example, each row in the Geo_Zipcode_City_Lookup table preferably includes an identifier (Geo_Zipcode_City_Lookup.Zipcode_id) used to identify a zip code and an identifier (Geo_Zipcode_City_Lookup.City_id) used to identify a city—thus associating the zip code with the city.

Consequently, the Geo_Npa_nxx_Zipcode_Lookup table may be used to join the Geo_Zipcode_City_Lookup table and the Geo_Npa_nxx table to identify the cities that are associated with at least a portion of an identifier associated with a telephone. For example, as illustrated by the SQL Statement #8, the Geo_Npa_nxx_Zipcode_Lookup table may be used to identify one or more cities associated with an area code (<Telephone Area Code>) and a prefix (<Telephone Prefix>).

Geographical Regions (County)

Also, for example, the SQL Statement #1 may be modified to the SQL Statement #9, which could identify the file name and file extension (“Ads.File” and “Ads.Ext”) of at least one advertisement file that is associated with a county that is associated with an area code (<Telephone Area Code>) and a prefix (<Telephone Prefix>):

SQL Statement #9

SELECT Ads.File, Ads.Ext
FROM Geo_Zipcode_City_Lookup, Geo_City_County_Lookup,
Geo_Npa_nxx, Geo_Npa_nxx_Zipcode_Lookup, Ads,
Ad_system_geos, Geo_types_lookup, Ad_campaign_geos, Ad_campaign_lookup
WHERE (Geo_Npa_nxx.Npa = <Telephone Area Code>) AND
(Geo_Npa_nxx.Nxx = <Telephone Prefix>) AND
(Geo_Npa_nxx.Npa_nxx_id = Geo_Npa_nxx_Zipcode_Lookup.Npa_nxx_id) AND
(Geo_Npa_nxx_Zipcode_Lookup.Zipcode_id =
Geo_Zipcode_City_Lookup.Zipcode_id) AND
(Geo_Zipcode_City_Lookup.City_id = Geo_City_County_Lookup.City_id) AND
(Geo_City_County_Lookup.County_id = Ad_system_geos.Geo_id) AND
(Ad_system_geos.Geo_type_id = Geo_types_lookup.Geo_type_id) AND
(Geo_types_lookup.Name = “County”) AND
(Ad_system_geos.Geo_id = Ad_campaign_geos.Geo_id) AND
(Ad_system_geos.Geo_type_id = Ad_campaign_geos.Geo_type_id) AND
(Ad_campaign_geos.Campaign_id = Ad_campaign_lookup.Campaign_id) AND
(Ad_campaign_lookup.Ad_id = Ads.Ad_id)

As illustrated by FIG. 4, the Geo_County table may include various states. In particular, each row in the Geo_County table preferably includes a county (Geo_County. County) and an identifier (Geo_County.County_id) used to identify the county.

As illustrated by the SQL Statement #9 and FIG. 5, the Geo_City_County_Lookup table may advantageously associate at least one city with at least one county. For example, each row in the Geo_City_County_Lookup table preferably includes an identifier (Geo_City_County_Lookup.City_id) used to identify a city and an identifier (Geo_City_County_Lookup.County_id) used to identify a county—thus associating the city with the county.

As discussed above, the Geo_Zipcode_City_Lookup table may advantageously associate at least one zip code with at least one city.

Consequently, the Geo_Npa_nxx_Zipcode_Lookup table and the Geo_Zipcode_City_Lookup table may be used to join the Geo_City_County_Lookup table and the Geo_Npa_nxx table to identify the counties that are associated with at least a portion of an identifier associated with a telephone. For example, as illustrated by the SQL Statement #9, the Geo_Npa_nxx_Zipcode_Lookup table and the Geo_Zipcode_City_Lookup table may be used to identify one or more counties associated with an area code (<Telephone Area Code>) and a prefix (<Telephone Prefix>).

Geographical Regions (State)

Also, for example, the SQL Statement #1 may be modified to the SQL Statement #10, which could identify the file name and file extension (“Ads.File” and “Ads.Ext”) of at least one advertisement file that is associated with a state that is associated with an area code (<Telephone Area Code>) and a prefix (<Telephone Prefix>):

SQL Statement #10

SELECT Ads.File, Ads.Ext
FROM Geo_Zipcode_City_Lookup, Geo_City_State_Lookup,
Geo_Npa_nxx, Geo_Npa_nxx_Zipcode_Lookup, Ads,
Ad_system_geos, Geo_types_lookup, Ad_campaign_geos, Ad_campaign_lookup
WHERE (Geo_Npa_nxx.Npa = <Telephone Area Code>) AND
(Geo_Npa_nxx.Nxx = <Telephone Prefix>) AND
(Geo_Npa_nxx.Npa_nxx_id = Geo_Npa_nxx_Zipcode_Lookup.Npa_nxx_id) AND
(Geo_Npa_nxx_Zipcode_Lookup.Zipcode_id =
Geo_Zipcode_City_Lookup.Zipcode_id) AND
(Geo_Zipcode_City_Lookup.City_id = Geo_City_State_Lookup.City_id) AND
(Geo_City_State_Lookup.State_id = Ad_system_geos.Geo_id) AND
(Ad_system_geos.Geo_type_id = Geo_types_lookup.Geo_type_id) AND
(Geo_types_lookup.Name = “State”) AND
(Ad_system_geos.Geo_id = Ad_campaign_geos.Geo_id) AND
(Ad_system_geos.Geo_type_id = Ad_campaign_geos.Geo_type_id) AND
(Ad_campaign_geos.Campaign_id = Ad_campaign_lookup.Campaign_id) AND
(Ad_campaign_lookup.Ad_id = Ads.Ad_id)

As illustrated by FIG. 4, the Geo_states table may include various states. In particular, each row in the Geo_states table preferably includes a state (Geo_states.State) and an identifier (Geo_states.State_id) used to identify the state.

As illustrated by the SQL Statement #10 and FIG. 5, the Geo_City_State_Lookup table may advantageously associate at least one city with at least one state. For example, each row in the Geo_City_State_Lookup table preferably includes an identifier (Geo_City_State_Lookup.City_id) used to identify a city and an identifier (Geo_City_State_Lookup.State_id) used to identify a state—thus associating the city with the state.

As discussed above, the Geo_Zipcode_City_Lookup table may advantageously associate at least one zip code with at least one city.

Consequently, the Geo_Npa_nxx_Zipcode_Lookup table and the Geo_Zipcode_City_Lookup table may be used to join the Geo_City_State_Lookup table and the Geo_Npa_nxx table to identify the states that are associated with at least a portion of an identifier associated with a telephone. For example, as illustrated by the SQL Statement #10, the Geo_Npa_nxx_Zipcode_Lookup table and the Geo_Zipcode_City_Lookup table may be used to identify one or more states associated with an area code (<Telephone Area Code>) and a prefix (<Telephone Prefix>).

In sum, as shown above, an advertisement may be identified at least partially based upon (1) an identifier that is associated with a telephone; (2) a geographical region, such as a zip code, a county, a state, a country or the like; (3) an advertisement category; (4) a bid; (5) a time period; (6) one or more other suitable factors; or any one or more thereof.

### Exemplary User Interfaces

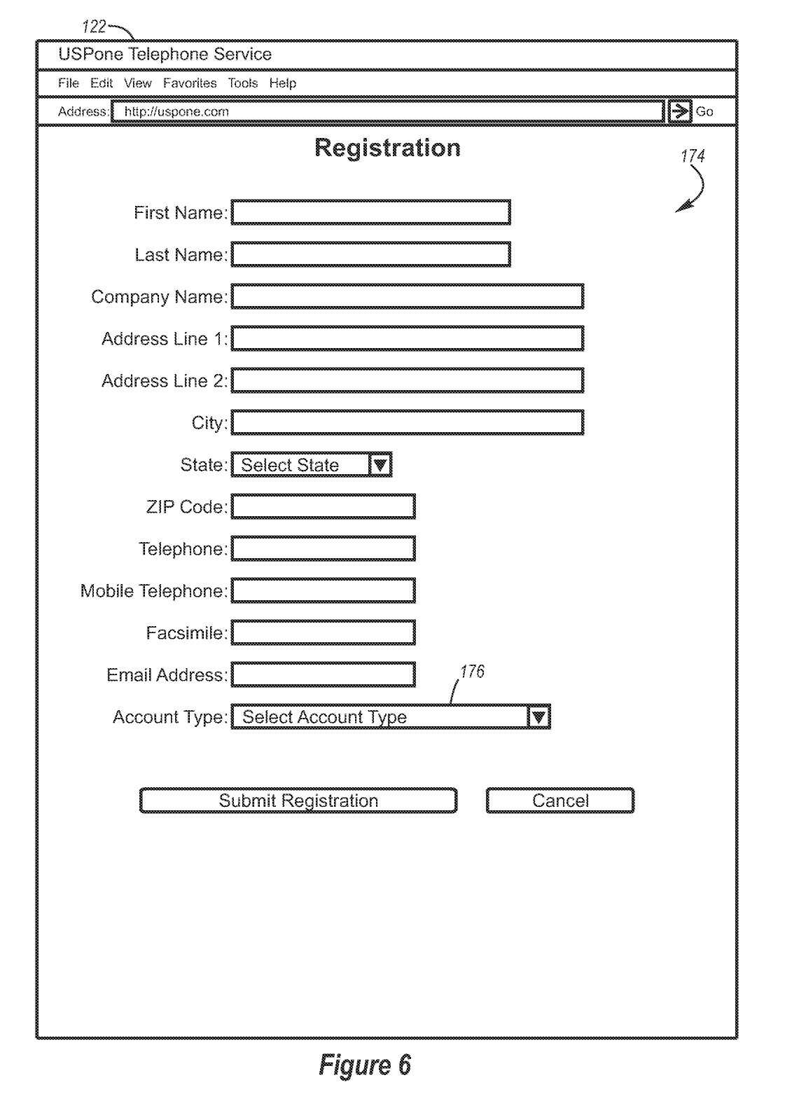

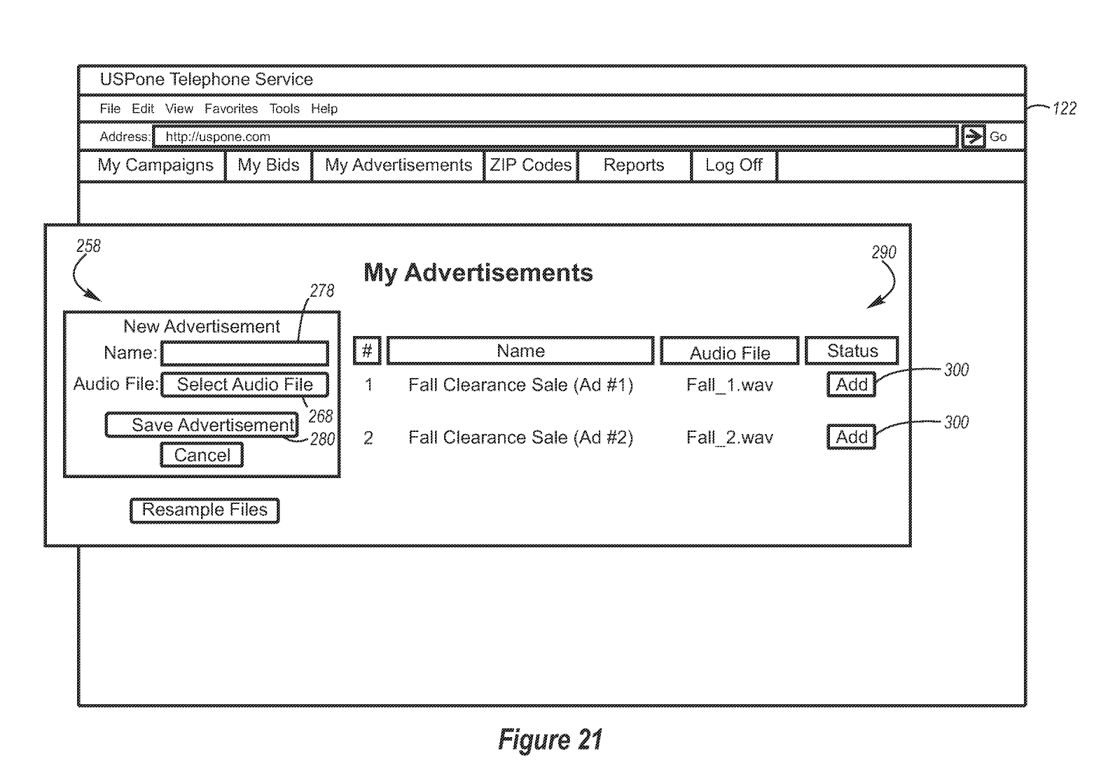

As shown in FIGS. 6-7, 9, 11, 13, 15, 17-21, 23-25, 28, 30, 32-33, 35-36, 38 and 39, user interfaces may include one or more user interface elements configured to receive user input. For example, user interfaces preferably comprise graphical user interfaces including one or more graphical user interface elements, such as buttons, pull down menus, dialog boxes, check boxes, radio or option buttons, drop-down list boxes, scroll bars, scroll boxes, text boxes, and the like. Throughout this patent application, various graphical user interfaces and graphical user interface elements are depicted; however, the depicted graphical user interfaces and graphical user interface elements are not necessary to receive any particular user input. Indeed, other user interfaces and/or other user interface elements may be configured to receive the user input described in this patent application. Accordingly, although particular user interfaces with particular user interface elements are depicted in FIGS. 6-7, 9, 11, 13, 15, 17-21, 23-25, 28, 30, 32-33, 35-36, 38 and 40, the embodiments of the present invention are not limited to those user interfaces or to those user interface elements. Also, the user input need not be received via any user interface and may be received via other suitable means. Further, the embodiments of the present invention do not require any user input to be received—whether via user interface elements or other means.

As shown below, the interface server 118 (FIG. 1) may advantageously provide user interface data for displaying these user interfaces shown in FIGS. 6-7, 9, 11, 13, 15, 17-21, 23-25, 28, 30, 32-33, 35-36, 38 and 40 to the browser 122 (FIG. 1) via a network (such as, the network 112). The browser 122 may then use the user interface data to display the user interfaces. If desired, the network 112 may comprise the Internet. However, the network 112 need not comprise the Internet, and the network 112 may comprise any other suitable type of network.

Registration

As shown in FIG. 6, a user interface 174 may include one or more user interface elements configured to receive data indicating a person, which may be used to create a user account. In particular, as shown in FIG. 6, the user interface 174 may include user interface elements configured to receive a first name, a last name, a company name, one or more address lines, a city, a state, a zip code, one or more telephone numbers (e.g., for home, work, mobile, facsimile, and the like), an email address, other data, or any one or more thereof—which data may be stored, for example, in the Agents table in the database 120 (FIG. 4). The user interface 174 may include user interface elements configured to receive a username and a password to allow persons to log onto their user accounts, and the username and password may also be stored, for example, in the Agents table in the database 120 (FIG. 4).

The user interface 174 desirably may be used to create various user accounts, such as customer user accounts or advertiser user accounts. For example, the user interface 174 may include a user interface element (such as, a drop-down list box 176), which may receive an account type, such as “customer” or “advertiser.” As discussed in further detail below, a customer may use a customer account to select preferred advertisement categories, which may be used to identify an advertisement (e.g., at the block 138 in FIG. 2) that is provided to the customer (e.g., at the block 156 in FIG. 3). Also discussed in further detail below, an advertiser may use an advertiser account to create and maintain advertising campaigns including one or more advertisements, which may be provided to customers (e.g., at the block 156 in FIG. 3). In some embodiments, the Agents table in the database 120 (FIG. 4) may include data for both customer user accounts and advertiser user accounts; and the Advertisers table may be used to indicate whether a particular account in the Agents table is for a customer or an advertiser. For example, to indicate that a particular account in the Agents table is an advertiser, the interface server 118 may create a row in the Advertisers table with the Agent_id in the Advertisers table being set to the Agent_id of the account in the Agents table; but when an account in the Agents table is a customer, no such row is created in the Advertisers table. Thus, the Agents table and the Advertisers table may be joined to determine whether a particular account in the Agents table is for an advertiser or a customer.

“My Campaigns” Tab

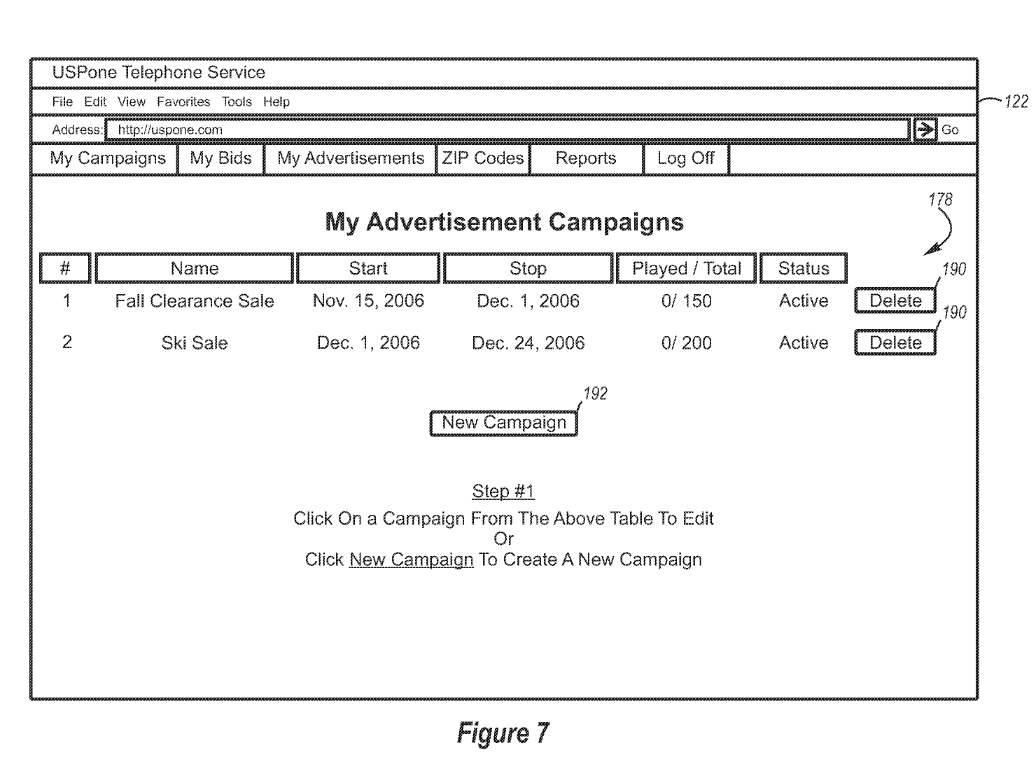

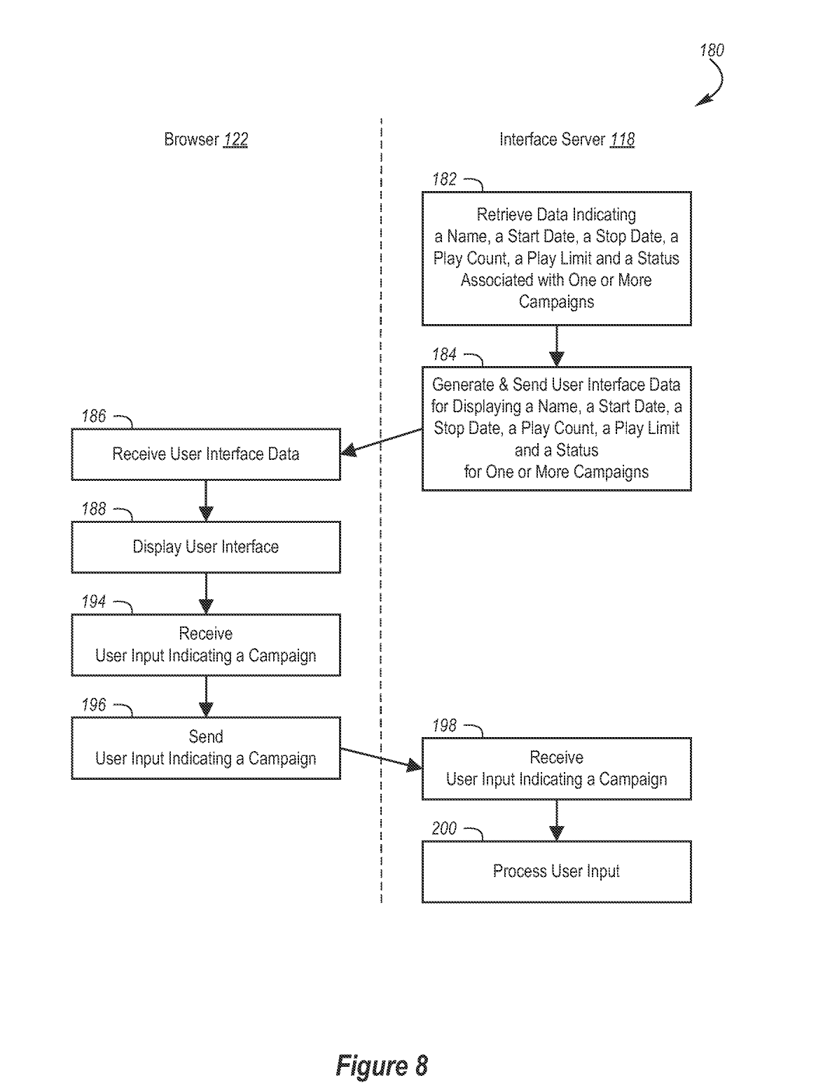

As shown in FIGS. 7 and 8, an advertiser may click a tab (for example, a “My Campaigns” tab) to access a user interface 178, which may display the advertiser's campaigns. For example, as shown in FIG. 8, the browser 122 and the interface server 118 may perform one or more portions of the method 180 in response to the advertiser's clicking of the “My Campaigns” tab. The method 180 may be performed by the telecommunications system 106; the browser 122; the interface server 118; one or more other suitable components, systems, modules, and the like; or any one or more thereof. Of course, the entire method 180 need not be performed; and any part or parts of the method 180 may be performed to provide a useful method 180.

In further detail, at a block 182, the interface server 118 may retrieve data indicating a name, a start date, a stop date, an advertisement play count, an advertisement play limit, and/or a status associated with one or more campaigns. In particular, the interface server 118 may retrieve this data from the Ad_campaigns table in the database 120 (FIG. 4) by, for example, retrieving rows from the Ad_campaigns table that include the advertiser's Advertiser_id.

At a block 184, the interface server 118 may generate user interface data (such as, an HTML document, an XML document, other types of documents, and/or other suitable user interface data) configured for displaying a name, a start date, a stop date, an advertisement play count, an advertisement play limit, and/or a status associated with one or more campaigns. For example, the interface server 118 may use the data retrieved at the block 182 in generating the user interface data at the block 184. In addition, at the block 184, the interface server 118 may send this user interface data to the browser 122 via, for example, the network 112. At a block 186, the browser 122 may receive the user interface data generated at the block 184 via, for example, the network 112; and the browser 122 may use the user interface data to display the user interface 178 at a block 188.

As shown in FIG. 7, the user interface 178 may display a name, a start date, a stop date, an advertisement play count, an advertisement play limit, and/or a status associated with one or more of an advertiser's campaigns. In addition, the user interface 178 may include one or more buttons 190 used in deleting campaigns and a button 192 used in creating new campaigns.

As shown in FIG. 7, the start date and the stop date of an advertiser's advertising campaign may advantageously indicate a period during which any advertisements of the advertiser's advertising campaign may be provided to customers (e.g., at the block 156 in FIG. 3). For example, using the exemplary database 120 shown in FIG. 4-5, the following exemplary SQL Statement #11 may be used to identify (e.g., at the block 138 in FIG. 2) the file name and file extension (“Ads.File” and “Ads.Ext”) of at least one advertisement file that may be provided on a particular date (<Date>) as part of an advertising campaign (<Campaign>) of an advertiser (<Advertiser>):

SQL Statement #11

SELECT Ads.File, Ads.Ext
FROM Ads, Ad_campaign_lookup, Ad_campaigns
WHERE (Ad_campaigns.Advertiser_id = <Advertiser>) AND
(Ad_campaigns.Campaign_id = <Campaign>) AND
(<Date> BETWEEN Ad_campaigns.Start and Ad_campaigns.Stop) AND
(Ad_campaigns.Campaign_id = Ad_campaign_lookup.Campaign_id)
AND
(Ads.Ad_id = Ad_campaign_lookup.Ad_id)

As shown in FIG. 7, the advertisement play count of an advertiser's advertising campaign may advantageously indicate the total number of times advertisements from the campaign has been provided to customers, and the advertisement play limit of the advertiser's advertising campaign may be used to affect the total number of times that advertisements from the campaign can be provided to customers (e.g., at the block 156 in FIG. 3). For example, using the exemplary database 120 shown in FIG. 4-5, the following exemplary SQL Statement #12 may be used to identify (e.g., at the block 138 in FIG. 2) the file name and file extension (“Ads.File” and “Ads.Ext”) of at least one advertisement file that may be provided as part of an advertising campaign (<Campaign>) of an advertiser (<Advertiser>) that has an associated total number of times that the advertisements are to be provided:

SQL Statement #12

SELECT Ads.File, Ads.Ext
FROM Ads, Ad_campaign_lookup, Ad_campaigns
WHERE (Ad_campaigns.Advertiser_id = <Advertiser>) AND
(Ad_campaigns.Campaign_id = <Campaign>) AND
(Ad_campaigns.Played < Ad_campaigns.Total) AND
(Ad_campaigns.Campaign_id = Ad_campaign_lookup.Campaign_id)
AND
(Ads.Ad_id = Ad_campaign_lookup.Ad_id)

In some embodiments, the system 100 may limit the total number of times advertisements from a particular advertising campaign may be provided. In some embodiments, the system 100 may limit the total number of times the system provides a particular advertisement. In some embodiments, the system 100 may limit the number of times the system provides a particular advertisement to a particular subset of one or more zip codes or a particular subset of one or more telephones (e.g., a particular ANI).

The status of an advertiser's advertising campaign may advantageously indicate whether an advertising campaign is active, that is, advertisements from the campaign can be provided to customers (e.g., at the block 156 in FIG. 3). For example, using the exemplary database 120 shown in FIG. 4-5, the following exemplary SQL Statement #13 may be used to identify (e.g., at the block 138 in FIG. 2) the file name and file extension (“Ads.File” and “Ads.Ext”) of at least one advertisement file that may be provided as part of an advertising campaign (<Campaign>) of an advertiser (<Advertiser>) because of the advertising campaign's active status:

SQL Statement #13

SELECT Ads.File, Ads.Ext
FROM Ads, Ad_campaign_lookup, Ad_campaigns
WHERE (Ad_campaigns.Advertiser_id = <Advertiser>) AND
(Ad_campaigns.Campaign_id = <Campaign>) AND
(Ad_campaigns.Status = “Active”) AND
(Ad_campaigns.Campaign_id = Ad_campaign_lookup.Campaign_id)
AND
(Ads.Ad_id = Ad_campaign_lookup.Ad_id)

Referring again to FIGS. 7 and 8, at a block 194, the browser 122 may receive user input indicating a campaign using the user interface 178. At a block 196, the browser 122 may send this user input to the interface server 118 via, for example, the network 112. At a block 198, the interface server 118 may receive this user input via, for example, the network 112; and the interface server 118 may process this user input at a block 200.

In one instance, the user input indicating a campaign may be received by, for example, an advertiser clicking on a delete button 190; and thus the user input indicates that the campaign should be deleted. Consequently, at the block 200, the interface server 118 may alter the database 120 to reflect that deletion.

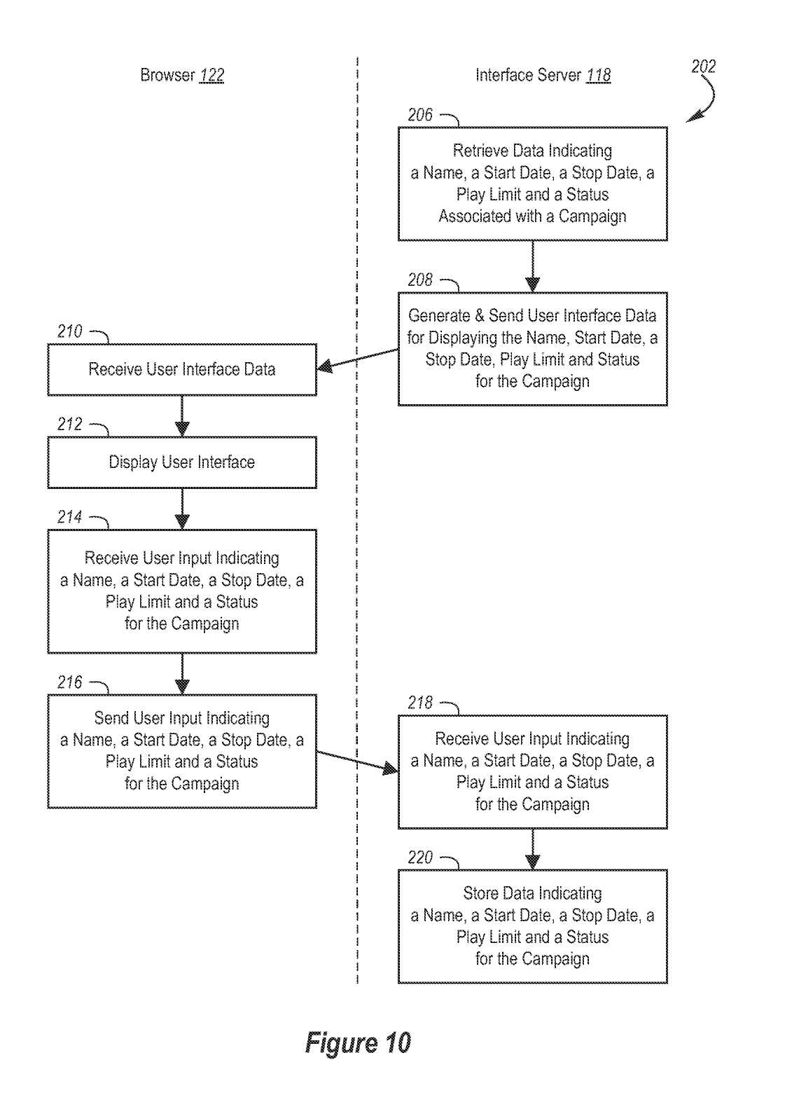

In another instance, the user input indicating a campaign preferably indicates that the campaign should be viewed and/or edited, and the user input is preferably received by an advertiser clicking on the name of a campaign displayed in the user interface 178. Consequently, at the block 200, the interface server 118 may perform at least a portion of the method 202 (FIG. 10) to help provide a user interface 204 that an advertiser may use to view and/or edit aspects of the selected campaign.

As shown in FIG. 10, the browser 122 and the interface server 118 may perform one or more portions of the method 202 in response to an advertiser's selection of a campaign. The method 202 may be performed by the telecommunications system 106; the browser 122; the interface server 118; one or more other suitable components, systems, modules, and the like; or any one or more thereof. Of course, the entire method 202 need not be performed; and any part or parts of the method 202 may be performed to provide a useful method 202.

In further detail, at a block 206, the interface server 118 may retrieve data indicating a name, a start date, a stop date, an advertisement play count, an advertisement play limit, and/or a status associated with a campaign, such as the campaign selected via the user input received at the block 194 (FIG. 8). In particular, the interface server 118 may retrieve this data from the Ad_campaigns table in the database 120 (FIG. 4) by, for example, selecting the row from the Ad_campaigns table that includes the selected campaign's Campaign_id.

At a block 208, the interface server 118 may generate user interface data configured for displaying a name, a start date, a stop date, an advertisement play count, an advertisement play limit, and/or a status associated with the campaign selected via the user input received at the block 194 (FIG. 8). For example, the interface server 118 may use the data retrieved at the block 206 in generating the user interface data at the block 208. In addition, at the block 208, the interface server 118 may send this user interface data to the browser 122 via, for example, the network 112. At a block 210, the browser 122 may receive the user interface data generated at the block 208 via, for example, the network 112; and the browser 122 may use the user interface data to display the user interface 204 at a block 212.

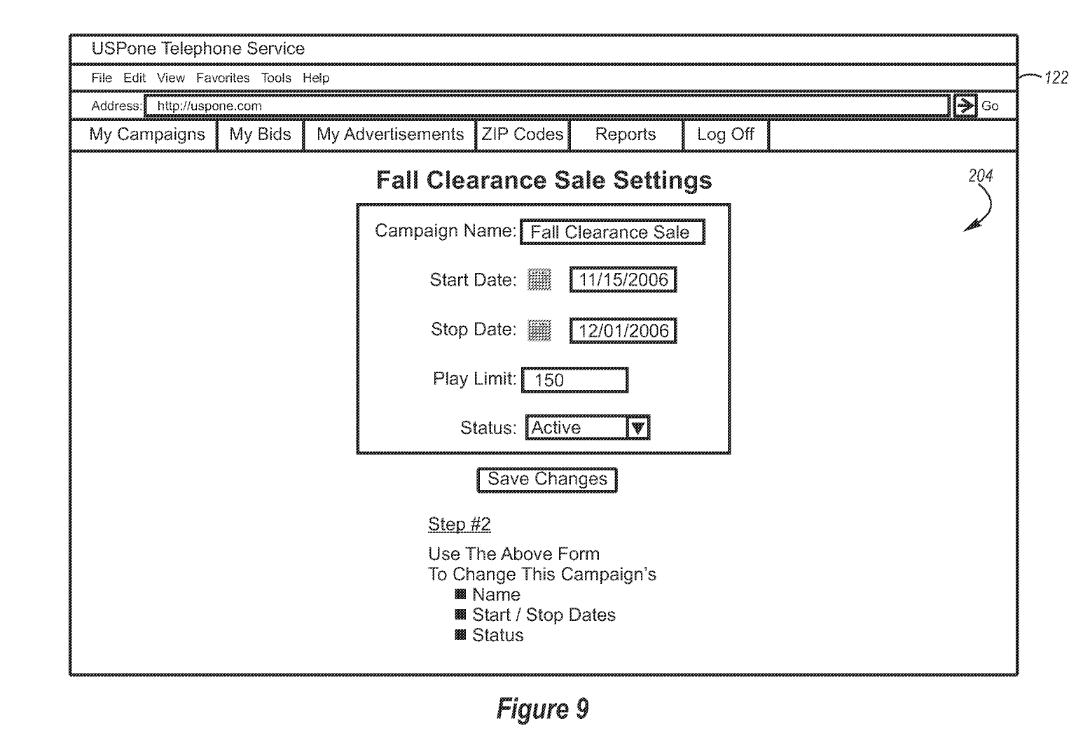

As shown in FIG. 9, the user interface 204 may include one or more user interface elements configured to receive user input indicating a name, a start date, a stop date, an advertisement play limit, and/or a status for a selected campaign. Consequently, at a block 214 (FIG. 10), the browser 122 may receive the user input indicating a name, a start date, a stop date, an advertisement play limit, and/or a status for a selected campaign. At a block 216, the browser 122 may send this user input to the interface server 118 via, for example, the network 112. At a block 218, the interface server 118 may receive this user input via, for example, the network 112; and the interface server 118 may store data indicating a name, a start date, a stop date, an advertisement play limit, and/or a status for the selected campaign at a block 220. For example, the interface server 118 may store such data in the Ad_campaigns table in the database 120 (FIG. 4).

“My Bids” Tab

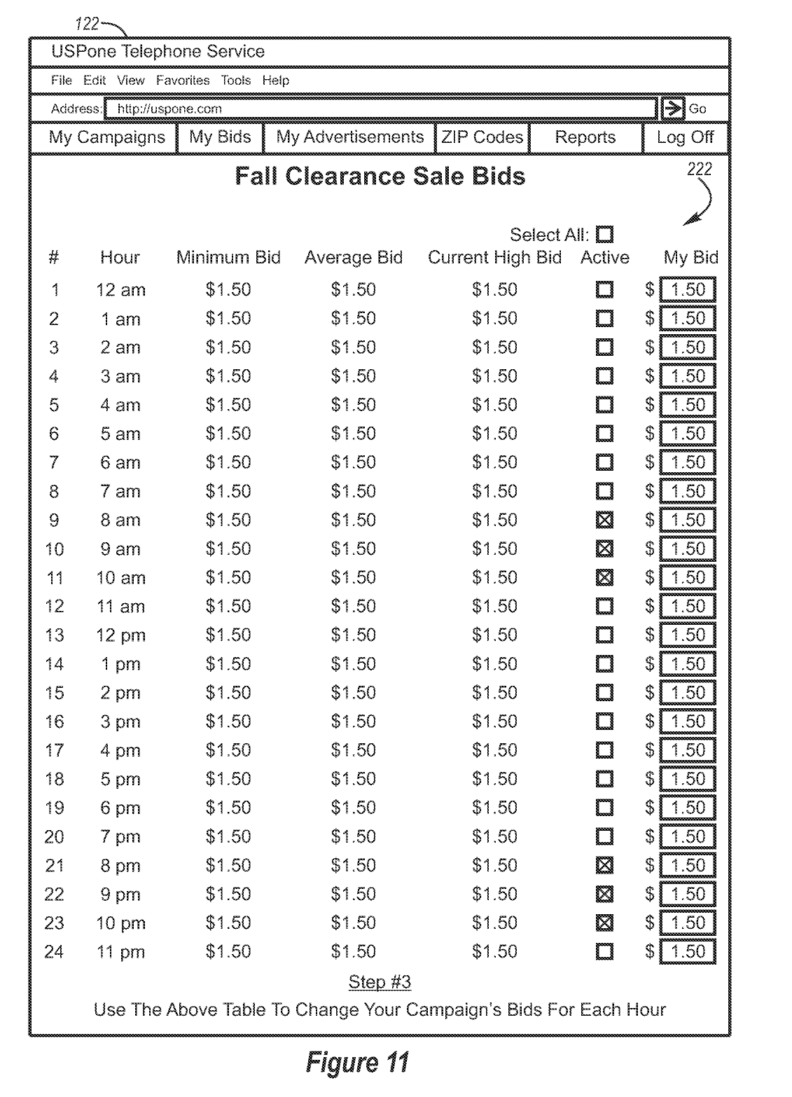

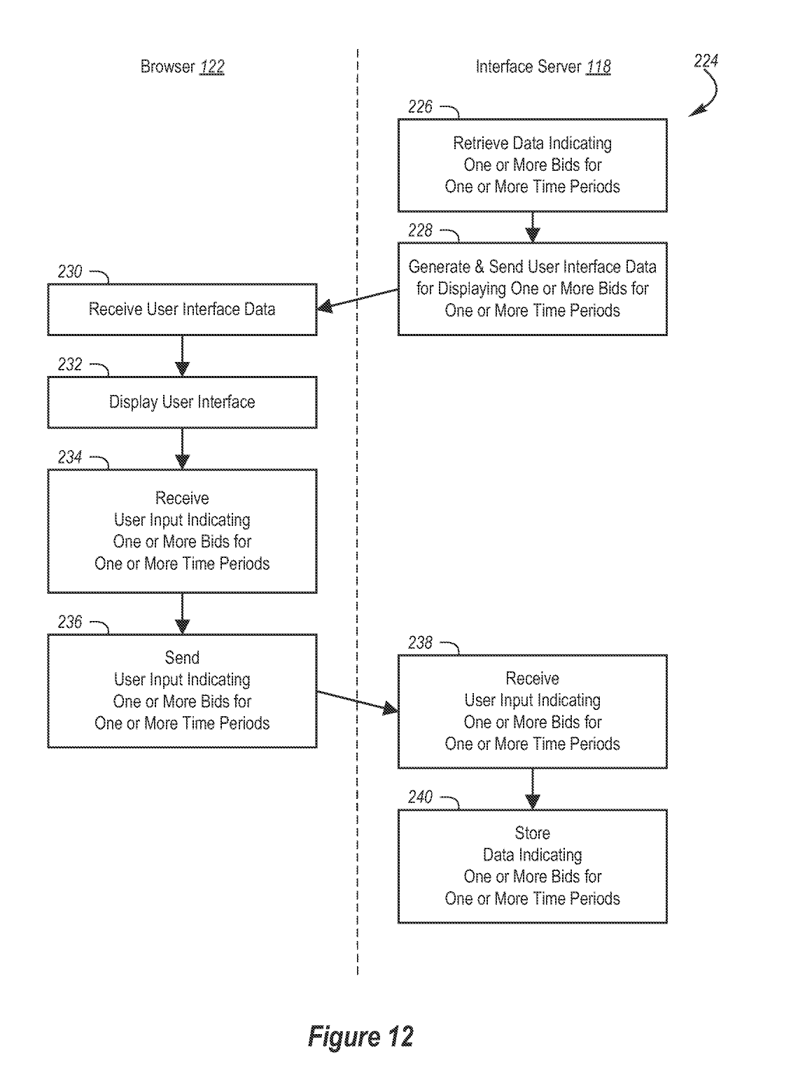

As shown in FIGS. 11 and 12, an advertiser may click a tab (for example, a “My Bids” tab) to access a user interface 222, which may display one or more bids associated with the currently selected campaign. For example, as shown in FIG. 12, the browser 122 and the interface server 118 may perform one or more portions of the method 224 in response to the advertiser's clicking of the “My Bids” tab. The method 224 may be performed by the telecommunications system 106; the browser 122; the interface server 118; one or more other suitable components, systems, modules, and the like; or any one or more thereof. Of course, the entire method 224 need not be performed; and any part or parts of the method 224 may be performed to provide a useful method 224.

In further detail, at a block 226, the interface server 118 may retrieve data indicating one or more time periods, one or more of the advertiser's bids that are associated with the time periods and the currently selected campaign, and a status associated with those bids. In particular, the interface server 118 may retrieve this data from the Ad_bids table in the database 120 (FIG. 4) by, for example, retrieving the rows from the Ad_bids table that include the currently selected campaign's Campaign_id.

As shown in FIG. 4, each row in the Ad_bids table preferably includes an identifier (Ad_bids.Advertiser_id) used to identify an advertiser, an identifier (Ad_bids.Campaign_id) used to identify one of the advertiser's campaigns, an identifier (Ad_bids.Period_id) used to identify a period, and a bid (Ad_bids.Bid)—thus associating that bid with the period and the campaign. In addition, each row in the Ad_bids table preferably includes a status indicating whether the bid is active, that is, can be accepted for the associated time period. In addition, at the block 226, the interface server 118 may retrieve data indicating one or more statistics (such as, minimum bid values, average bid values, median bid values and/or the like) for the time periods. As shown in FIG. 4, the Ad_min bids table may include an identifier (Ad_min_bids.Period_id) used to identify a period, a minimum bid (Ad_min_bids.Bid) and a date (Ad_min_bids.Date) on which the minimum bid becomes effective. Thus, by using the Ad_min_bids table, a particular minimum bid may remain in effect until the date another minimum bid becomes effective for a particular period.

At a block 228, the interface server 118 may generate user interface data configured for displaying one or more time periods; one or more statistics (such as, minimum bid values, average bid values, median bid values and/or the like) for the time periods; one or more of the advertiser's bids that are associated with the time periods and the currently selected campaign; and a status associated with those bids. For example, the interface server 118 may use the data retrieved at the block 226 in generating the user interface data at the block 228. In addition, at the block 228, the interface server 118 may send this user interface data to the browser 122 via, for example, the network 112. At a block 230, the browser 122 may receive the user interface data generated at the block 228 via, for example, the network 112; and the browser 122 may use the user interface data to display the user interface 222 at a block 232.

As shown in FIG. 11, the user interface 222 may include one or more user interface elements configured to receive user input indicating one or more of the bids for one or more time periods, for example, bids associated with a selected campaign. Consequently, at a block 234 (FIG. 12), the browser 122 may receive the user input indicating one or more of the bids for one or more time periods. At a block 236, the browser 122 may send this user input to the interface server 118 via, for example, the network 112. At a block 238, the interface server 118 may receive this user input via, for example, the network 112; and the interface server 118 may store data indicating one or more of the bids for one or more time periods at a block 240. For example, the interface server 118 may store such data in the Ad_bids table in the database 120 (FIG. 4).

“My Advertisements” Tab

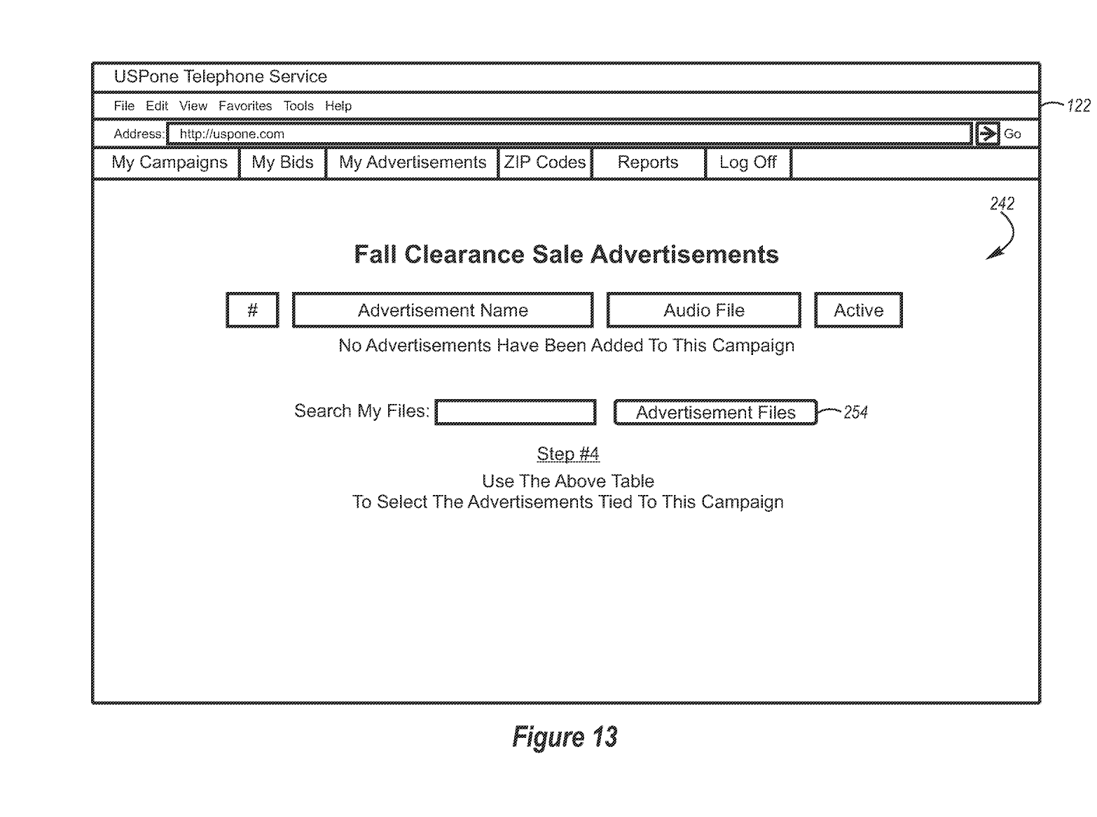

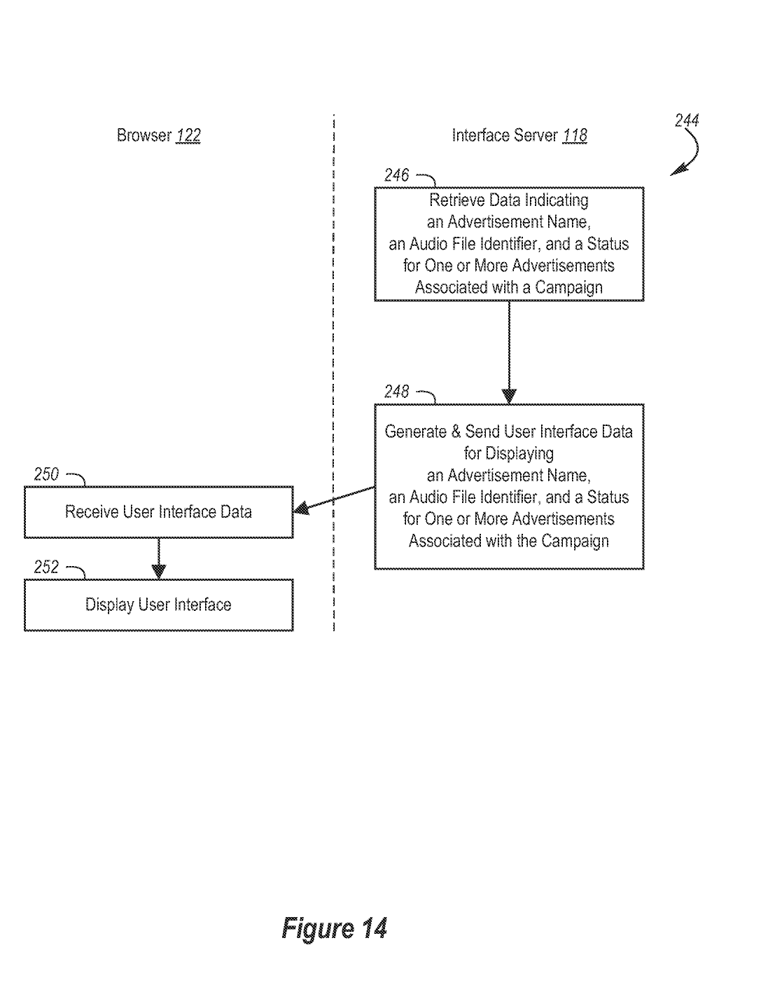

As shown in FIGS. 13 and 14, an advertiser may click a tab (for example, a “My Advertisements” tab) to access a user interface 242, which may display one or more advertisements associated with the currently selected campaign. For example, as shown in FIG. 14, the browser 122 and the interface server 118 may perform one or more portions of the method 244 in response to the advertiser's clicking of the “My Advertisements” tab. The method 244 may be performed by the telecommunications system 106; the browser 122; the interface server 118; one or more other suitable components, systems, modules, and the like; or any one or more thereof. Of course, the entire method 244 need not be performed; and any part or parts of the method 244 may be performed to provide a useful method 244.

In further detail, at a block 246, the interface server 118 may retrieve data indicating an advertisement name, an advertisement file identifier (such as an audio file identifier), and a status for one or more advertisements that are associated with the currently selected campaign. For example, using the exemplary database 120 shown in FIG. 4, the following exemplary SQL Statement #14 may be used to identify the name (“Ads.Name”), advertisement file identifier (“Ads.File” and “Ads.Ext”), and status (“Ad_campaign_lookup.Status”) of at least one advertisement associated with an advertising campaign (<Campaign>) of an advertiser (<Advertiser>):

SQL Statement #14

SELECT Ads.Name, Ads.File, Ads.Ext, Ad_campaign_lookup.Status
FROM Ads, Ad_campaign_lookup, Ad_campaigns
WHERE (Ad_campaigns.Advertiser_id = <Advertiser>) AND
(Ad_campaigns.Campaign_id = <Campaign>) AND
(Ad_campaigns.Campaign_id = Ad_campaign_lookup.Campaign_id)
AND
(Ads.Ad_id = Ad_campaign_lookup.Ad_id)

As shown in FIG. 4, each row in the Ads table preferably includes a name of an advertisement (Ads.Name), an advertisement file name (Ads.File), an advertisement file extension (Ads.Ext), and an identifier (Ads.Ad_id) used to identify the advertisement, and an identifier (Ads.Advertiser_id) used to identify an advertiser—thus associating that advertisement with the advertiser. In addition, each row in the Ads table preferably includes a status (Ads.Status) indicating whether the advertisement is active, that is, can be associated with one or more campaigns. Also, each row in the Ad_campaign_lookup table preferably includes a status (Ad_campaign_lookup.Status) indicating whether an advertisement associated with an advertising campaign is active, that is, can be provided to customers (e.g., at the block 156 in FIG. 3).

At a block 248, the interface server 118 may generate user interface data configured for displaying an advertisement name, an advertisement file identifier (such as an audio file identifier), and a status for one or more advertisements that are associated with the currently selected campaign. For example, the interface server 118 may use the data retrieved at the block 246 in generating the user interface data at the block 248. In addition, at the block 248, the interface server 118 may send this user interface data to the browser 122 via, for example, the network 112. At a block 250, the browser 122 may receive the user interface data generated at the block 248 via, for example, the network 112; and the browser 122 may use the user interface data to display the user interface 242 at a block 252.

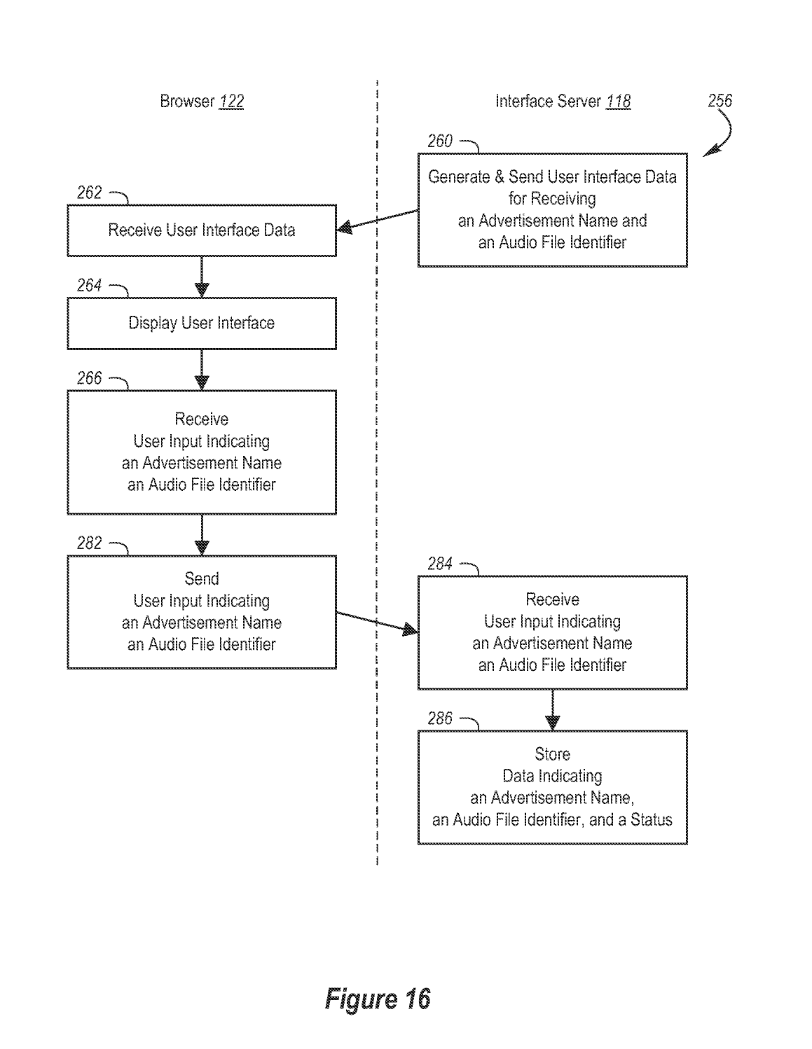

As shown in FIG. 13, no advertisements have been associated with the currently selected campaign. In response to the click of the button 254, at least a portion of a method 256 may be performed to provide a user interface 258 that an advertiser may use to associate one or more advertisements with the currently selected campaign. As shown in FIG. 16, the browser 122 and the interface server 118 may perform one or more portions of the method 256 in response to the click of the button 254. The method 256 may be performed by the telecommunications system 106; the browser 122; the interface server 118; one or more other suitable components, systems, modules, and the like; or any one or more thereof. Of course, the entire method 256 need not be performed; and any part or parts of the method 256 may be performed to provide a useful method 256.

At a block 260, the interface server 118 may generate user interface data configured for receiving an advertisement name and an advertisement file identifier (such as an audio file identifier). In addition, at the block 260, the interface server 118 may send this user interface data to the browser 122 via, for example, the network 112. At a block 262, the browser 122 may receive the user interface data generated at the block 260 via, for example, the network 112; and the browser 122 may use the user interface data to display the user interface 258 at a block 264.

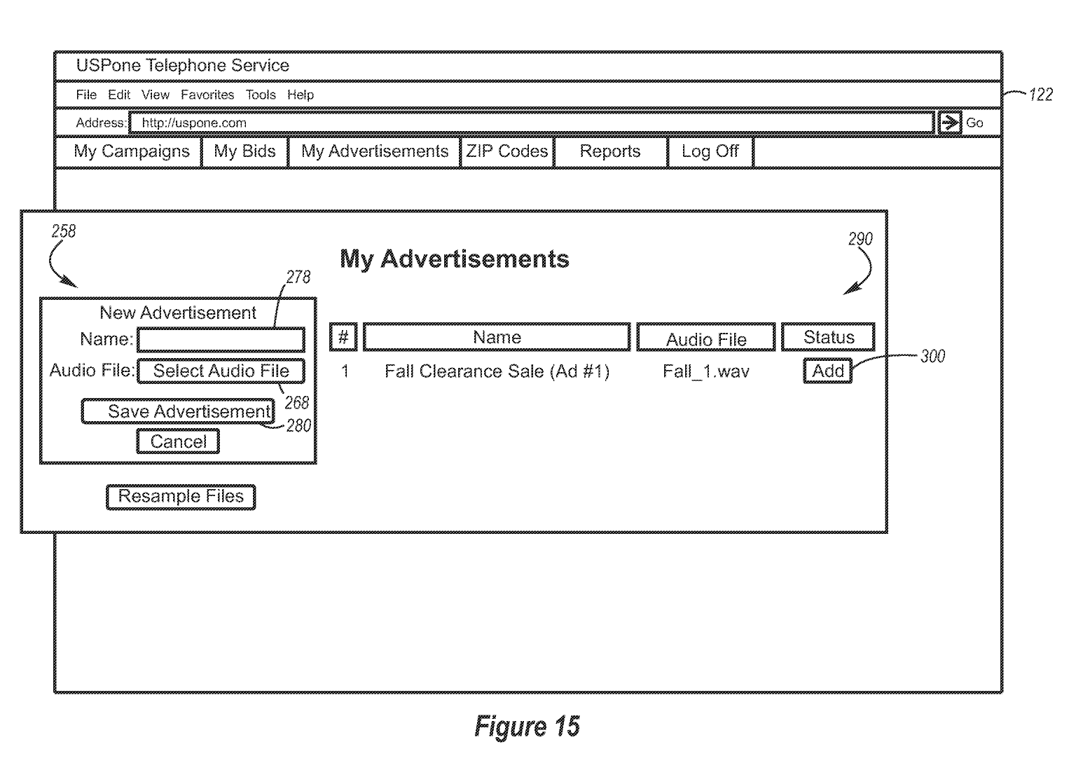

As shown in FIG. 15, the user interface 258 may include one or more user interface elements configured to receive an advertisement name and an advertisement file identifier (such as an audio file identifier). Consequently, at a block 266 (FIG. 16), the browser 122 may receive the user input indicating an advertisement name and an audio file identifier.

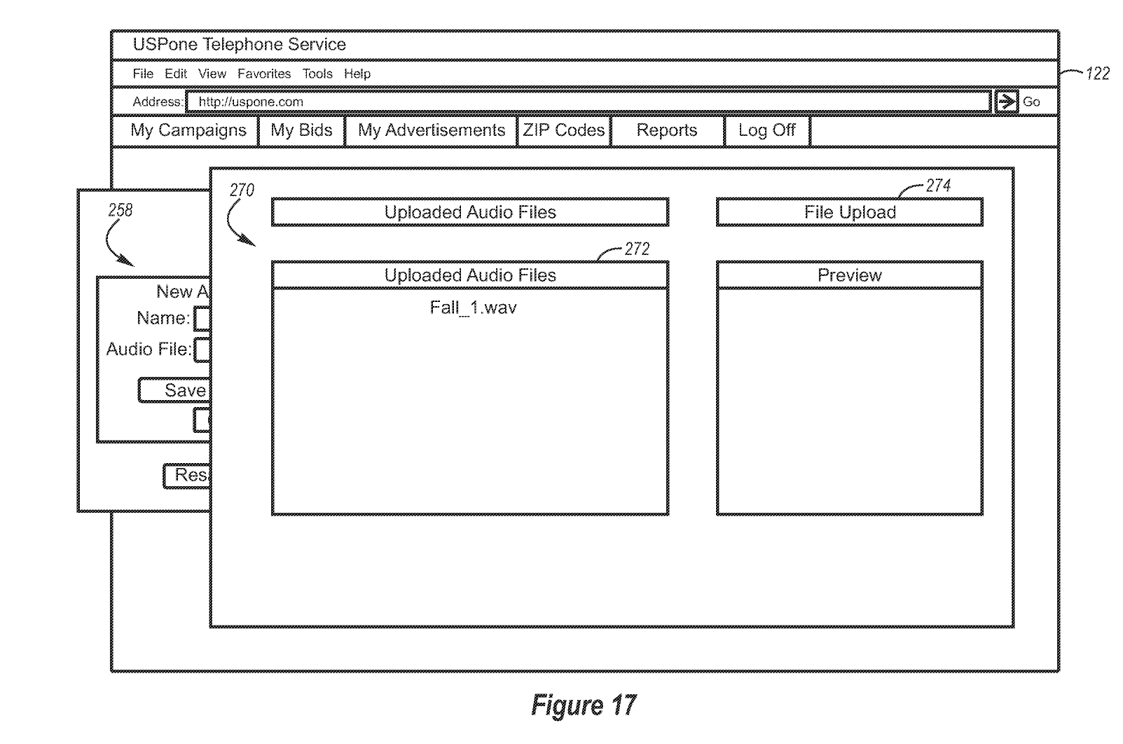

To add the user input indicating the audio file identifier into the user interface 258, an advertiser may first click the button 268 to access a user interface 270 shown in FIG. 17, which includes a display 272 of audio file identifiers for one or more audio files. For example, the display 272 may include a list of audio file identifiers for one or more audio files that have been uploaded.

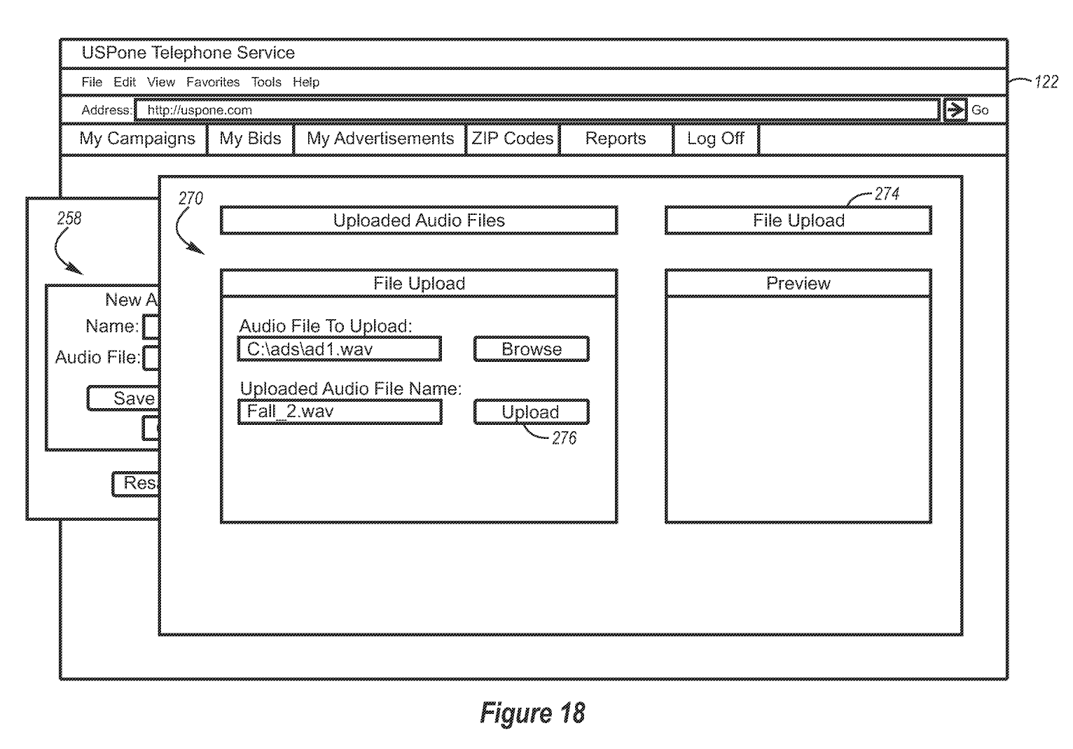

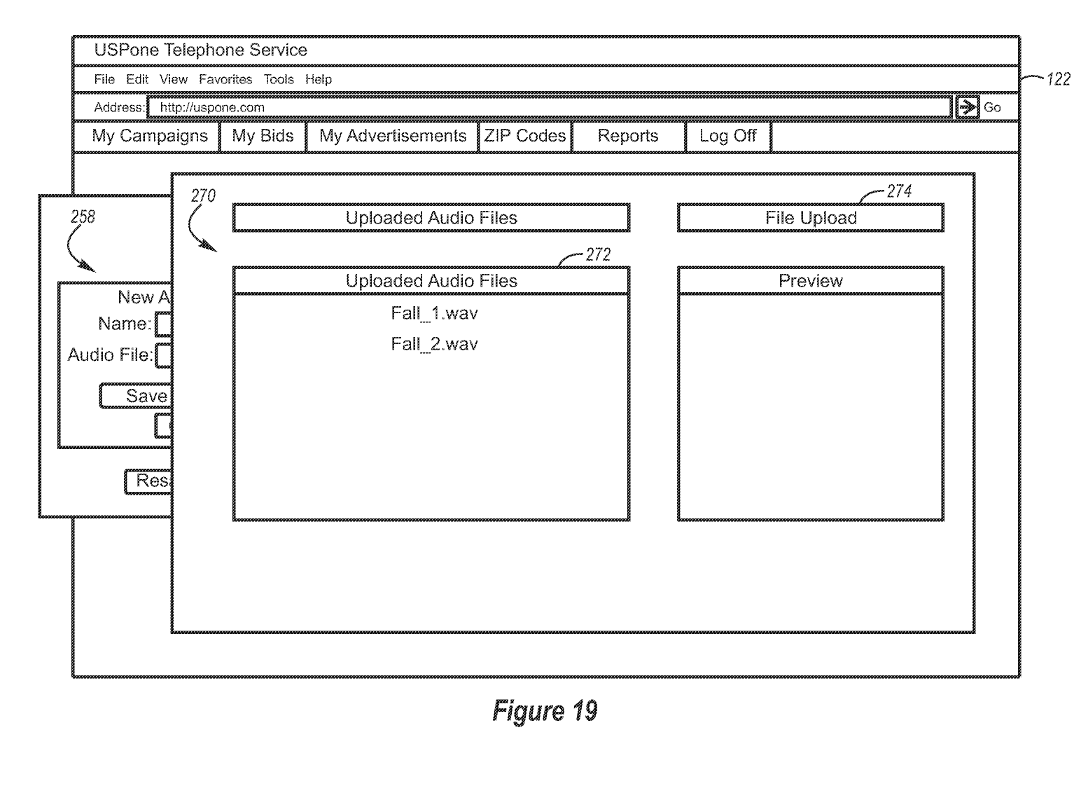

As shown in FIG. 17, an advertiser may click a button 274 to upload additional audio files. For example, in response to the click of the button 274, the user interface 270 may display one or more user interface elements configured to receive an audio file identifier and/or a path for an audio file to be uploaded as shown in FIG. 18. As shown in FIG. 18, the user interface 270 may also include and one or more user interface elements configured to receive an audio file identifier for the file once uploaded. To upload the indicated audio file, an advertiser may click the button 276. As shown in FIG. 19, in response to the clicking of the button 276, the indicated audio file appears in the display 272. In addition, in response to the clicking of the button 276, the interface server 118 may store the uploaded file in a location accessible by, for example, the interface server 118 and/or the server 114.

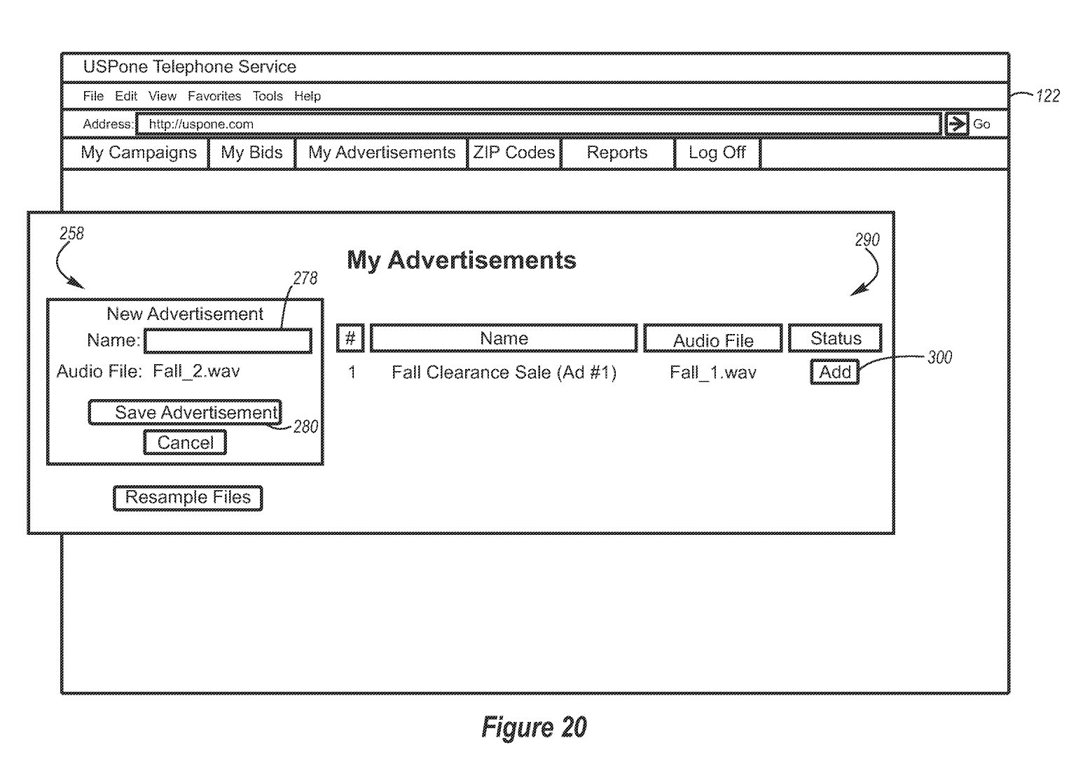

With reference to FIG. 19, to load the user input indicating the audio file identifier into the user interface 258, an advertiser may click a displayed audio file identifier in the display 272. In response to the clicking of the displayed audio file identifier in the display 272, the audio file identifier is loaded into the display 258, as shown in FIG. 20.

With reference to FIG. 20, a name for an advertisement may be entered into textbox 278, and a button 280 may be clicked to associate the advertisement with the advertiser. For example, in response to clicking the button 280, the browser 122 may, at a block 282 in FIG. 16, send user input indicating an advertisement name and an audio file identifier for the advertisement to the interface server 118 via, for example, the network 112. At a block 284, the interface server 118 may receive this user input via, for example, the network 112; and the interface server 118 may store data indicating an advertisement name, an audio file identifier, and/or a status for the advertisement at a block 286. For example, the interface server 118 may store such data in the Ads table in the database 120 (FIG. 4).

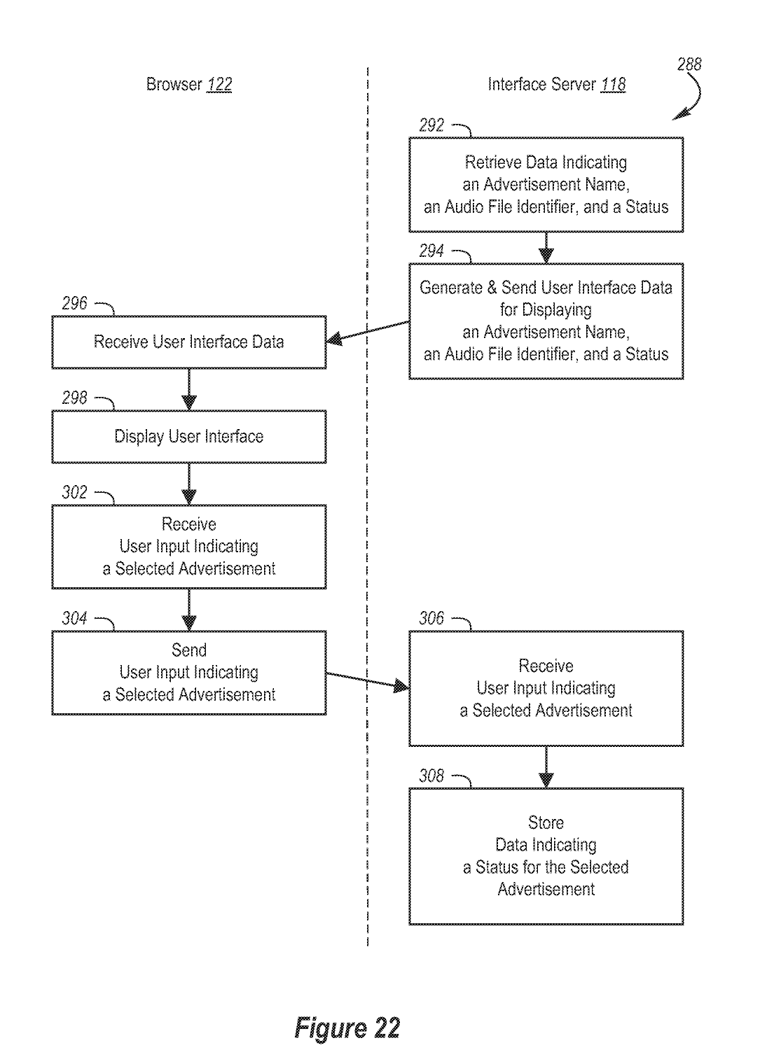

In response to clicking the button 254 (FIG. 13) or the button 280 (FIG. 15), the browser 122 and the interface server 118 may perform one or more portions of a method 288 (FIG. 22) to provide a user interface 290 that an advertiser may use to associate one or more advertisements with the currently selected advertising campaign. The method 288 may be performed by the telecommunications system 106; the browser 122; the interface server 118; one or more other suitable components, systems, modules, and the like; or any one or more thereof. Of course, the entire method 288 need not be performed; and any part or parts of the method 288 may be performed to provide a useful method 288.

In further detail, at a block 292, the interface server 118 may retrieve data indicating an advertisement name and an advertisement file identifier (such as an audio file identifier) for one or more advertisements, for example, one or more advertisements associated with the advertiser. In particular, the interface server 118 may retrieve data indicating an advertisement name and an advertisement file identifier from the Ads table in the database 120 (FIG. 4) by, for example, selecting the rows from the Ads table that includes the advertiser's Advertiser_id. In addition, at the block 292, the interface server 118 may retrieve data indicating a status for the one or more advertisements, for example, whether the advertisements are associated with the currently selected advertising campaign. The interface server 118 may retrieve this data indicating whether the advertisements are associated with the currently selected advertising campaign by, for example, selecting the rows from the Ad_campaign lookup table that include the currently selected campaign's Campaign_id.

At a block 294, the interface server 118 may generate user interface data configured for displaying an advertisement name, an advertisement file identifier (such as an audio file identifier), and a status for one or more advertisements associated with the advertiser. For example, the interface server 118 may use the data retrieved at the block 292 in generating the user interface data at the block 294. In addition, at the block 294, the interface server 118 may send this user interface data to the browser 122 via, for example, the network 112. At a block 296, the browser 122 may receive the user interface data generated at the block 294 via, for example, the network 112; and the browser 122 may use the user interface data to display the user interface 290 at a block 298.

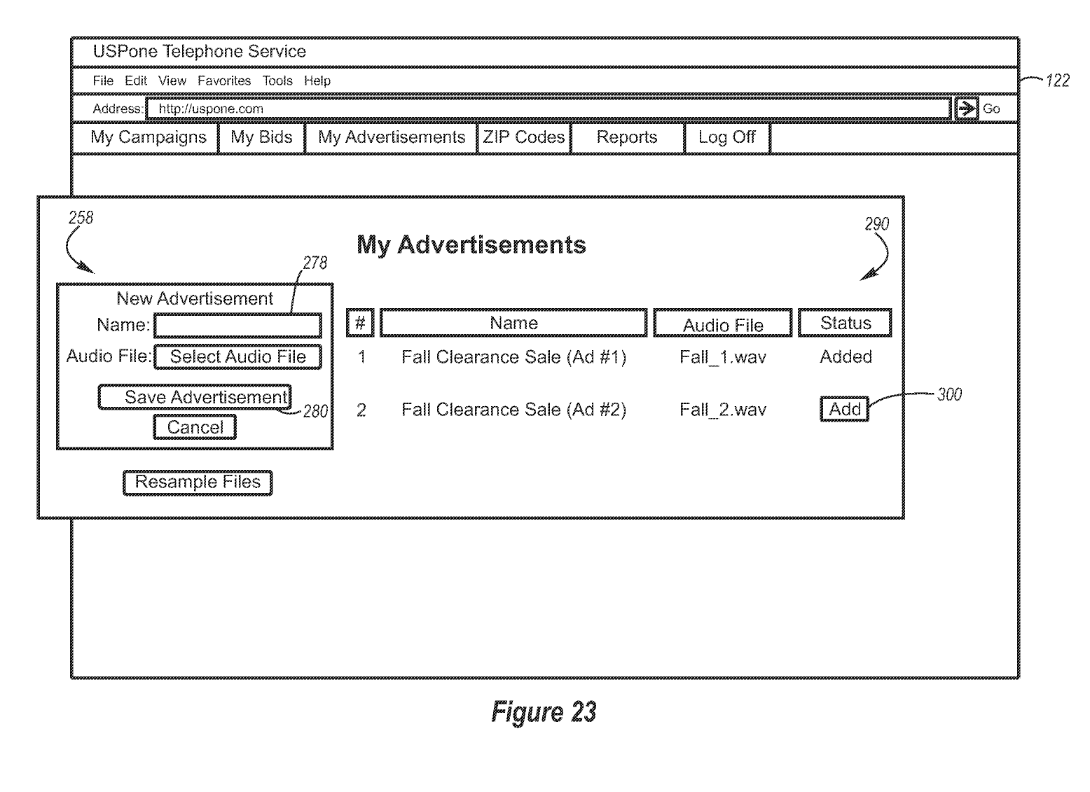

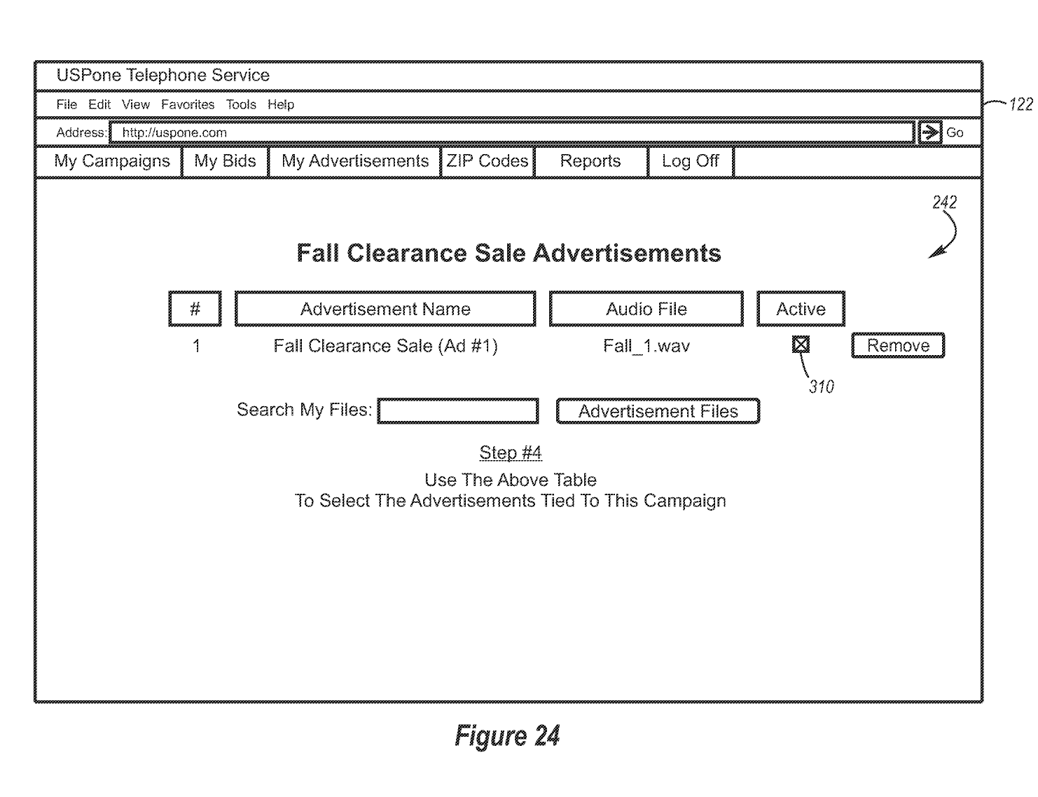

As shown in FIGS. 15, 20 and 21, the user interface 290 may include one or more user interface elements (such as, buttons 300) configured to receive user input indicating a selected advertisement. Consequently, in response to an advertiser clicking a button 300, the browser 122 may receive the user input indicating a selected advertisement at a block 302 (FIG. 22). At a block 304, the browser 122 may send this user input to the interface server 118 via, for example, the network 112. At a block 306, the interface server 118 may receive this user input via, for example, the network 112; and the interface server 118 may store data indicating a status for the selected advertisement at a block 308. For example, at the block 308, the interface server 118 may store data in the Ad_campaign_lookup table in the database 120 (FIG. 4) to associate the selected advertisement with the currently selected advertising campaign—thus indicating that the selected advertisement has been added to the currently selected advertising campaign. Also, at the block 308, the interface server 118 may store data in the Status field of the Ad_campaign_lookup table in the database 120 (FIG. 4) to indicate that the selected advertisement may be provided to customers (e.g., at the block 156 in FIG. 3). In addition, the browser 122 and the server 118 may repeat the blocks 292 to 298 (FIG. 22) to refresh the user interface 290 to reflect that the selected advertisement has been associated with the currently selected advertising campaign—as shown in FIG. 23. Also, the browser 122 and the server 118 may repeat the blocks 246 to 252 (FIG. 14) to refresh the user interface 242 to reflect that the selected advertisement has been associated with the currently selected advertising campaign—as shown in FIG. 24.

As shown in FIG. 24, the user interface 242 may include one or more user interface elements (for example, a checkbox 310) configured to receive user input indicating a status for an advertisement associated with the currently selected campaign. The status may indicate, for example, whether the selected advertisement may be provided to customers (e.g., at the block 156 in FIG. 3). The browser 122 may receive this user input and may send this user input to the interface server 118 via, for example, the network 112. The interface server 118 may receive this user input via, for example, the network 112; and the interface server 118 may store data indicating the status for an advertisement associated with the currently selected campaign. For example, the interface server 118 may store such data in the Ad_campaign_lookup table in the database 120 (FIG. 4).

“ZIP Codes” Tab

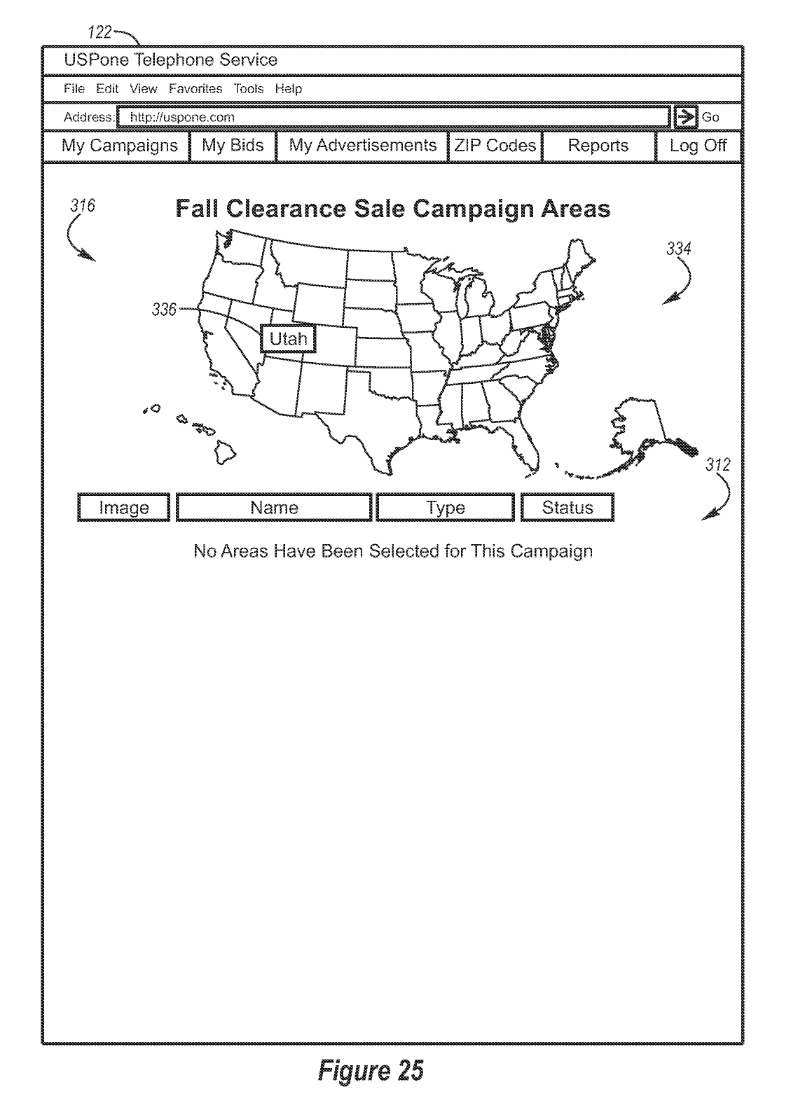

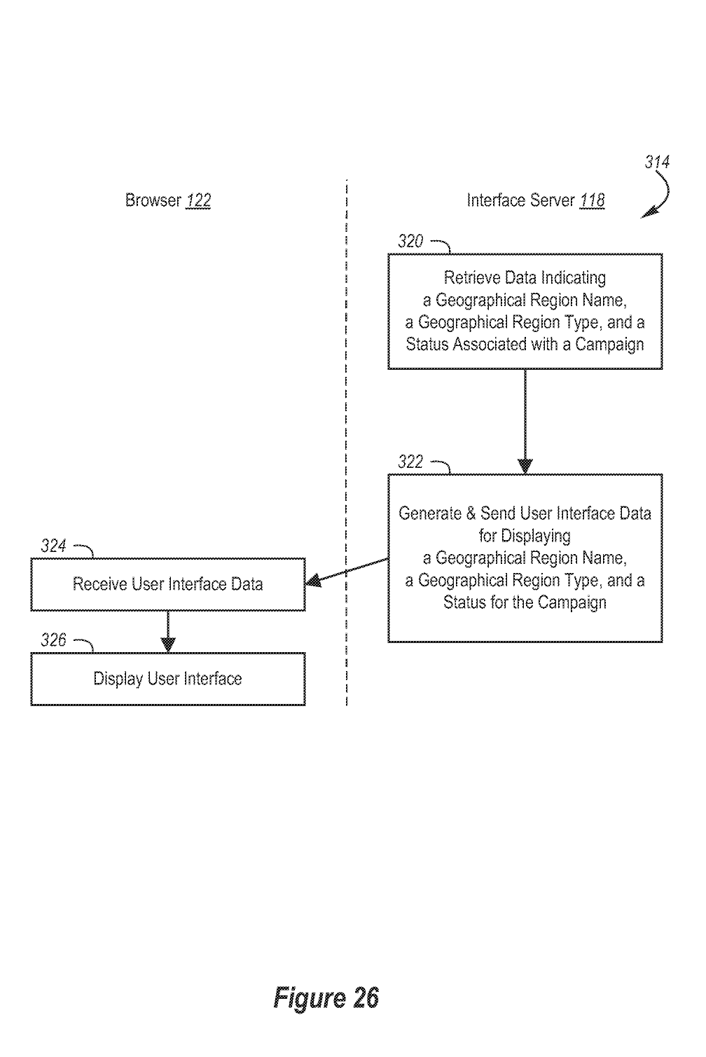

An advertiser may click a tab (for example, a “ZIP Codes” tab) to access a user interface 312 shown in FIG. 25, which may display one or more geographical regions associated with the currently selected campaign. For example, as shown in FIG. 26, the browser 122 and the interface server 118 may perform one or more portions of the method 314 in response to the advertiser's clicking of the “ZIP Codes” tab. The method 314 may be performed by the telecommunications system 106; the browser 122; the interface server 118; one or more other suitable components, systems, modules, and the like; or any one or more thereof. Of course, the entire method 314 need not be performed; and any part or parts of the method 314 may be performed to provide a useful method 314.

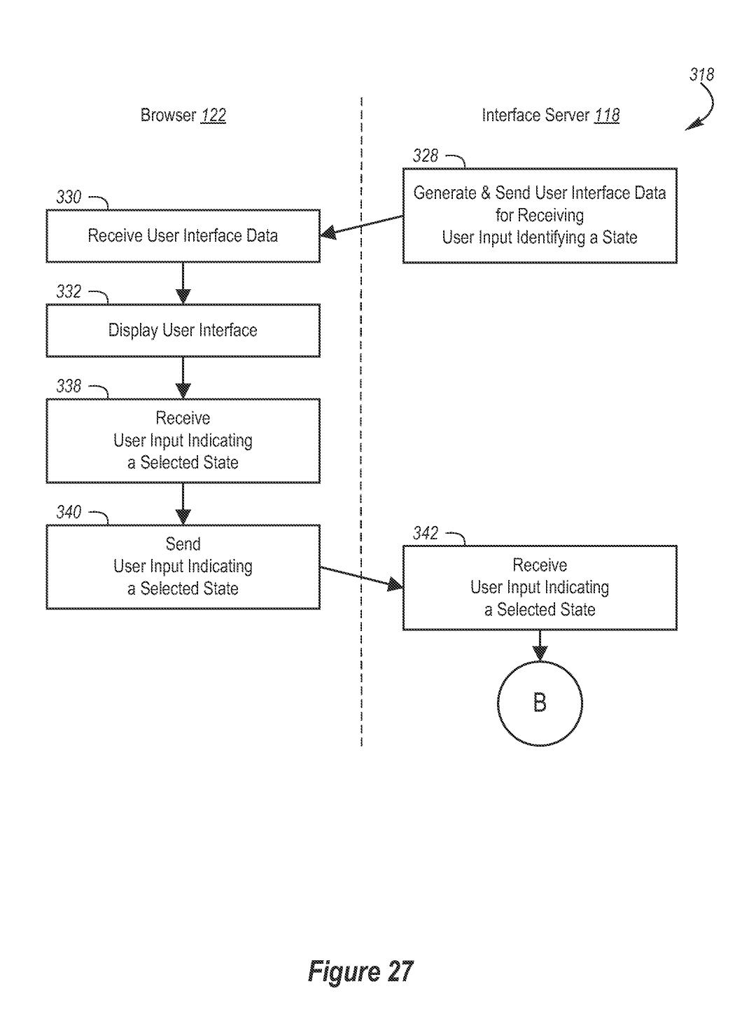

An advertiser may also click a tab (for example, a “ZIP Codes” tab) to access a user interface 316 shown in FIG. 25, which may be configured to receive user input indicating a geographical region, such as a state. For example, as shown in FIG. 27, the browser 122 and the interface server 118 may perform one or more portions of the method 318 in response to the advertiser's clicking of the “ZIP Codes” tab. The method 318 may be performed by the telecommunications system 106; the browser 122; the interface server 118; one or more other suitable components, systems, modules, and the like; or any one or more thereof. Of course, the entire method 318 need not be performed; and any part or parts of the method 318 may be performed to provide a useful method 318.

In response to the clicking of the “ZIP Codes” tab, the interface server 118 may, at a block 320 in FIG. 26, retrieve data indicating a geographical region name, a geographical region type, and/or a status for one or more geographical regions associated with the currently selected campaign. For example, using the exemplary database 120 shown in FIG. 4, the following exemplary SQL Statement #15 may be used to identify a geographical region name, a geographical region type, and/or a status of one or more geographical regions associated with an advertising campaign (<Campaign>):

SQL Statement #15

SELECT Geo_zipcodes.Zipcode “Name”, Geo_types_lookup.Name “Type”,
Ad_campaign_geos.Status “Status”
FROM Ad_campaign_geos, Ad_system_geos, Geo_types_lookup, Geo_zipcodes
WHERE (Ad_campaign_geos.Campaign_id = <Campaign>) AND
(Ad_campaign_geos.Geo_id = Ad_system_geos.Geo_id) AND
(Ad_campaign_geos.Geo_type_id = Ad_system_geos.Geo_type_id) AND
(Ad_system_geos.Geo_type_id = Geo_types_lookup.Geo_type_id) AND
(Geo_types_lookup.Name = “ZIP Code”) AND
(Geo_zipcodes.Zipcode_id = Ad_system_geos.Geo_id)
UNION
SELECT Geo_Cities.city “Name”, Geo_types_lookup.Name “Type”,
Ad_campaign_geos.Status “Status”
FROM Ad_campaign_geos, Ad_system_geos, Geo_types_lookup, Geo_Cities
WHERE (Ad_campaign_geos.Campaign_id = <Campaign>) AND
(Ad_campaign_geos.Geo_id = Ad_system_geos.Geo_id) AND
(Ad_campaign_geos.Geo_type_id = Ad_system_geos.Geo_type_id) AND
(Ad_system_geos.Geo_type_id = Geo_types_lookup.Geo_type_id) AND
(Geo_types_lookup.Name = “City”) AND
(Geo_Cities.City_id = Ad_system_geos.Geo_id)
UNION
SELECT Geo_County.County “Name”, Geo_types_lookup.Name “Type”,
Ad_campaign_geos.Status “Status”
FROM Ad_campaign_geos, Ad_system_geos, Geo_types_lookup, Geo_County
WHERE (Ad_campaign_geos.Campaign_id = <Campaign>) AND
(Ad_campaign_geos.Geo_id = Ad_system_geos.Geo_id) AND
(Ad_campaign_geos.Geo_type_id = Ad_system_geos.Geo_type_id) AND
(Ad_system_geos.Geo_type_id = Geo_types_lookup.Geo_type_id) AND
(Geo_types_lookup.Name = “County”) AND
(Geo_County.County_id = Ad_system_geos.Geo_id)
UNION
SELECT Geo_states.State “Name”, Geo_types_lookup.Name “Type”,
Ad_campaign_geos.Status “Status”
FROM Ad_campaign_geos, Ad_system_geos, Geo_types_lookup, Geo_states
WHERE (Ad_campaign_geos.Campaign_id = <Campaign>) AND
(Ad_campaign_geos.Geo_id = Ad_system_geos.Geo_id) AND
(Ad_campaign_geos.Geo_type_id = Ad_system_geos.Geo_type_id) AND
(Ad_system_geos.Geo_type_id = Geo_types_lookup.Geo_type_id) AND
(Geo_types_lookup.Name = “State”) AND
(Geo_states.State_id = Ad_system_geos.Geo_id)

At a block 322, the interface server 118 may generate user interface data configured for displaying a geographical region name, a geographical region type, and/or a status for one or more geographical regions associated with the currently selected campaign. For example, the interface server 118 may use the data retrieved at the block 320 in generating the user interface data at the block 322. In addition, at the block 322, the interface server 118 may send this user interface data to the browser 122 via, for example, the network 112. At a block 324, the browser 122 may receive the user interface data generated at the block 322 via, for example, the network 112; and the browser 122 may use the user interface data to display the user interface 322 at a block 326. As shown in FIG. 25, no geographical regions have been associated with the currently selected campaign.

In response to the clicking of the “ZIP Codes” tab, the interface server 118 may also, at a block 328 in FIG. 27, generate user interface data configured for receiving user input indicating a geographical region, such as a state. In addition, at the block 328, the interface server 118 may send this user interface data to the browser 122 via, for example, the network 112. At a block 330, the browser 122 may receive the user interface data generated at the block 328 via, for example, the network 112; and the browser 122 may use the user interface data to display the user interface 316 at a block 332.

As shown in FIG. 25, the user interface 316 may include a map 334. As an advertiser moves a pointer over a portion of the map 334, the map 334 may display the name 336 of a geographical region associated with that portion.

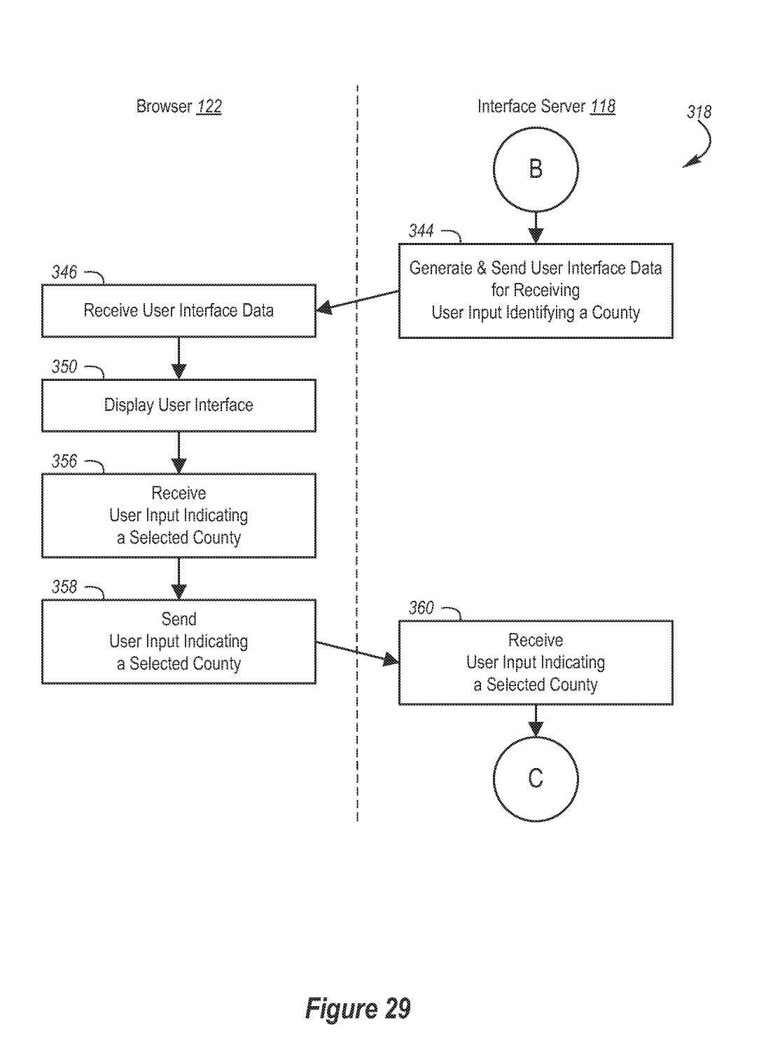

Desirably, an advertiser may click on a portion of the map 334 to allow the browser 122 to receive user input indicating a selected geographical region, such as a selected state. For example, an advertiser may left-mouse-button-click on a portion of the map 334 to allow the browser 122 to receive user input indicating a selected state, which the browser 122 may send to the interface server 118 via, for example, the network 112 at a block 340. At a block 342, the interface server 118 may receive the user input via, for example, the network 112 and may proceed to a block 344 (FIG. 29).

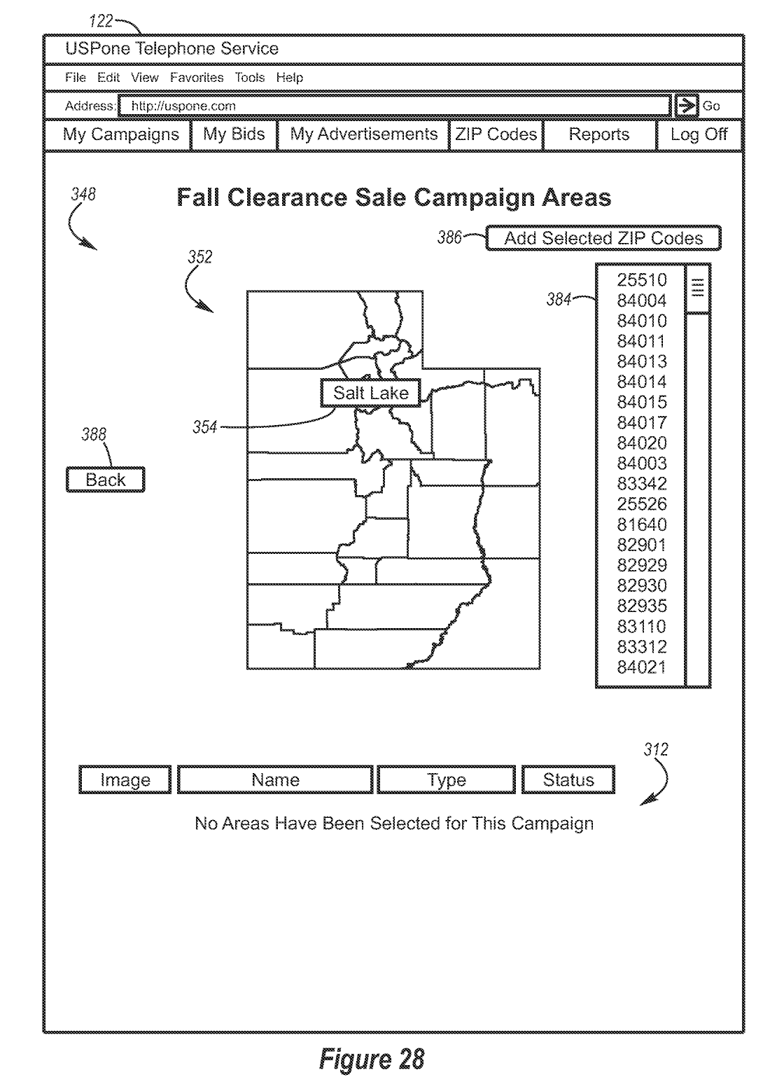

As a result, in response to an advertiser's left-mouse-button-click on a portion of the map 334, the interface server 118 may, at the block 344, generate user interface data configured for receiving user input indicating a geographical region, such as a county and/or a zip code. In addition, at the block 344, the interface server 118 may send this user interface data to the browser 122 via, for example, the network 112. At a block 346, the browser 122 may receive the user interface data generated at the block 344 via, for example, the network 112; and the browser 122 may use the user interface data to display a user interface 348 at a block 350. In addition, in response to an advertiser's left-mouse-button-click on a portion of the map 334, some or all of the method 314 (FIG. 26) may be performed to refresh the user interface 312 shown in FIG. 28.

As shown in FIG. 28, the user interface 348 may include a map 352. As an advertiser moves a pointer over a portion of the map 352, the map 352 may display the name 354 of a geographical region associated with that portion.

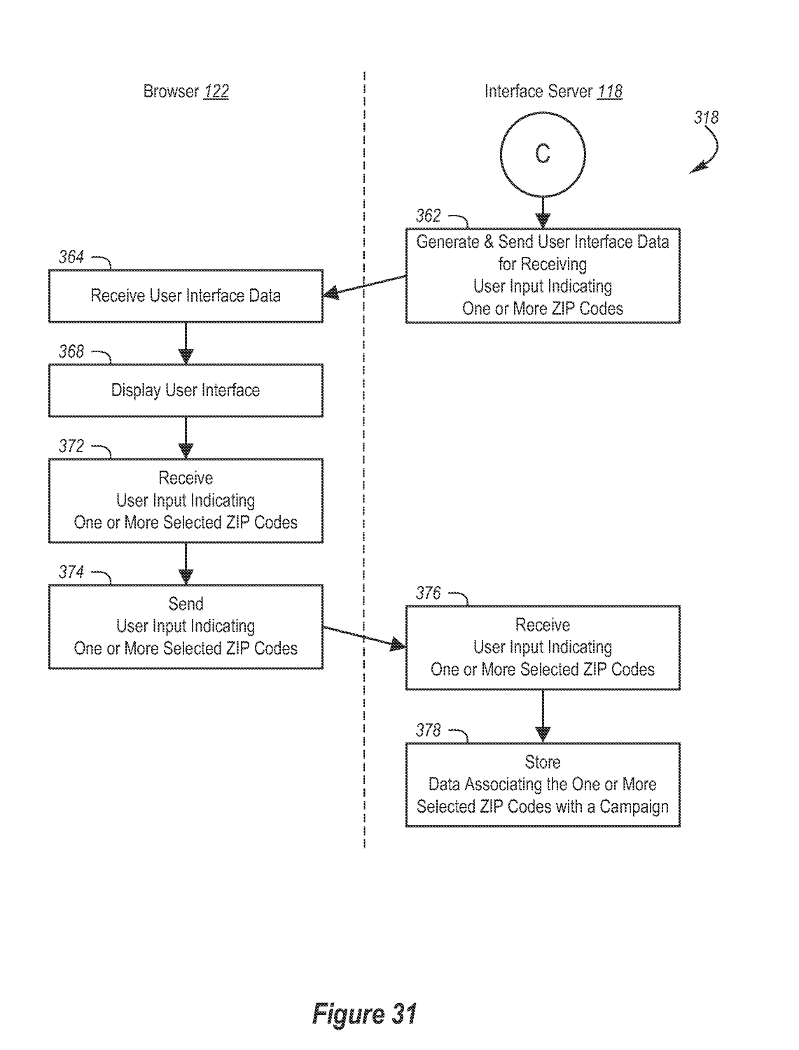

Desirably, an advertiser may click on a portion of the map 352 to allow the browser 122 to receive user input indicating a selected geographical region, such as a selected county. For example, an advertiser may left-mouse-button-click on a portion of the map 352 to allow the browser 122 to receive user input indicating a selected county at a block 356. The browser 122 may send the user input to the interface server 118 via, for example, the network 112 at a block 358. At a block 360, the interface server 118 may receive the user input via, for example, the network 112 and may proceed to a block 362 (FIG. 31).

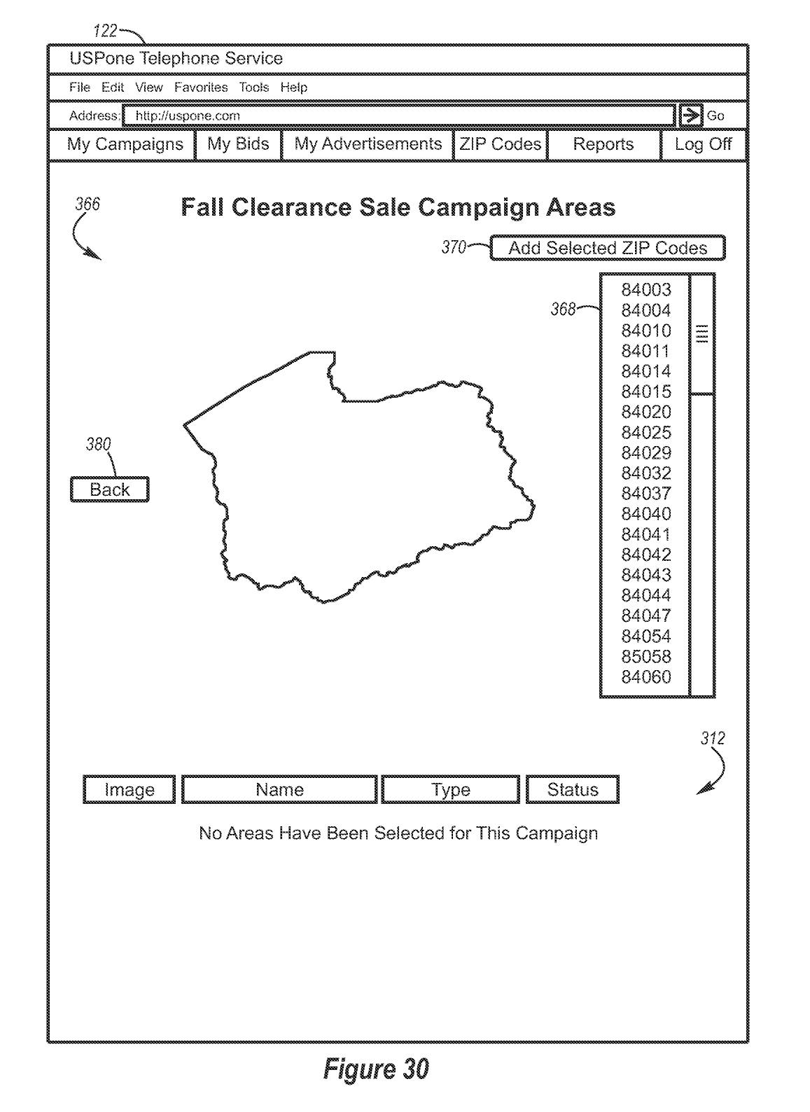

As a result, in response to an advertiser's left-mouse-button-click on a portion of the map 352, the interface server 118 may, at the block 362, generate user interface data configured for receiving user input indicating one or more zip codes, such as one or more zip codes associated with the portion of map 352. In addition, at the block 362, the interface server 118 may send this user interface data to the browser 122 via, for example, the network 112. At a block 364, the browser 122 may receive the user interface data generated at the block 362 via, for example, the network 112; and the browser 122 may use the user interface data to display a user interface 366 at a block 36. In addition, in response to an advertiser's left-mouse-button-click on a portion of the map 352, some or all of the method 314 (FIG. 26) may be performed to refresh the user interface 312 shown in FIG. 30.

As shown in FIG. 30, the user interface 366 may include one or more user interface elements (for example, a listbox 368) configured to receive user input indicating one or more zip codes, such as one or more zip codes associated with a geographical region (for example, one or more zip codes associated with the county selected at the block 356). In response to an advertiser clicking a button 370, the browser 122 may receive this user input at a block 372 (FIG. 31) and may, at a block 374, send this user input to the interface server 118 via, for example, the network 112. At a block 376, the interface server 118 may receive this user input via, for example, the network 112; and the interface server 118 may, at a block 378, store data associating the one or more zip codes with an advertising campaign, such as the currently selected campaign. For example, the interface server 118 may store such data in the Ad_campaign_geos table in the database 120 (FIG. 4).

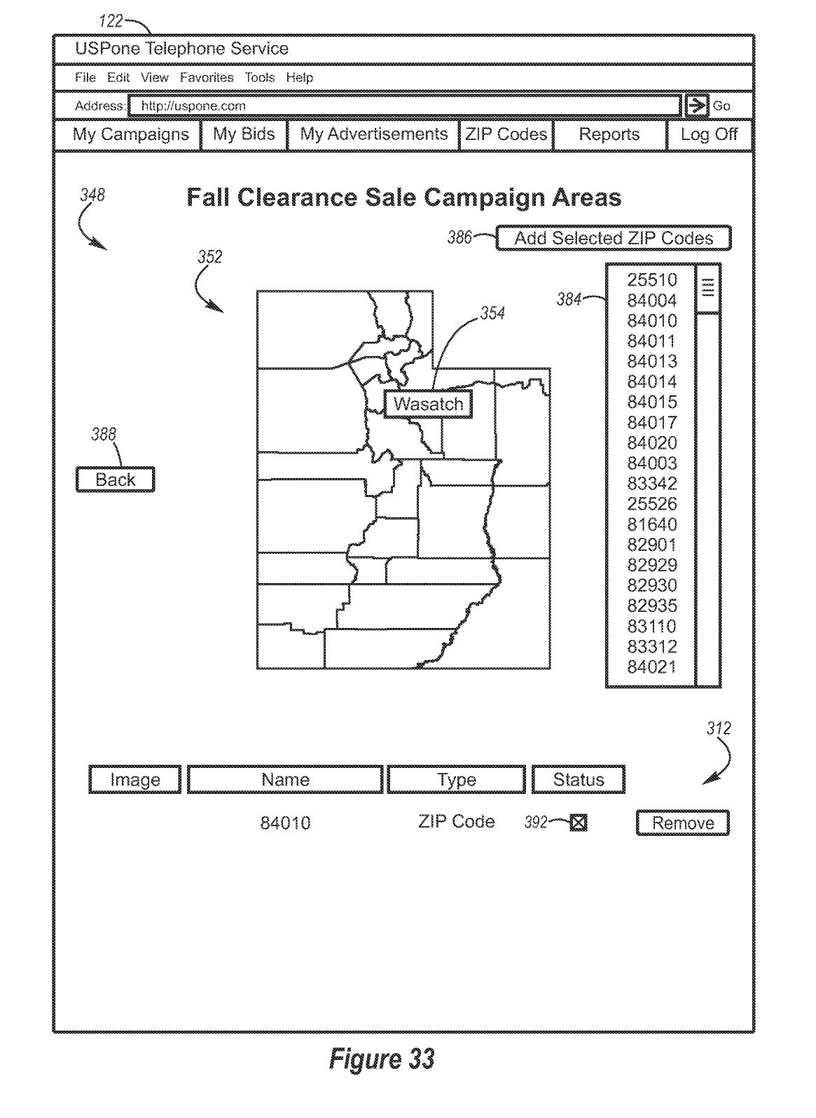

In addition, in response to an advertiser's click of the button 370, some or all of the method 314 (FIG. 26) may be performed to refresh the user interface 312. For example, in response to selecting the “84010” zip code in the listbox 368 and clicking the button 370, the method 314 may be performed to refresh the user interface 312 to illustrate that the “84010” zip code has been associated with the currently selected campaign, as shown in FIG. 33.

In response to an advertiser's click of a button 380, the blocks 344, 346, 350 may be performed to provide the user interface 348 as shown in FIG. 33. In addition, in response to an advertiser's click of the button 380, some or all of the method 314 (FIG. 26) may be performed to refresh the user interface 312.

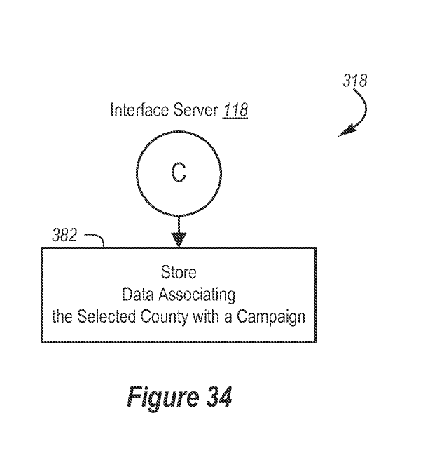

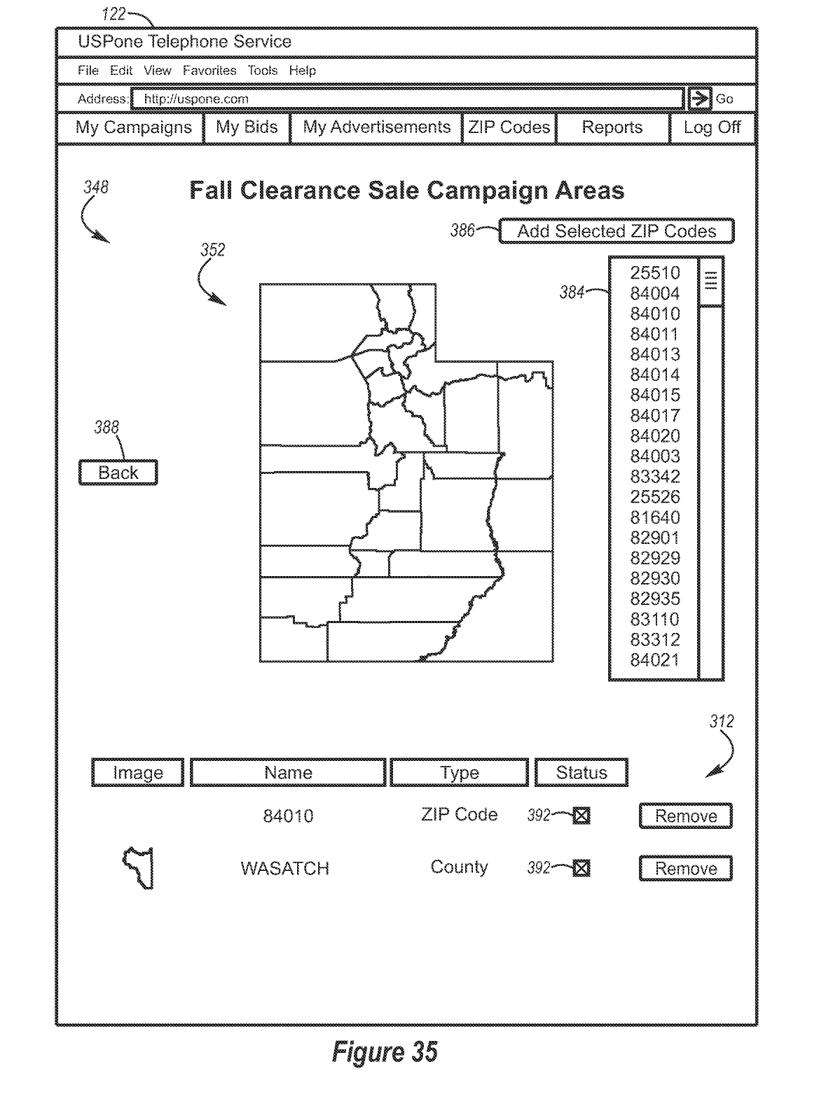

As mentioned above, an advertiser may click on a portion of the map 352 to allow the browser 122 to receive user input indicating a selected geographical region, such as a selected county. For example, an advertiser may right-mouse-button-click on a portion of the map 352 to allow the browser 122 to receive user input indicating a selected county at the block 356. The browser 122 may send the user input to the interface server 118 via, for example, the network 112 at the block 358. At the block 360, the interface server 118 may receive the user input via, for example, the network 112 and may proceed to a block 382 (FIG. 34). At the block 382, the interface server 118 may store data associating the selected county with an advertising campaign, such as the currently selected campaign. For example, the interface server 118 may store such data in the Ad_campaign_geos table in the database 120 (FIG. 4). In addition, some or all of the method 314 (FIG. 26) may be performed to refresh the user interface 312. For example, in response to selecting “Wasatch” county, the method 314 may be performed to refresh the user interface 312 to illustrate that “Wasatch” county has been associated with the currently selected campaign, as shown in FIG. 35.

As shown in FIGS. 28, 33, and 35, the user interface 348 may include one or more user interface elements (for example, a listbox 384) configured to receive user input indicating one or more zip codes, such as one or more zip codes associated with a geographical region (for example, one or more zip codes associated with the state selected at the block 338 in FIG. 27). In response to an advertiser clicking a button 386, the browser 122 may receive this user input and may send this user input to the interface server 118 via, for example, the network 112. The interface server 118 may receive this user input via, for example, the network 112; and the interface server 118 may store data associating the one or more zip codes with an advertising campaign, such as the currently selected campaign. For example, the interface server 118 may store such data in the Ad_campaign_geos table in the database 120 (FIG. 4). In addition, in response to an advertiser's click of the button 386, some or all of the method 314 (FIG. 26) may be performed to refresh the user interface 312.

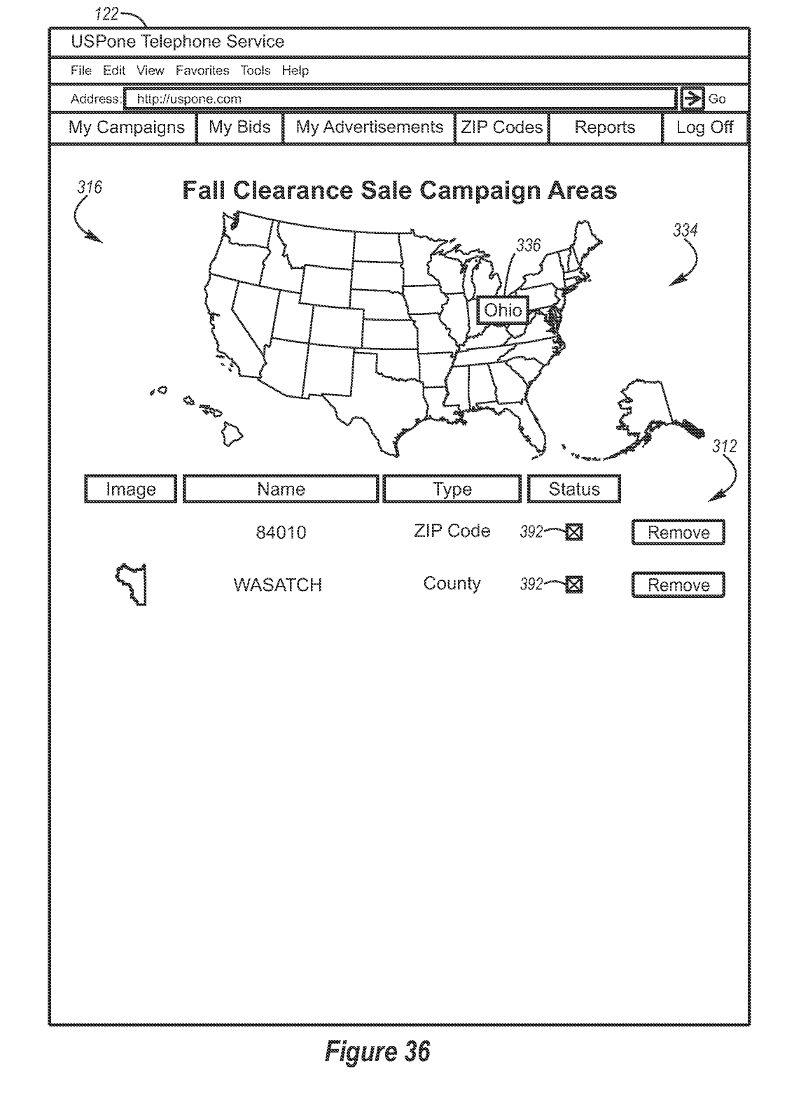

In response to an advertiser's click of a button 388, the blocks 328, 330 and 332 may be performed to provide the user interface 316 as shown in FIG. 36. In addition, in response to an advertiser's click of the button 388, some or all of the method 314 (FIG. 26) may be performed to refresh the user interface 312.

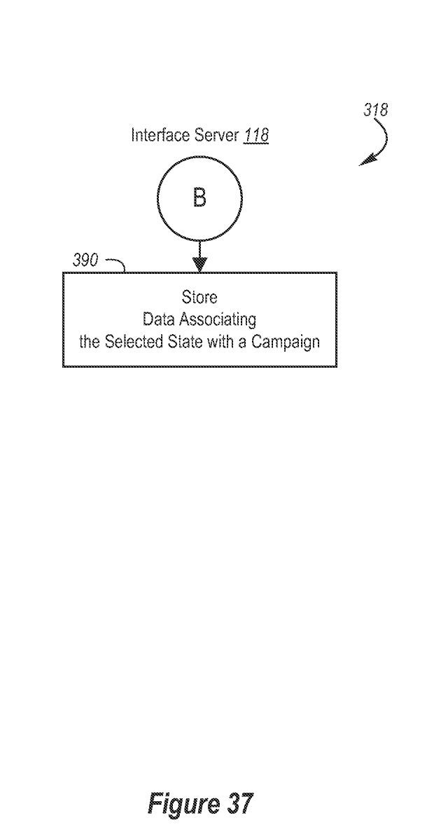

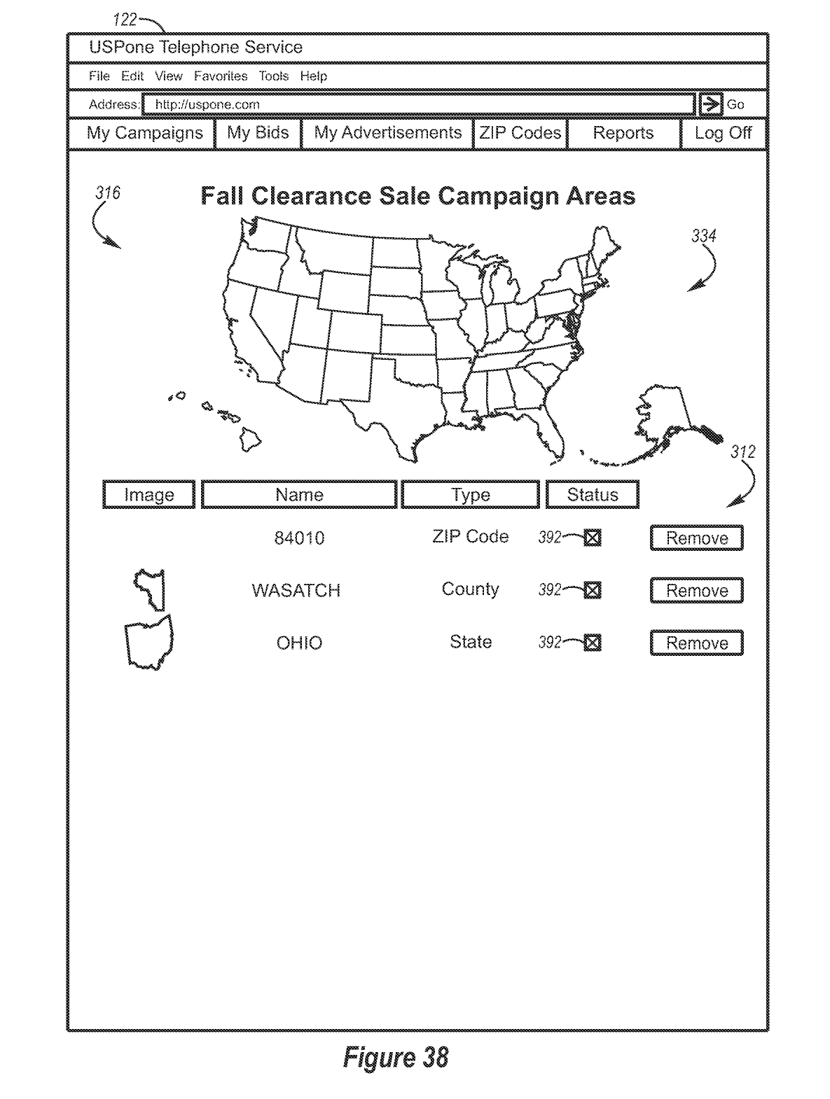

As mentioned above, an advertiser may click on a portion of the map 334 to allow the browser 122 to receive user input indicating a selected geographical region, such as a selected state. For example, an advertiser may right-mouse-button-click on a portion of the map 334 to allow the browser 122 to receive user input indicating a selected state at the block 338, which the browser 122 may send, at the block 340, to the interface server 118 via, for example, the network 112. At the block 342, the interface server 118 may receive the user input via, for example, the network 112 and may proceed to a block 390 (FIG. 37). At the block 390, the interface server 118 may store data associating the selected state with an advertising campaign, such as the currently selected campaign. For example, the interface server 118 may store such data in the Ad_campaign_geos table in the database 120 (FIG. 4). In addition, some or all of the method 314 (FIG. 26) may be performed to refresh the user interface 312. For example, in response to selecting Ohio, the method 314 may be performed to refresh the user interface 312 to illustrate that Ohio has been associated with the currently selected campaign, as shown in FIG. 38.

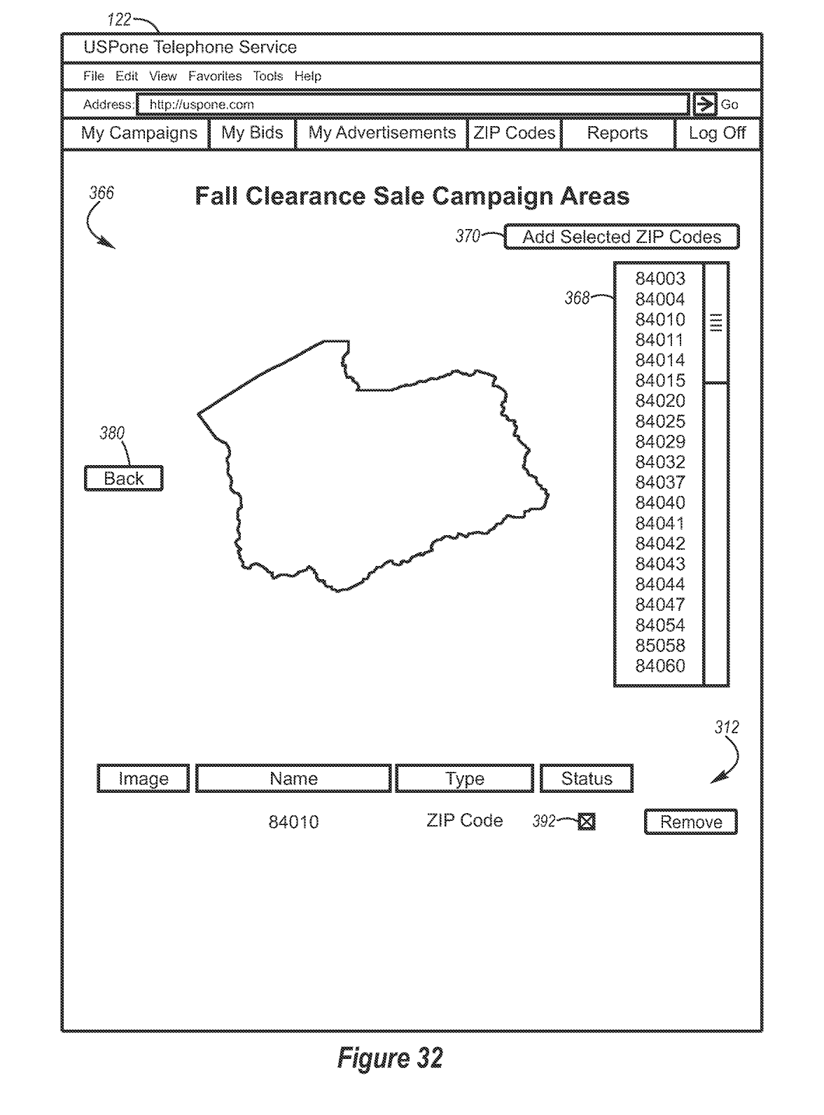

As shown in FIGS. 32, 33, 35, 36 and 38, the user interface 312 may include one or more user interface elements (for example, checkboxes 392) configured to receive user input indicating a status for one or more geographical regions associated with the currently selected campaign. The status may indicate, for example, whether the selected advertisement may be provided to customers (e.g., at the block 156 in FIG. 3) using a telephone associated with the geographical region. The browser 122 may receive this user input and may send this user input to the interface server 118 via, for example, the network 112. The interface server 118 may receive this user input via, for example, the network 112; and the interface server 118 may store data indicating the status for an advertisement associated with the currently selected campaign. For example, the interface server 118 may store such data in the Ad_campaign_geos table in the database 120 (FIG. 4).

Customer Advertisement Preferences

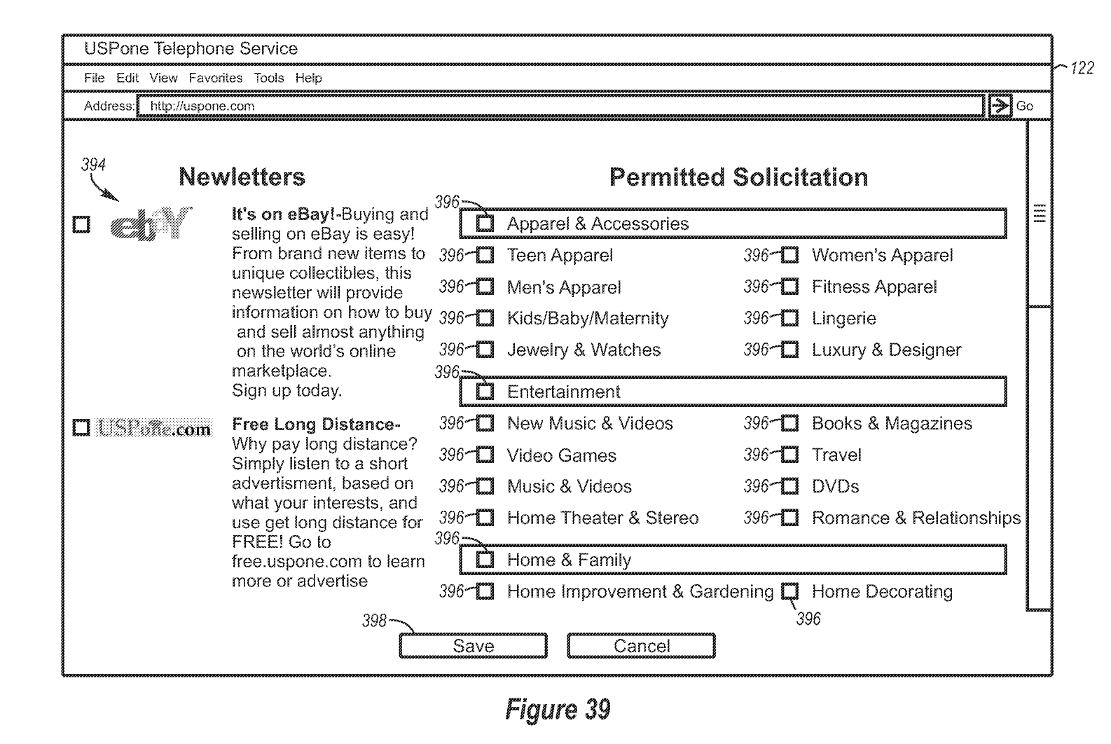

As mentioned above, in one embodiment, at the block 138, the server 114 may identify the advertisement at least partially based upon an advertisement category associated with a telephone, such as the telephone 102 or the telephone 104. As shown in FIG. 39, a user interface 394 may include one or more user interface elements (for example, checkboxes 396) configured to receive user input indicating one or more selected advertisement categories. In response to a customer clicking a button 398, the browser 122 may receive this user input and may send this user input to the interface server 118 via, for example, the network 112. The interface server 118 may receive this user input via, for example, the network 112; and the interface server 118 may store data associating the one or more selected advertisement categories with a telephone identifier, such as the customer's telephone number. For example, the interface server 118 may store such data in the Ad_Types_Pref table in the database 120 (FIG. 4).

### Reports

Using the data stored in the database 120, the interface server 118 may be configured to provide one or more reports in any desired format, such as xml, html, pdf, Microsoft Word, tiff, and/or other formats. The reports may include pie charts, tables and/or other suitable display formats. The interface server 118 may provide such reports to the browser 122 in response to a request from the browser 122; and the reports may be requested via a user interface that may be accessed by clicking a tab (for example, a “Reports” tab). The interface server 118 may provide such reports, for example, via a web service.

Campaigns Report

In one embodiment, a “Campaigns” report may include a name, a start date, a stop date, an advertisement play count, an advertisement play limit, and/or a status associated with one or more of an advertiser's campaigns. Desirably, advertisers may run a “Campaigns” report to review their advertising campaigns.

Call History Report

In some embodiments, a “Call History” report may include various data related to telephone calls made using the system 100, such as, data indicating the date and/or time a call began; the date and/or time the call ended; the length of the call; the date and/or time an advertisement was provided to a customer; the advertisement that was provided to the customer; at least one advertisement category associated with the advertisement; the campaign under which the advertisement was provided; the advertiser running the campaign; at least a portion of the telephone number of the customer (a portion of the telephone number, such as the last four digits of the telephone number, may be kept private if desired); a zip code associated with the telephone number of the customer; at least a portion of the telephone number of the person that the customer called using the system 100 (a portion of the telephone number, such as the last four digits of the telephone number, may be kept private if desired); a zip code associated with the telephone number of the person that the customer called using the system 100; and/or a total number of calls that occurred during a particular time period (such as, individual days, months, quarters, years, etc.).

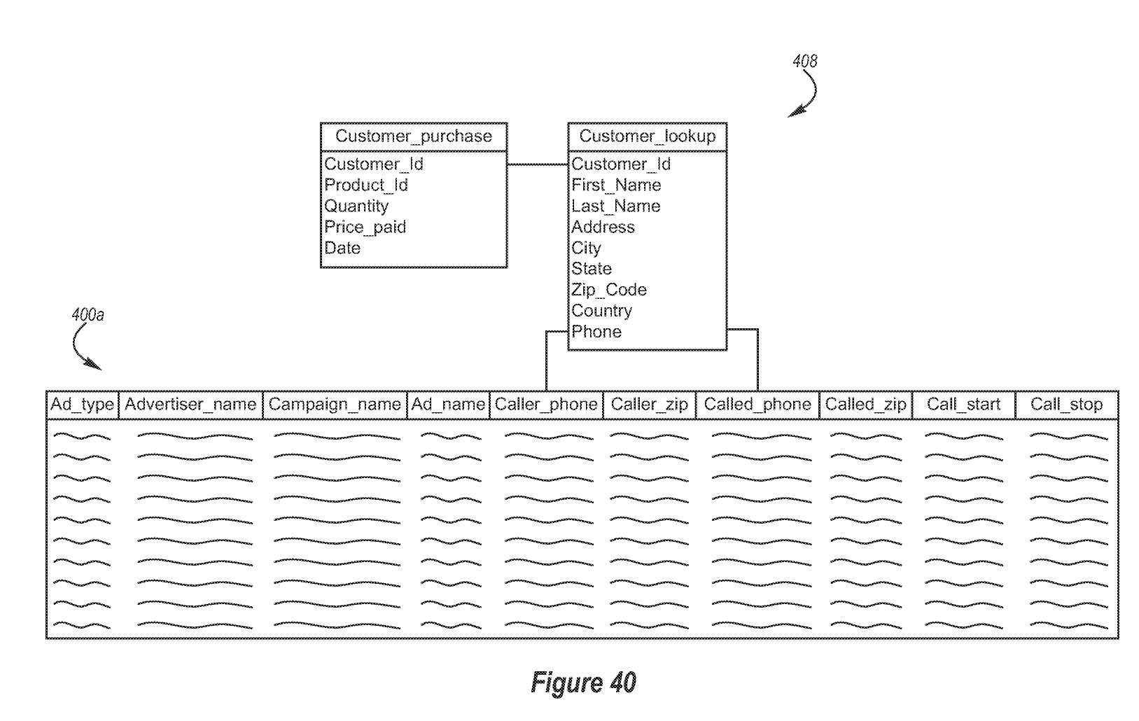

In one embodiment, as shown in FIG. 40, an exemplary “Call History” report 400a may include various data related to telephone calls made using the system 100, such as, data indicating the date and/or time a call began (“Call_start”); the date and/or time the call ended (“Call_stop”); the advertisement that was provided to the customer (“Ad_name”); the campaign under which the advertisement was provided (“Campaign_name”); at least a portion of the telephone number of the customer (“Caller_phone”); a zip code associated with the telephone number of the customer (“Caller_zip”); at least a portion of the telephone number of the person that the customer called using the system 100 (“Called_phone”); and/or a zip code associated with the telephone number of the person that the customer called using the system 100 (“Called_zip”).

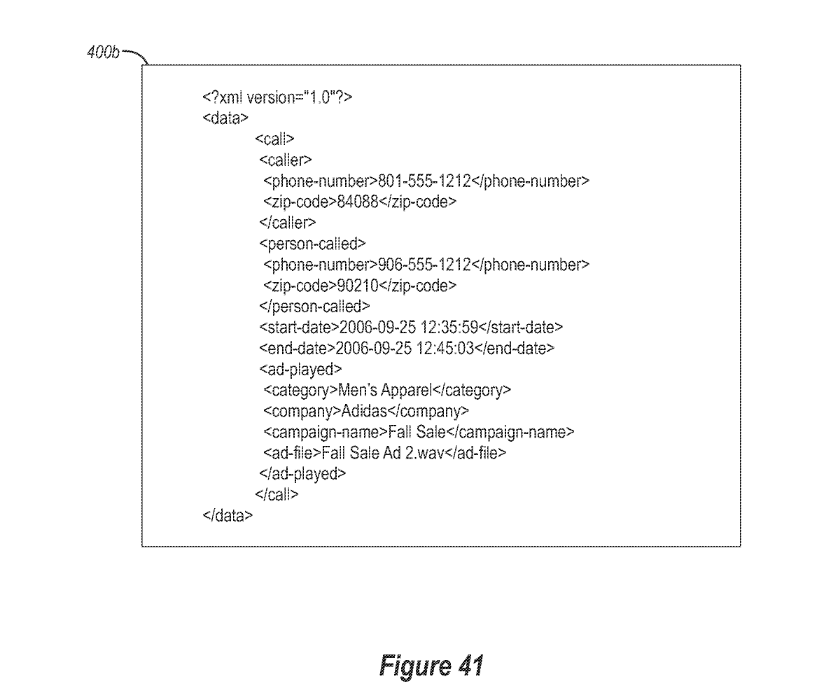

In one embodiment, as shown in FIG. 41, an exemplary “Call History” report 400b may include various data related to telephone calls made using the system 100, such as, data indicating the date and/or time a call began (“start-date”); the date and/or time the call ended (“end-date”); the advertisement that was provided to the customer (“ad-played.ad-file”); an advertisement category associated with the advertisement (“ad-played.category”); the campaign under which the advertisement was provided (“ad-played.campaign-name”); the advertiser running the campaign (“ad-played.company”); at least a portion of the telephone number of the customer (“caller.phone-number”); a zip code associated with the telephone number of the customer (“caller.zip-code”); at least a portion of the telephone number of the person that the customer called using the system 100 (“person-called.phone-number”); and/or a zip code associated with the telephone number of the person that the customer called using the system 100 (“person-called.zip-code”). As shown in FIG. 41, the report 400b may advantageously be provided via an XML format; however, an XML format is not required.

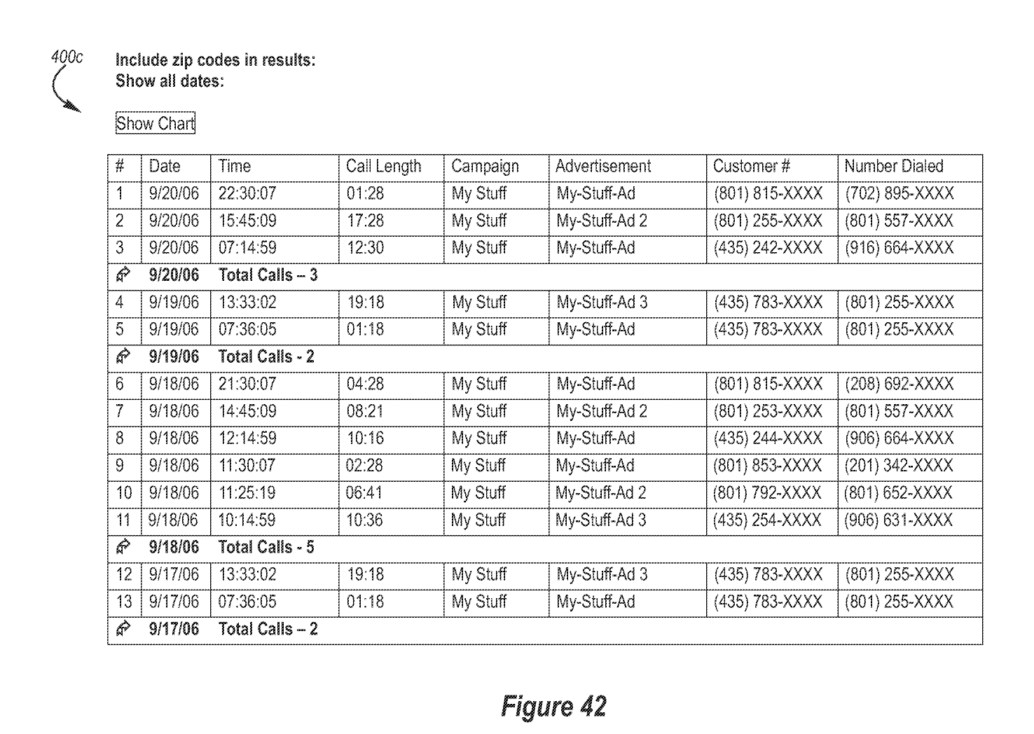

In one embodiment, as shown in FIG. 42, an exemplary “Call History” report 400c may include various data related to telephone calls made using the system 100, such as, data indicating the date (“Date”) and/or time (“Time”) a call began; the length of the call (“Call Length”); the advertisement that was provided to the customer (“Advertisement”); the campaign under which the advertisement was provided (“Campaign”); at least a portion of the telephone number of the customer (a portion of the telephone number, such as the last four digits of the telephone number, may be kept private if desired); at least a portion of the telephone number of the person that the customer called using the system 100 (a portion of the telephone number, such as the last four digits of the telephone number, may be kept private if desired); and/or a total number of calls that occurred during one or more particular time periods.

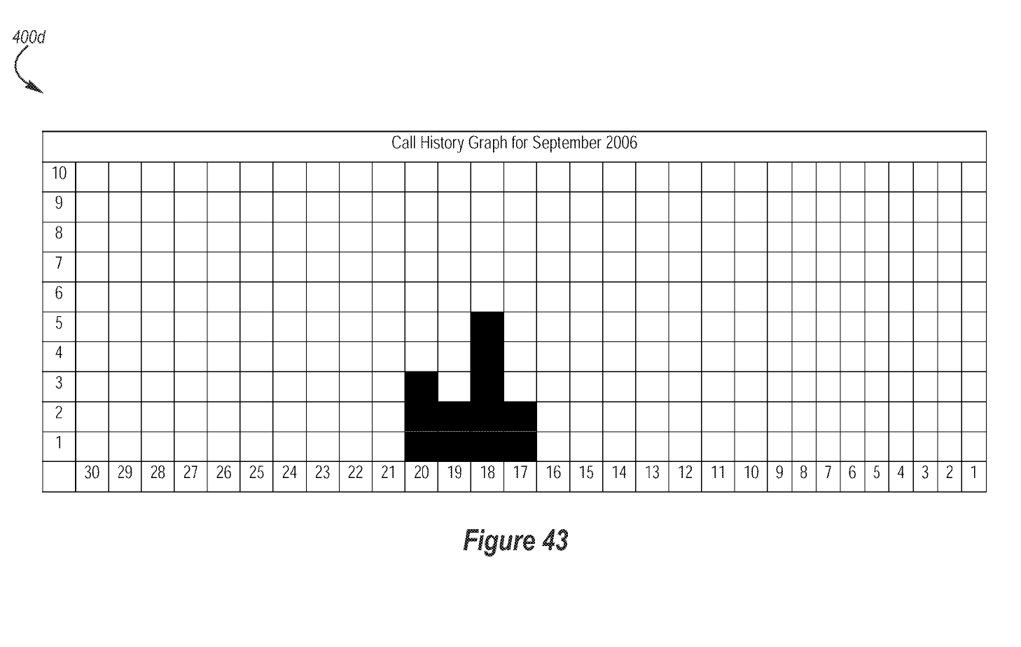

In one embodiment, as shown in FIG. 43, an exemplary “Call History” report 400d may include various data related to telephone calls made using the system 100, such as, a total number of calls that occurred during one or more particular time periods, such as, the individual days of a month.

Desirably, advertisers may run a “Call History” report to review various aspects about the telephone calls that were provided as part of their advertising campaigns. A customer may run a “Call History” report to review various aspects about the telephone calls that the customer made.

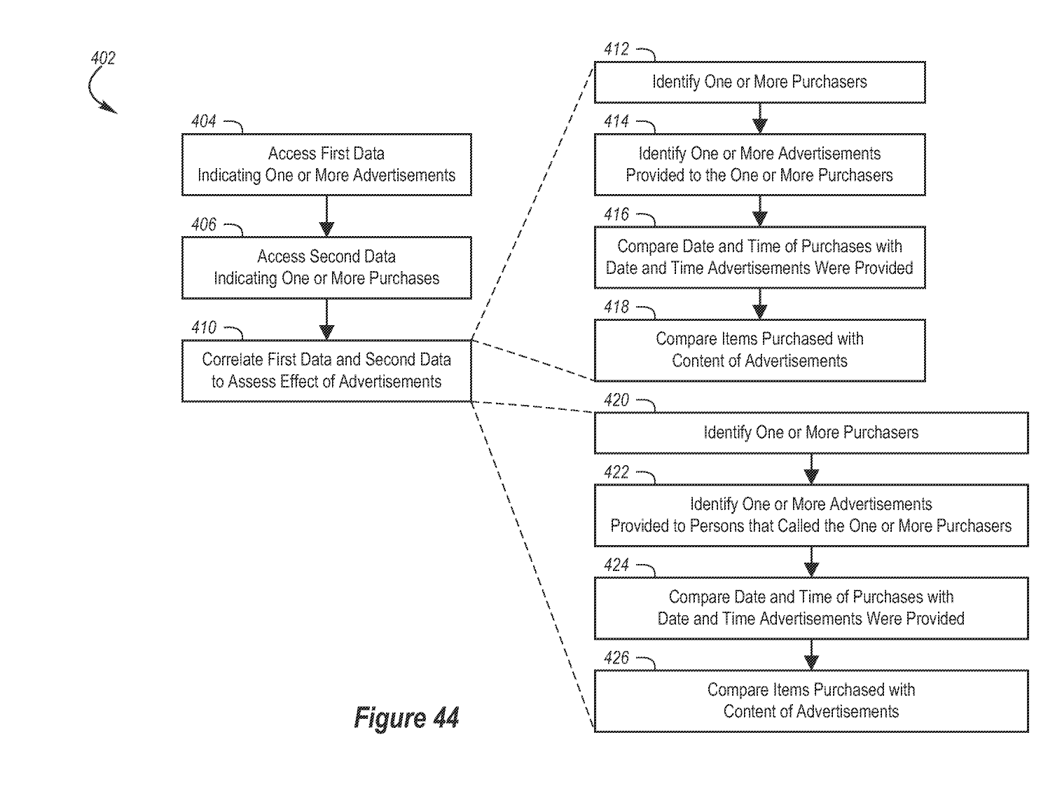

A “Call History” report may be especially useful for analyzing purchases. In further detail, as shown in FIG. 44, a method 402 may be performed to analyze one or more purchases. The method 402 may be performed by the system 100; the telecommunications system 106; the networks 108, 110, 112; the servers 114, 116; the database 120; one or more other suitable components, systems, modules, and the like; or any one or more thereof. Of course, the entire method 402 need not be performed; and any part or parts of the method 402 may be performed to provide a useful method 402.

At a block 404 in FIG. 44, first data indicating one or more advertisements may be accessed. For example, the first data may comprise a “Call History” report 400.

At a block 406 in FIG. 44, second data indicating one or more purchases may be accessed. Some examples of such second data may include data gathered from grocery store purchase tracking systems, such as Smith's Fresh Values card, Albertson's Preferred card, and the like. In some embodiments, the second data may comprise data from a database 408 (FIG. 40). As shown in FIG. 40, the database 408 may include one or more tables, such as a Customer_purchase table, a Customer_lookup table, one or more other tables, or any one or more thereof. The tables of the database 408 may include one or more rows, which may include one or more fields. For example, the rows of the Customer_purchase table may include Customer_Id, Product_Id, Quantity, Price_paid, Date, other suitable fields, or any one or more thereof. The rows of the Customer_lookup table may include Customer_Id, First_Name, Last_Name, Address, City, State, Zip_Code, Country, Phone, other suitable fields, or any one or more thereof. The database 408 does not require all (or any) of the tables and fields of the exemplary embodiment of the database 408 shown in FIG. 40. In fact, the database 408 may include different structures having other suitable configurations features disclosed herein. Nevertheless, the exemplary embodiment of the database 408 shown in FIG. 40 advantageously provides an example that will enable a person to create such different structures having other suitable configurations.

At a block 410 in FIG. 44, the first data and the second data may be correlated to assess the effect of one or more advertisements. For example, a “Call History” report 400 accessed by an advertiser (or other party) at the block 404 may include first data indicating the date and/or time a call began; the date and/or time the call ended; the date and/or time an advertisement was provided to a customer; the advertisement that was provided to the customer; at least a portion of the telephone number of the customer; and/or at least a portion of the telephone number of the person that the customer called using the system 100. In addition, a database 408 accessed by the advertiser (or other party) at the block 406 may include second data indicating one or items that were purchased (e.g., “Customer_purchase.Product_Id”) and the date and/or time of those purchases (e.g., “Customer_purchase.Date”). Desirably, the advertiser (or other party) may, at the block 410, use this first and second data to correlate the purchases with previously received advertisements.

For instance, as shown in FIG. 44, the block 410 may include one or more blocks, such as blocks 412, 414, 416, 418. At the block 412, one or more purchasers may be identified. For example, one or more purchasers may be identified by selecting the Customer_Id field from the Customer_purchase table in the database 408 (FIG. 40). At the block 414, one or more advertisements provided to the one or more purchasers may be identified. For example, with reference to FIG. 40, the Customer_purchase table and the Customer_lookup table may be joined by their Customer_Id field to identify the telephone numbers (“Customer_lookup.Phone”) of the purchasers; and these telephone numbers may be joined with the Caller_phone of the report 400a to identify advertisements (“Ad_name”) that were provided to the purchasers and/or other related data from the report 400a. Consequently, at the block 416, the date and/or time of the purchases may be compared with the date and/or time the advertisements were provided. In addition, at the block 418, the items purchased may be compared with the content of the advertisements and/or other related data from the report 400a.

Also, for instance, as shown in FIG. 44, the block 410 may include one or more blocks, such as blocks 420, 422, 424, 426. At the block 420, one or more purchasers may be identified. For example, one or more purchasers may be identified by selecting the Customer_Id field from the Customer_purchase table in the database 408 (FIG. 40). At the block 422, one or more advertisements provided to persons that called the one or more purchasers may be identified. For example, with reference to FIG. 40, the Customer_purchase table and the Customer_lookup table may be joined by their Customer_Id field to identify the telephone numbers (“Customer_lookup.Phone”) of the purchasers; and these telephone numbers may be joined with the Called_hone of the report 400a to identify advertisements (“Ad_name”) that were provided to persons that called the purchasers and/or other related data from the report 400a. Consequently, at the block 424, the date and/or time of the purchases may be compared with the date and/or time the advertisements were provided. In addition, at the block 426, the items purchased may be compared with the content of the advertisements and/or other related data from the report 400a.

Thus, as shown above, by matching the telephone numbers from the first and second data, one may ascertain the purchasing behavior of persons that heard particular advertisements (and/or persons that were called by persons that heard particular advertisements)—which may help in assessing the effect of particular advertisements.

In some embodiments, some or all of the first and second data may be displayed in a report to allow a person to quickly assess the effect of particular advertisements. For example, in one embodiment, the data may be grouped by particular purchasers, and the purchases, advertisements and/or calls may be sorted by their respective dates and/or times.

Statistics Report

In one embodiment, a “Statistics” report may include various statistics calculated for one or more of an advertiser's campaigns, which may be specified via user input if desired. Such statistics may include the advertiser's total cost of the accepted bids for individual advertisements in the campaign; the advertiser's total cost of the accepted bids for a group of some or all of the advertisements in the campaign; the advertiser's total cost of the accepted bids for individual geographical regions in the campaign; the advertiser's total cost of the accepted bids for a group of some or all of the geographical regions in the campaign; the total number of advertisements provided for individual geographical regions in the campaign; the total number of advertisements provided for a group of some or all of the geographical regions in the campaign; the total number of advertisements provided for individual geographical regions in the campaign; the total number of unique telephone numbers to which advertisements were provided for individual geographical regions in the campaign; the total number of unique telephone numbers to which advertisements were provided for a group of some or all of the geographical regions in the campaign; and the like. Desirably, advertisers may run a “Statistics” report to review their advertising campaigns.

### Server Access

As mentioned above with reference to FIG. 2, the telephone 102 may receive first user input identifying an access telephone number at a block 126, which may be used to access the server 114.

In some embodiments, multiple access numbers may be used to access the server 114. As shown in FIG. 4, the Ad_systems table may allow the database 120 to support a plurality of different subsystems by, for example, using a System_id field for each subsystem, which may be used in various tables in the database 120. Desirably, multiple access numbers may be used to access the same subsystem or different subsystems.

In some embodiments, a first subsystem may be used for a first predefined set of one or more geographical regions, and a second subsystem may be used for a different second predefined set of one or more geographical regions. This may advantageously facilitate selling franchises by selling the first subsystem to a first franchisee and selling the second subsystem to a different second franchisee. Desirably, the first franchisee may have one or more access numbers for the first franchisee's subsystem and thus the first franchisee may advertise its access numbers, while the second franchisee may have one or more access numbers for the second franchisee's subsystem and thus the second franchisee may advertise its access numbers also. In further detail, the ability to obtain telephone service via a particular access number associated with a particular subsystem may be limited to one or more predefined geographical regions (such as one or more zip codes, one or more cities, one or more counties, one or more states, one or more countries, one or more other geographical regions, and/or any combination thereof). For example, as shown in FIG. 4, the Status field in the Ad_systems_geos table in FIG. 4 may be used to define the geographical regions to which a particular subsystem (e.g., a particular System_id) can provide advertisements and/or define the geographical regions to which a particular subsystem cannot provide advertisements. Consequently, different access numbers may be used to access different subsystems configured to provide advertisements to different sets of geographical regions. The different sets of geographical regions may be mutually exclusive, for example, to facilitate franchising; however, the different sets of geographical regions need not be mutually exclusive.

In some embodiments, a first subsystem may be used for a first language (such as English), and a second subsystem may be used for a different second language (such as Spanish).

In some embodiments, an advertiser may have its own subsystem for the purpose of exclusive advertising via one or more access numbers.

In some embodiments, an advertiser may access multiple subsystems via a single login account. For example, the Adsys_lookup table may allow a single advertiser login account (Advertiser_id) to access multiple subsystems (System_id). In addition, one or more advertiser login accounts may be associated with a single subsystem, if desired.

### Exemplary Environments

The methods and systems described above require no particular component or function. Thus, any described component or function—despite its advantages—is optional. Also, some or all of the described components and functions described above may be used in connection with any number of other suitable components and functions.

The methods and systems described above can be implemented using software, hardware, or both hardware and software. For example, the software may advantageously be configured to reside on an addressable storage medium and be configured to execute on one or more processors. Software, hardware, or both may include, by way of example, any suitable module, such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (“FPGA”), a field programmable logic arrays (“FPLAs”), a programmable logic array (“PLAs”), any programmable logic device, application-specific integrated circuits (“ASICs”), controllers, computers, and firmware to implement those methods and systems described above. The functionality provided for in the software, hardware, or both may be combined into fewer components or further separated into additional components. Additionally, the components may advantageously be implemented to form a part of and/or execute on one or more computing devices. As used herein, “computing device” is a broad term and is used in its ordinary meaning and includes, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

Also, one or more software modules, one or more hardware modules, or both may comprise a means for performing some or all of any of the methods described herein. Further, one or more software modules, one or more hardware modules, or both may comprise a means for implementing any other functionality or features described herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

Although exemplary SQL Statements #1 through #15 are illustrated and discussed above, the system 100 does not require all (or any) of the SQL Statements #1 through #15. In fact, the system 100 may use different query language statements having other suitable configurations (including other Structured Query Language statements and/or query language statements other than Structured Query Language statements). Moreover, although exemplary SQL Statements #1 through #15 are illustrated as query language statements, the system 100 does not require any query language statements, and the system 100 may use other suitable means for accessing, updating and/or using the database 120. Nevertheless, the exemplary SQL Statements #1 through #15 advantageously provide examples that will enable a person to create such different query language statements having other suitable configurations and such other suitable means for accessing, updating and/or using the database 120.

As used herein, the term “zip code” is a broad term and is used in its ordinary meaning and includes, but is not limited to, any combination of letters, numbers, symbols, and the like used to identify at least a portion of a postal zone or post office, which facilitates the delivery of mail. For example, some zip codes in the United States may comprise a 5-digit or 9-digit code that may form a portion of a mailing address.

If desired, the methods described above (or any part thereof) and/or the systems described above (or any part thereof) may be used to help provide a telephone call to another telephone, a telephone call to one or more other telephones (such as, for a conference call), and/or other suitable telephone service.

If desired, the methods described above (or any part thereof) and/or the systems described above (or any part thereof) may be used to send an advertisement to the telephone of a user seeking to join a conference call and/or to connect the user's telephone to the conference call. Consequently, the methods described above (or any part thereof) and/or the systems described above (or any part thereof) may be used to provide advertisements to some or all of the attendees of a conference call depending, for example, upon the particular configuration of the methods and systems.

Although this invention has been described in terms of certain preferred embodiments, other embodiments apparent to those of ordinary skill in the art are also within the scope of this invention. Indeed, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a database including:
first data associating a first geographical region with a first plurality of identifiers, each identifier of the first plurality of identifiers comprising at least a portion of a telephone identifier; and
second data associating the first geographical region with one or more advertisements; and
a first server configured to receive a first telephone identifier; to determine whether at least a portion of the first telephone identifier matches at least a portion of at least one of the first plurality of identifiers; and to, at least partially in response to determining that at least a portion of the first telephone identifier matches at least a portion of at least one of the first plurality of identifiers, send at least one of the one or more advertisements to a first telephone associated with the first telephone identifier.

2. The system as in claim 1, wherein the database further includes third data and fourth data; the third data associating the one or more advertisements with one or more advertisement categories; the fourth data associating the one or more advertisement categories with a second plurality of identifiers, each identifier of the second plurality of identifiers comprising at least a portion of a telephone identifier; and wherein the first server is further configured to determine whether at least a portion of the first telephone identifier matches at least a portion of at least one of the second plurality of identifiers; and to, at least partially in response to determining that at least a portion of the first telephone identifier matches at least a portion of at least one of the second plurality of identifiers, send the at least one of the one or more advertisements to the first telephone.

3. The system as in claim 1, wherein the first geographical region comprises a zip code.

4. The system as in claim 1, wherein the first geographical region comprises a city.

5. The system as in claim 1, wherein the first geographical region comprises a county.

6. The system as in claim 1, wherein the first geographical region comprises a state.

7. The system as in claim 1, wherein the first geographical region comprises a country.

8. The system as in claim 1, wherein the first server is configured to send the at least one of the one or more advertisements to the first telephone via a network, the network comprising a Public Switched Telephone Network (PSTN) exchange.

9. The system as in claim 1, wherein the first server is configured to send the at least one of the one or more advertisements to the first telephone via a network, the network comprising a Session Initiation Protocol (SIP) server.

10. The system as in claim 1, wherein the first server is a Voice over Internet Protocol (VoIP) server.

11. The system as in claim 1, wherein the first telephone identifier is a telephone number.

12. A method comprising:
receiving at least one advertisement from a server;
the server being configured to send the at least one advertisement at least partially in response to the server receiving a first telephone identifier, identifying at least one geographical region associated with the first telephone identifier, and determining that the at least one advertisement is associated with the at least one geographical region.

13. The method as in claim 12, wherein the server is further configured to send the at least one advertisement at least partially in response to the server identifying at least one advertisement category associated with the first telephone identifier and determining that the at least one advertisement is associated with the at least one advertisement category.

14. The method as in claim 12, further comprising providing the at least one advertisement via one or more output devices of a telephone.

15. The method as in claim 12, wherein the step of receiving is performed by a telephone.

16. The method as in claim 12, wherein the step of receiving is performed by a Public Switched Telephone Network (PSTN) exchange.

17. The method as in claim 12, wherein the step of receiving is performed by a Session Initiation Protocol (SIP) server.

18. The method as in claim 12, wherein the at least one geographical region comprises a zip code.

19. The method as in claim 12, wherein the at least one geographical region comprises a city.

20. The method as in claim 12, wherein the at least one geographical region comprises a county.

21. The method as in claim 12, wherein the at least one geographical region comprises a state.

22. The method as in claim 12, wherein the at least one geographical region comprises a country.

23. A method comprising:
identifying one or more geographical regions associated with a first telephone identifier;
identifying one or more advertisements associated with at least one of the one or more geographical regions; and
sending at least one of the one or more advertisements to a first telephone associated with the first telephone identifier.

24. The method as in claim 23, wherein the at least one geographical region comprises a zip code.

25. The method as in claim 23, wherein the at least one geographical region comprises a city.

26. The method as in claim 23, wherein the at least one geographical region comprises a county.

27. The method as in claim 23, wherein the at least one geographical region comprises a state.

28. The method as in claim 23, wherein the at least one geographical region comprises a country.
